(19) United States
(12) Patent Application Publication
(10) Pub. No.: US 2006/0051523 A1
(43) Pub. Date: Mar. 9, 2006

(54) Sptical compensatory sheet and method for preparing optically anisotropic layer

(75) Inventors: Shinichi Morishima, Minami-ashigara-shi (JP); Junichi Yamanouchi, Minami-ashigara-shi (JP); Makoto Takahashi, Minami-ashigara-shi (JP); Mitsuyoshi Ichihashi, Minami-ashigara-shi (JP)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: Fuji Photo Film Co., Ltd., Kanagawa (JP)

(21) Appl. No.: 10/513,506

(22) PCT Filed: May 16, 2003
(86) PCT No.: PCT/JP03/06117

§ 371 Date: Jul. 1, 2005

(30) Foreign Application Priority Data
May 17, 2002 (JP) 2002-143518
Aug. 7, 2002 (JP) 2002-229495
Aug. 23, 2002 (JP) 2002-243600
Sep. 9, 2002 (JP) 2002-262239

(51) Int. Cl. C09K 19/00

(52) U.S. Cl. 428/1.1; 428/1.2

(57) ABSTRACT

A novel optical compensatory sheet is disclosed. The sheet comprises an optically anisotropic layer thereon comprising at least one compound represented by Formula (I) (R¹—X¹—)ₘAr¹(—COOH)ₚ, Formula (II): (R²—X²—)ₙAr²(—SO₃H)_{q} or Formula (III): (R—)ₛAr(—Y)ᵣ; where Ar¹ denotes an aromatic heterocyclic group or aromatic condensed carbocyclic group, X¹ denotes a single bond or divalent linking group, R¹ denotes an alkyl group, and m and p are integers from 1 to 4; where Ar² denotes an aromatic heterocyclic group or aromatic carbocyclic group, X² denotes a single bond or divalent linking group, R² denotes an alkyl group, n is an integer from 1 to 4 and q is an integer from 1 to 4; where Ar denotes an aromatic heterocyclic group or aromatic carbocyclic group, R denotes a substituent group, Y denotes sulfo or carboxyl, s is an integer from 0 to 5 and r is an integer from 1 to 4.

### FIELD OF THE INVENTION

The present invention belongs to the filed of novel optical compensate sheets and methods for preparing optically anisotropic layers.

Related Art

Optical compensatory sheets are employed in a variety of liquid-crystal displays to eliminate image coloration and broaden the viewing angle. Stretched birefringent films have conventionally been employed as optical compensatory sheets. Further, in recent years, instead of optical compensatory sheets comprised of stretched birefringent films, the use of optical compensatory sheets having an optically anisotropic layer formed of discotic liquid-crystal molecules on a transparent support has been proposed.

The optically anisotropic layer is generally prepared according to a method comprising coating a discotic liquid-crystal composition comprising discotic liquid-crystal molecules on an alignment layer, aligning the discotic liquid-crystal molecules by heating to a temperature exceeding the orientation temperature and fixing the aligned liquid crystal molecules. Generally, discotic liquid-crystal molecules are highly birefringent. Further, discotic liquid-crystal molecules have various orientation modes. The use of discotic liquid-crystal molecules permits the achievement of optical properties that are unachievable in conventional stretched birefringent films. Especially, the optical compensatory sheets having the optically anisotropic layer, in which the discotic liquid-crystal molecules are aligned so that the tilt angle varies with the distance from the surface of a transparent support, are useful to broaden the viewing angle of TN (Twisted Nematic) and OCB (Optically Compensatory Bend) modes liquid-crystal displays. U.S. Pat. Nos. 5,583,679 and 5,646,703 proposed the optical compensatory sheets having the optically anisotropic layer in which the discotic liquid-crystal molecules aligned at an mean tilt angle of 5 to 50°. EP No. 1054049 A1 proposed the optical compensators containing a columnar complexes consisting of melamines and substituted benzoic acid.

On the other hand, it is necessary for preparing an optically anisotropic layer having desired optical characteristics to control an alignment of discotic liquid crystal molecules in the layer since discotic liquid-crystal molecules have various orientation modes. It is described in pages from 9 to 21 of JP-A No. hei 11-352328 (the term “JP-A” as used herein means an “unexamined published Japanese patent application”) that addition of cellulose esters of low fatty acids and either F-containing surfactants or 1,3,5-triazin based compounds allows discotic liquid-crystal molecules to align in a homogenous alignment state where the mean tilt angle of molecules is not greater than 5°. It is described on pages in pages from 7 to 10 of JP-A No. 2001-330725 that compounds having a fluorine-substituted alkyl group and hydrophilic group which is a sulfo connected to a benzene ring through a linking group, are added to optically anisotropic layers in order to control tilt angles of discotic liquid crystal compounds in the layers. It is described in JP-A No. 2002-20363 that compounds showing an excluded volume effect are added to optically anisotropic layers in order to control alignments of liquid crystal compounds. However, when the present inventors actually employed these optical compensatory sheets in combination with some kinds of polarization plates, optical leaks were found in the inclined direction, and the viewing angle was not adequately broadened (to the degree that would be theoretically anticipated). One reason for the inadequate optical compensation function is that the tilt angle of the discotic liquid crystal molecules cannot be adequately ensured. There have not been disclosed compounds capable of promoting hybrid alignment of liquid crystal compounds.

There have been proposed other methods using alignment layers, in other words interface treatments, for controlling alignments of liquid crystal compounds. However, it is difficult to align liquid crystal compounds in mono-domain alignment, in which liquid crystal compounds are uniformly aligned in whole spaces between alignment layer interfaces and air interfaces, by driving force of an alignment layer alone. Some defects such as schlieren defects occur easily in the layers composed of liquid crystals aligned by driving force of alignment layer alone. Although shortening time for maturing alignment contributes to raising productivity, it leads to much increased schlieren defects. The optically anisotropic layers having schlieren defects scatter light, thereby resulting in lowered optical characteristics.

U.S. Pat. No. 5,995,184 (correspoing to JP-A No. 2000-105315) discloses a method of making a phase retardation plate, comprising the steps of: providing a substrate; applying a liquid crystal alignment layer to the substrate; applying a thin film of a polymerizable liquid crystal material to the alignment layer such that the free surface of the thin film constitutes a liquid crystal/air interface, the liquid crystal material including a surface active material that reduces the intrinsic tilt orientation of the director of the liquid crystal material at the liquid crystal/air interface; adjusting the temperature of the thin film to orient the director of the thin film in the bulk of the thin film; and polymerizing the thin film to preserve the orientation.

### SUMMARY OF THE INVENTION

One object of the present invention is to provide methods capable of rapidly preparing optically anisotropic layers formed of hybrid aligned liquid crystal compounds without defects such as schlieren defects. Another object of the present invention is to provide optical compensatory sheets having optically anisotropic layers in which liquid crystal molecules are aligned with improved tilt angle, exhibiting excellent optical compensatory properties. Especially, the present invention has for its object to provide optical compensatory sheets having optically anisotropic layers in which discotic liquid crystal molecules are aligned with improved tilt angle, contributing to broadening the viewing angle of liquid crystal displays (LCD) such as TN-mode and OCB-mode LCD.

In an aspect, the present invention provide an optical compensatory sheet comprising a transparent support and an optically anisotropic layer thereon comprising at least one compound represented by following Formula (I) or (II);
(R¹—X¹—)ₘAr¹(—COOH)ₚ Formula (I):
where Ar¹ denotes an aromatic heterocyclic group or aromatic condensed carbocyclic group; X¹ denotes a single bond or divalent linking group; R¹ denotes an alkyl group; m is an integer from 1 to 4 and p is an integer from 1 to 4; and plural R¹—X¹ may be identical or different each other when m is not smaller than 2;
   (R²—X²—)ₙAr²(—SO₃H)_{q} Formula (II):
where Ar² denotes an aromatic heterocyclic group or aromatic carbocyclic group; X² denotes a single bond or divalent linking group; R² denotes an alkyl group; n is an integer from 1 to 4 and q is an integer from 1 to 4; and plural R²—X² may be identical or different each other when n is not smaller than 2.

In another aspect, the present invention provides an optical compensatory sheet comprising a transparent support and an optically anisotropic layer thereon formed of a triphenylene liquid crystal compound and at least one compound represented by Formula (III);
(R—)ₛAr(—Y)ᵣ Formula (III):
where Ar denotes an aromatic heterocyclic group or aromatic carbocyclic group; R denotes a substituent group; Y denotes sulfo or carboxyl; s is an integer from 0 to 5 and r is an integer from 1 to 4; and plural R and Y may be respectively identical or different each other when s and r are not smaller than 2 respectively.

As embodiments of the present invention, there are provided, the optical compensatory sheet wherein Ar is a benzene group; the optical compensatory sheet wherein the compound represented by Formula (III) is represented by Formula (IIIa); 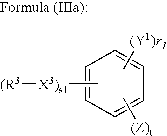
where Z denotes a substituent group, X³ denotes a single bond and divalent linking group, R³ denotes an alkyl group, alkenyl group or alkynyl group; Y¹ denotes a sulfo or carboxyl, t is an integer from 0 to 4, s¹ is an integer from 1 to 4 and r¹ is an integer from 1 to 4; and plural Z, R³, X³ and Y¹ may be respectively same or different each other when t, s¹ and r¹ are respectively not smaller than 2; and the optical compensatory sheet wherein, in Formula (IIIa), Z denotes an alkyl group, hydroxy, halogen atom or cyano; X³ is —O—, —S—, —OCO—, —N (R^{a})CO—, —CO—, —COO— or —CON(R^{a})—; R^{a} denotes a C1-5 alkyl group or hydrogen atom; R³ denotes a substituted or non-substituted C8-20 alkyl group or C4-12 alkyl group which is terminated by —CHF₂ or —CF₃ and is substituted with fluorine atoms at not less than 60% of hydrogen positions; t is an integer from 0 to 2, s¹ is an integer from 1 to 3 and r¹ is 1.

In another aspect, the present invention provides an optical compensatory sheet comprising a transparent support and an optically anisotropic layer thereon formed of a discotic liquid crystal compound and at least one compound represented by Formula (IVb); 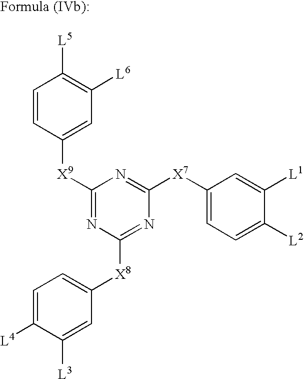
wherein X⁷, X⁸ and X⁹ independently denote —NH—, —NHCO—, —NHSO₂—, —O— or —S—; L¹, L², L³, L⁴, L⁵ and L⁶ independently denote a group having a structure represented by Formula (IVc) or (IVd); 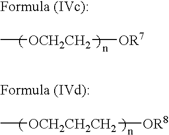
where in Formulae (IVc) and (IVd), R⁷ and R⁸ independently a substituted or non-substituted alkyl group; and n is an integer from 1 to 12;
wherein the liquid crystal compound is fixed in hybrid alignment.

In another aspect, the present invention provides an optical compensatory sheet comprising a transparent support and an optically anisotropic layer thereon formed of a discotic liquid crystal compound, at least one compound represented by Formula (XIIIa) and at least one compound represented by Formula (XXII); 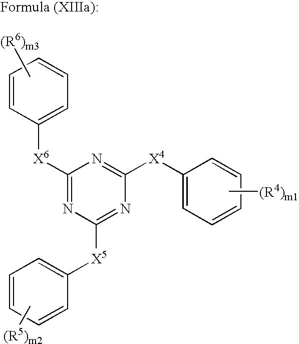
wherein R⁴, R⁵ and R⁶ independently denote a hydrogen atom or substituent group; X⁴, X⁵ and X⁶ independently denote a divalent linking group selected from the group consisting of —CO—, —NR^{a}— (R^{a} denotes a C1-5 alkyl group or hydrogen atom), —O—, —S—, —SO—, —SO₂— and combinations thereof; and m¹, m² and m³ denote independently integers from 1 to 5; and plural R⁴, R⁵ and R⁶ may be respectively identical or different each other when m¹, m² and m³ are respectively not smaller than 2;
   Ar³(-L⁷-Y²)ₘ₄ Formula (XXII)
where Ar³ denotes an aromatic carbocyclic group or aromatic heterocyclic group; Y² denotes a sulfo or a carboxyl; L⁷ denotes a single bond or divalent linking group; and m⁴ is an integer from 1 to 10;
wherein the liquid crystal compound is fixed in hybrid alignment.

In another aspect, the present invention provides a method for preparing an optically anisotropic layer formed of a liquid crystal compound hybrid-aligned, comprising a first step of aligning the liquid crystal compound in homogenous alignment, and a second step of aligning the liquid crystal compound in hybrid alignment after the first step.

The embodiments of the present invention, there are provided the method wherein the first step is a step of aligning the liquid crystal compound in homogenous alignment at T₁ degrees Celsius in the presence of a homogenous alignment promoter and the second step is a step of aligning the liquid crystal compound in hybrid alignment at T₂ (T₂<T₁) degrees Celsius in the presence of the homogenous alignment promoter; the method wherein the homogenous alignment promoter is a compound represented by Formula (IVb); 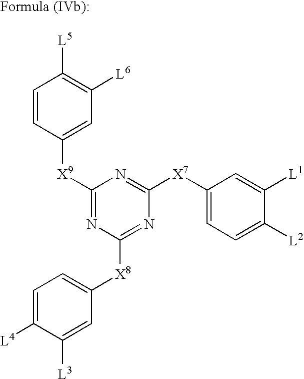
wherein X⁷, X⁸ and X⁹ independently denote —NH—, —NHCO—, —NHSO₂—, —O— or —S—; L¹, L², L³, L⁴, L⁵ and L independently denote a group having a structure represented by Formula (IVc) or (IVd); 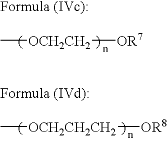
where in Formulae (IVc) and (IVd), R⁷ and R⁸ independently a substituted or non-substituted alkyl group; n is an integer from 1 to 12.

The embodiments of the present invention, there are provided the method wherein the first step is a step of aligning the liquid crystal compound in homogenous alignment at T₁ degrees Celsius in the presence of at least two compounds having a function group capable of hydrogen bonding, the second step is a step of aligning the liquid crystal compound in hybrid alignment at T₂ (T₁<T₂) degrees Celsius in the presence of the at least two compound having a function group capable of hydrogen bonding; the method wherein at least one of the at least two compounds having a function group capable of hydrogen bonding is a compound having a 1,3,5-triazine ring; the method wherein at least one of the at least two compounds having a function group capable of hydrogen bonding is a compound having a carboxyl group; the method wherein at least one of the at least two compounds having a function group capable of hydrogen bonding is a compound having a sulfo group; the method wherein one of the at least two compounds having a function group capable of hydrogen bonding is a compound having a 1,3,5-triazine ring and another is a compound having a carboxyl group or sulfo group; and the method wherein one of the at least two compounds having a function group capable of hydrogen bonding is a compound having a structure represented by Formula (XIIIa), and another is a compound having a structure represented by Formula (XXII); 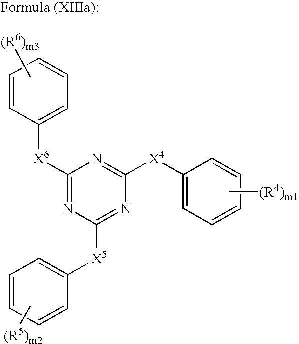
wherein R⁴, R⁵ and R⁶ independently denote a hydrogen atom or substituent group; X⁴, X⁵ and X⁶ independently denote a divalent linking group selected from the group consisting of —CO_, —NR^{a}— (R^{a} denotes a C1-5 alkyl group or hydrogen atom), —O—, —S—, —SO—, —SO₂— and combinations thereof; and m¹, m² and m³ denote independently integers from 1 to 5; and plural R⁴, R⁵ and R⁶ may be respectively identical or different each other when m¹, m² and m³ are respectively not smaller than 2;
   Ar³(-L⁷-Y²)ₘ₄ Formula (XXII)
where Ar³ denotes an aromatic carbocyclic group or aromatic heterocyclic group; Y² denotes a sulfo or a carboxyl; L⁷ denotes a single bond or divalent linking group; and m⁴ is an integer from 1 to 10.

The embodiments of the present invention, there are provided the method further comprising a third step of fixing the crystal compound in the hybrid alignment after the second step; and the method wherein the liquid crystal compound is a discotic liquid crystal compound.

In another aspect, the present invention provides an optical compensatory sheet comprising an optically anisotropic layer prepared by the method according to the present invention.

### DETAILED DESCRIPTION OF THE INVENTION

[Tilt Angle Improver]

The compensatory sheet according to the present invention comprises a transparent support and an optically anisotropic layer comprising at least one compound represented by Formula (I), (II) or (III). The compounds represented by Formulae (I) to (III) may contribute to stable hybrid alignments of liquid crystal compounds with large tilt angles, especially contributes to improvement of tilt angles at air interfaces, thereby resulting in remarkably improving optical compensatory properties. Furthermore, adding the compounds represented by Formulae (I) to (III) to liquid crystal layers (optically anisotropic layers) may contribute to improving in wettings between the layers and supports, in other words preventing generation of repelled spots.
(R¹—X¹—)ₘAr¹(—COOH)ₚ Formula (I):

In the formula, Ar¹ denotes an aromatic heterocyclic group or aromatic condensed carbocyclic group; X¹ denotes a single bond or divalent linking group; R¹ denotes an alkyl group; m is an integer from 1 to 4 and p is an integer from 1 to 4; and plural R¹—X¹ may be identical or different each other when m is not smaller than 2.
(R²—X²—)ₙAr²(—SO₃H)_{q} Formula (II):

In the formula, Ar² denotes an aromatic heterocyclic group or aromatic carbocyclic group; X² denotes a single bond or divalent linking group; R² denotes an alkyl group; n is an integer from 1 to 4 and q is an integer from 1 to 4; and plural R²—X² may be identical or different each other when n is not smaller than 2.
(R—)ₛAr(—Y)ᵣ Formula (III):

In the formula, Ar denotes an aromatic heterocyclic group or aromatic carbocyclic group; R denotes a substituent group; Y denotes sulfo or carboxyl; s is an integer from 0 to 5 and r is an integer from 1 to 4; and plural R and s may be respectively identical or different each other when s and r are not smaller than 2 respectively.

At first, the Formula (I) will be described in detail.

The aromatic heterocyclic groups denoted by Ar¹ are desirably aromatic heterocyclic groups with from 1 to 20 carbon atoms, and preferably with from 1 to 12 carbon atoms. The aromatic heterocycles included in the groups have at least one hetero atom such as nitrogen (N), oxygen (O) or sulfur (S). Examples of the aromatic heterocycles of the groups include furan, pyrrole, imidazole, pyrazole, isoxazole, pyridine, pyrimidine, 1,3,5-triazine, indole, indazole, quinoline and carbazole.

The aromatic condensed carbocyclic groups denoted by Ar¹ are composed of condensed two or more rings. The aromatic condensed carbocyclic groups are desirably aromatic condensed carbocyclic groups with from 10 to 30 carbon atoms, preferably with from 10 to 20 carbon atoms. The most preferable example of the aromatic condensed ring included in the group is naphthalene.

Ar¹ denotes desirably an aromatic condensed carbocyclic group.

The heterocycles and carbocycles denoted by Ar¹ may be substituted with at least one substituent such as:
alkyl groups (desirably alkyl groups having from 1 to 20 carbon atoms, preferably having from 1 to 12 carbon atoms, and more preferably having from 1 to 8 carbon atoms; examples are methyl, ethyl, isopropyl, tert-butyl, n-octyl, n-decyl, n-hexadecyl, cyclopropyl, cyclopentyl, and cyclohexyl), alkenyl groups (desirably alkenyl groups having from 2 to 20 carbon atoms, preferably from 2 to 12 carbon atoms, and more preferably having from 2 to 8 carbon atoms; examples are vinyl, allyl, 2-butenyl, and 3-pentenyl), alkynyl groups (desirably alkynyl groups having from 2 to 20 carbon atoms, preferably from 2 to 12 carbon atoms, and more preferably from 2 to 8 carbon atoms; examples are propargyl and 3-pentenyl), aryl groups (desirably aryl groups having from 6 to 30 carbon atoms, preferably having from 6 to 20 carbon atoms, and more preferably having from 6 to 12 carbon atoms; examples are phenyl, p-methylphenyl, and naphthyl), optionally substituted amino groups (desirably amino groups having from 0 to 20 carbon atoms, preferably having from 0 to 10 carbon atoms, and more preferably having from 0 to 6 carbon atoms; examples are unsubstituted amino, methylamino, dimethylamino, diethylamino and anilino), alkoxy groups (desirably alkoxy groups having from 1 to 20 carbon atoms, preferably having from 1 to 16 carbon atoms, and more preferably having from 1 to 10 carbon atoms; examples are methoxy, ethoxy, and butoxy), alkoxycarbonyl groups (desirably alkoxycarbonyl groups having from 2 to 20 carbon atoms, preferably having from 2 to 16 carbon atoms, and more preferably having from 2 to 10 carbon atoms; examples are methoxycarbonyl and ethoxycarbonyl), acyloxy groups (desirably acyloxy groups having from 2 to 20 carbon atoms, preferably having from 2 to 16 carbon atoms, and more preferably having from 2 to 10 carbon atoms; examples are acetoxy and benzoyloxy), acylamino groups (desirably acylamino groups having from 2 to 20 carbon atoms, preferably having from 2 to 16 carbon atoms, and more preferably having from 2 to 10 carbon atoms; examples are acetylamino and benzoylamino), alkoxycarbonylamino groups (desirably alkoxycarbonylamino groups having from 2 to 20 carbon atoms, preferably having from 2 to 16 carbon atoms, and more preferably having from 2 to 12 carbon atoms; examples include methoxycarbonylamino), aryloxycarbonylamino groups (desirably aryloxycarbonylamino groups having from 7 to 20 carbon atoms, preferably having from 7 to 16 carbon atoms, and more preferably having from 7 to 12 carbon atoms; examples include phenyloxycarbonylamino), sulfonylamino groups (desirably sulfonylamino groups having from 1 to 20 carbon atoms, preferably having from 1 to 16 carbon atoms, and more preferably having from 1 to 12 carbon atoms; examples are methanesulfonylamino and benzenesulfonylamino), sulfamoyl groups (preferably sulfamoyl groups having from 0 to 20 carbon atoms, preferably having from 0 to 16 carbon atoms, and more preferably having from 0 to 12 carbon atoms; examples are sulfamoyl, methylsulfamoyl, dimethylsulfamoyl and phenylsulfamoyl), carbamoyl groups (desirably carbamoyl groups having from 1 to 20 carbon atoms, preferably having from 1 to 16 carbon atoms, and more preferably having from 1 to 12 carbon atoms; examples are unsubstituted carbamoyl, methylcarbamoyl, diethylcarbamoyl and phenylcarbamoyl), alkylthio groups (desirably alkylthio groups having from 1 to 20 carbon atoms, preferably having from 1 to 16 carbon atoms, and more preferably having from 1 to 12 carbon atoms; examples are methylthio and ethylthio), arylthio groups (desirably arylthio groups having from 6 to 20 carbon atoms, preferably having from 6 to 16 carbon atoms, and more preferably having from 6 to 12 carbon atoms; examples include phenylthio), sulfonyl groups (desirably sulfonyl groups having from 1 to 20 carbon atoms, preferably having from 1 to 16 carbon atoms, and more preferably having from 1 to 12 carbon atoms; examples are mesyl and tosyl); sulfinyl groups (desirably sulfinyl groups having from 1 to 20 carbon atoms, preferably having from 1 to 16 carbon atoms, and more preferably having from 1 to 12 carbon atoms; examples are methanesulfinyl and benzenesulfinyl); ureido groups (desirably ureido groups having from 1 to 20 carbon atoms, preferably having from 1 to 16 carbon atoms, and more preferably having from 1 to 12 carbon atoms; examples are unsubstituted ureido, methylureido and phenylureido), phosphoramide groups (desirably phosphoramide groups having from 1 to 20 carbon atoms, preferably having from 1 to 16 carbon atoms, and more preferably having from 1 to 12 carbon atoms; examples are diethyl phosphoramide and phenyl phosphoramide), hydroxy, mercapto, halogen atoms (for example, fluorine, chlorine, bromine and iodine); cyano, sulfo, carboxyl, nitro, hydroxamic acid groups, sulfino, hydrazino, imino, heterocyclic groups (desirably heterocyclic groups having from 1 to 30 carbon atoms, and preferably having from 1 to 12 carbon atoms; examples are heterocyclic groups having hetero atom such as nitrogen, oxygen or sulfur; examples are imidazolyl, pyridyl, quinolyl, furyl, piperidyl, morpholino, benzoxazolyl, benzimidazolyl, and benzthioazolyl), and silyl groups (desirably silyl groups having from 3 to 40 carbon atoms, preferably having from 3 to 30 carbon atoms, and more preferably having from 3 to 24 carbon atoms; examples are trimethylsilyl and triphenylsilyl). These substituents may be further substituted with these substituents. Further, when there are two or more substituents, they may be identical or different. When possible, they may be bonded together to form a ring.

The preferred examples of substituents for the heterocycles and carbocycles denoted by Ar¹ are alkyl groups, aryl groups, alkoxy groups, alkoxycarbonyl groups, acyloxy groups, acylamino groups, sulfonylamino groups and alkylthio groups; more preferred examples are alkyl groups, alkoxy groups, alkoxycarbonyl groups and acyloxy groups.

The divalent linking group denoted by X¹ is desirably selected from the group consisting of alkylene groups alkenylene groups, arylene groups, divalent heterocyclic groups, —CO—, —NR^{a}— where R^{a} denotes a C1-5 alkyl groups or hydrogen, —O—, —S—, —SO—, —SO₂— and any combinations of at least two of them. The divalent linking group denoted by X¹ is desirably selected from the group consisting of alkylene groups, —CO—, —NR^{a}—, —O—, —S—, —SO₂— and any combinations of at least two of them. The preferred alkylene groups have from 1 to 12 carbon atoms, the preferred alkenylene groups have from 2 to 12 carbon atoms, and the preferred arylene groups have from 6 to 10 carbon atoms. The alkylene, alkenylene and arylene groups may be substituted with at least one substituent exemplified above as substituents for Ar¹, such as alkyl groups, halogen atoms, cyano, alkoxy groups or acyloxy groups.

X¹ denotes desirably a divalent linking group, and preferably —O—, —O(CH₂CH₂O)ₙ— where n is an integer from 1 to 4, —S—, —OCO—, —N(R^{a})CO_, —CO—, —COO— or —CON(R^{a})—.

The alkyl group denoted by R¹ may have a straight, branching or cyclic structure, desirably has from 6 to 60 carbon atoms, preferably has from 7 to 50 carbon atoms, more preferably has from 8 to 40 carbon atoms, much more preferably has from 8 to 30 carbon atoms, and most preferably has from 8 to 20.

The alkyl group denoted by R¹ may be substituted with at least one substituent exemplified above as substituents for Ar¹. The preferred examples of substituents for R¹ are halogen atoms, and the more preferred is fluorine. When R¹ is a fluorinated alkyl group, the fluorinated alkyl group has desirably a terminal CHF₂ or CF₃ group, and from 1 to 12, preferably from 4 to 16, more preferably from 4 to 12 carbon atoms. The alkyl group having a terminal CHF₂ or CF₃ group is desirably substituted with fluorine atoms at a part or all positions of the hydrogen atoms. The alky groups are preferably substituted with fluorine atoms at not less than 60 percent of hydrogen atoms positions.

Examples of R¹ are given below.

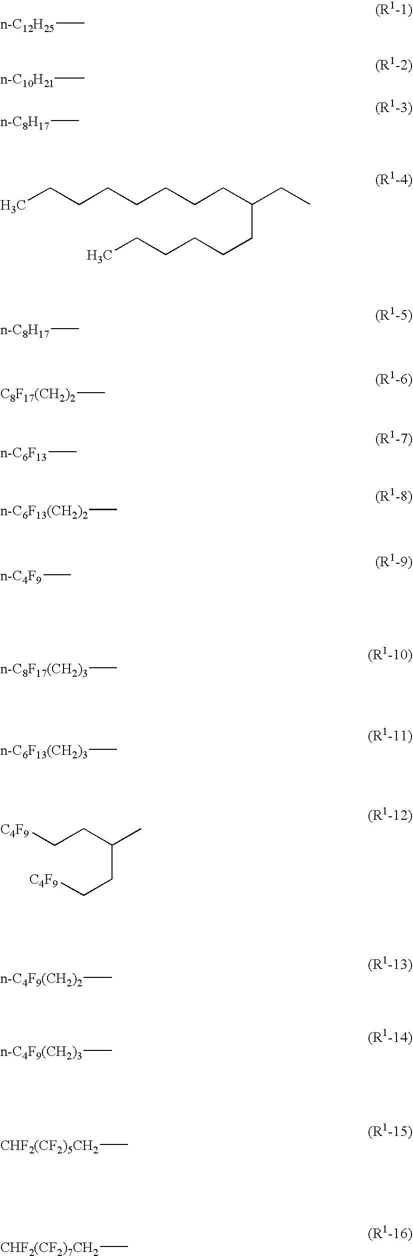

In Formula (I), m is desirably an integer from 1 to 3, and p is desirably 1.

The preferred embodiment of the compound represented by Formula (I) is represented by Formula (Ia).

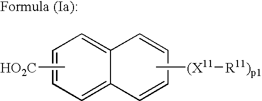

In the formula, X¹¹ denotes —O—, —O(CH₂CH₂O)ₙ— where n is an integer from 1 to 4, —S—, —OCO—, —N(R^{a})CO_, —CO—, —COO— or —CON(R^{a})—; R¹¹ denotes a C8-20 non-substituted alkyl group or C4-12 alkyl group which is terminated by —CHF₂ or —CF₃ and is substituted with fluorine atoms at not less than 60% of hydrogen positions; p¹ is an integer from 1 to 3; and R^{a} denotes a C1-5 alkyl group or hydrogen.

In the formula, X¹¹ desirably denotes —O—, —O(CH₂CH₂O)ₙ— where n is an integer from 1 to 4, —OCO— or —COO—.

When p¹ is 1, R¹¹ is desirably a C4-12 alkyl group which is terminated by —CF₃ and is substituted with fluorine atoms at not less than 60% of hydrogen positions; when p¹ is 2, R¹¹ is desirably a C8-20 non-substituted alkyl group or C4-12 alkyl group which is terminated by —CHF₂ or —CF₃ and is substituted with fluorine atoms at not less than 60% of hydrogen positions; and when P¹ is 3, R¹¹ is desirably a C8-20 non-substituted alkyl group or C4-12 alkyl group which is terminated by —CHF₂ or —CF₃ and is substituted with fluorine atoms at not less than 60% of hydrogen positions.

Next, the Formula (II) will be described in detail.

In the formula, Ar² denotes an aromatic heterocyclic group or aromatic carbocyclic group. The aromatic heterocyclic groups denoted by Ar² are identically defined with the aromatic heterocyclic groups denoted by Ar¹ in Formula (I) above, and their preferred scopes are identical. The aromatic carbocyclic groups denoted by Ar² have desirably from 6 to 30 carbon atoms, and preferably from 6 to 20 carbon atoms. The aromatic carbocycle included in the group is desirably benzene ring or naphthalene ring. Ar² denotes desirably an aromatic carbocyclic group.

The aromatic heterocyclic groups and aromatic carbocyclic groups denoted by Ar² may be substituted with at least one substituent. Examples of the substituents are identical with the substituents exemplified above for Ar¹ and their preferred scopes are identical.

X², R², n and q in Formula (II) are identically defined with X¹, R¹, m and p respectively in Formula (I) and their preferred scopes are identical.

The preferred embodiment of the compound represented by Formula (II) is represented by Formula (IIa).
HO₃S—(Ar²²)—(X²²—R²²)_{q1} Formula (IIa)

In the formula, Ar²² denotes a benzene or naphthalene ring; X²² is —O—, —O(CH₂CH₂O)ₙ— where n is an integer from 1 to 4, —S—, —OCO—, —N(R^{a})CO_, —CO—, —COO— or —CON(R^{a})—; R²² denotes a C8-20 non-substituted alkyl group or C4-12 alkyl group which is terminated by —CHF₂ or —CF₃ and is substituted with fluorine atoms at not less than 60% of hydrogen positions; q¹ is an integer from 1 to 3; and R^{a} denotes a C1-5 alkyl group or hydrogen atom.

X²², R²² and q¹ in Formula (IIa) are identically defined with X¹¹, R¹¹ and p¹ respectively in Formula (Ia) and their preferred scopes are identical.

Next, Formula (III) will be described in detail.

In the formula, Ar denotes an aromatic heterocyclic group or aromatic carbocyclic group. The aromatic heterocyclic groups and aromatic carbocyclic groups denoted by R are identically defined with them denoted by Ar² in Formula (II), their preferred scopes are identical. Ar is desirably a benzene ring.

The substituents denoted by R are identically defined with the substituents for Ar¹.

The preferred embodiment of the compound represented by Formula (III) is represented by Formula (IIIa).

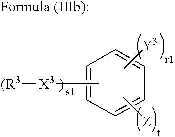

In the formula (IIIa), Z denotes a substituent, X³ denotes a single bond or divalent linking group; R³ denotes an alkyl group, alkenyl group or alkynyl group; Y¹ denotes sulfo or carboxyl; t is an integer from 0 to 4, s¹ is an integer from 1 to 4, and r¹ is an integer between 1 to 4; and plural Z, R³—X³ and Y¹ may be identical or different each other when t, s¹, and r¹ are respectively not smaller than 2.

The substituents denoted by Z are identically defined with substituents denoted by R in Formula (III) and their preferred scopes are identical. Z desirably denotes an alkyl group, hydroxy, halogen atom or cyano.

The divalent linking groups denoted by X³ are identically defined with the divalent linking groups denoted by X¹ in Formula (I) and their preferred scopes are identical.

The alkyl groups, alkenyl groups and alkynyl groups denoted by R³ may have a straight, branched or cyclic structure, desirably have from 6 to 60, preferably from 7 to 50, more preferably from 8 to 40, much more preferably from 8 to 30, most preferably from 8 to 20 carbon atoms. The alkyl groups, alkenyl groups and alkynyl groups denoted by R³ may be substituted with at least one substituent group exemplified above as R in Formula (III). The substituent for the alkyl groups, alkenyl groups and alkynyl groups denoted by R³ is desirably halogen, and preferably fluorine. When R³ denotes a fluorinated alkyl group, alkenyl group or alkynyl group, R³ is desirably an alkyl group, alkenyl group or alkynyl group having a terminal CHF₂ group or CF₃ group and desirably has from 1 to 20, preferably from 4 to 16, and more preferably from 4 to 12 carbon atoms. The alkyl groups, alkenyl groups and alkynyl groups having a terminal CHF₂ group or CF₃ group is substituted with fluorine atoms desirably at not less than 50 percent, preferably at not less than 60 percent, of hydrogen atoms positions. R³ is desirably an alkyl group.

Examples are given below of R³.

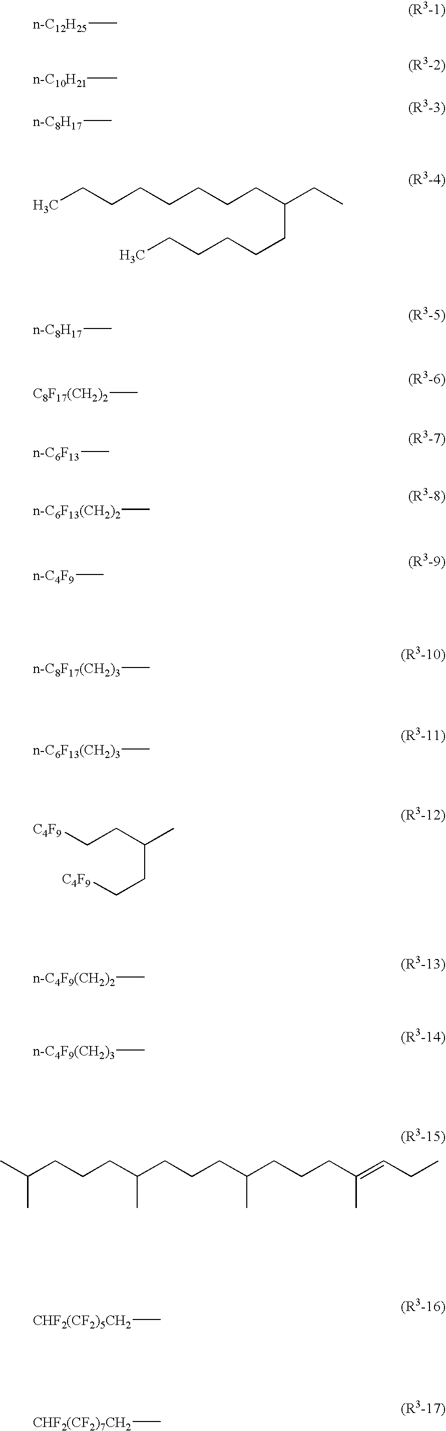

In the formula, t is desirably an integer from 0 to 2, s¹ is desirably an integer from 1 to 4 and r¹ is desirably an integer from 1 to 4. Plural Z, R³, X³ and Y¹ are respectively identical or different each other when t, s¹ and r¹ are not smaller than 2 respectively.

The preferred embodiment of the compound represented by Formula (IIIa) is represented by Formula (IIIb).

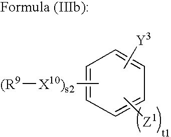

In the Formula (IIIb), Z¹ denotes an alkyl group, hydroxy, halogen atom or cyano; X¹⁰ denotes —O—, —O(CH₂CH₂O)ₙ— where n is an integer from 1 to 4, —S—, —OCO—, —N(R^{a})CO—, —CO—, —COO—, or —CON(R^{a})—; R^{a} denotes a C1-5 alkyl group or hydrogen; R⁹ denotes a C8-20 non-substituted alkyl group or a C4-12 alkyl group which is terminated by —CHF₂ or —CF₃ and is substituted with fluorine atoms at not less than 60% of hydrogen positions; Y³ denotes sulfo or carboxyl; t¹ is an integer from 0 to 2 and s² is an integer from 1 to 3.

In Formula (IIIb), X¹⁰ desirably denotes —O—, —O(CH₂CH₂O)ₙ— where n is an integer from 1 to 4, —OCO— or —COO—. When 52 is 1, R⁹ is desirably a C4-12 alkyl group which is terminated by —CHF₂ or —CF₃ and is substituted with fluorine atoms at not less than 60% of hydrogen positions; when s² is 2, R⁹ desirably denotes a C12-20 non-substituted alkyl group or a C4-12 alkyl group which is terminated by —CHF₂ or —CF₃ and is substituted with fluorine atoms at not less than 60% of hydrogen positions; and when 52 is 3, R⁹ desirably denotes a C8-20 non-substituted alkyl group or a C4-12 alkyl group which is terminated by —CHF₂ or —CF₃ and is substituted with fluorine atoms at not less than 60% of hydrogen positions. It is more preferred that S² is 1 or 2 and R⁹ is a C4-12 alkyl group which is terminated by —CHF₂ or —CF₃ and is substituted with fluorine atoms at not less than 60%, preferably 65 percent, of hydrogen atoms positions.

In the formula, plural Z¹ and R⁹—X¹⁰ may be respectively identical or different each other when t¹ and s² are respectively not smaller than 2.

The compounds represented respectively by the Formula (I), (II) and (III) desirably have polymerizable groups for fixing liquid crystal compounds in aligned states.

Specific examples of the compounds denoted respectively by the Formula (I), (II) and (III) are given below. However, compounds that can be employed in the present invention are not limited to these compounds. Among the specific examples below, Nos. I-1 to 37 are examples of compounds denoted by the Formula (I) and (III); Nos. II-1 to 46 are examples of compounds denoted by the Formula (II) and (III); and Nos. III-1 to 36 are examples of compounds denoted by the Formula (III).

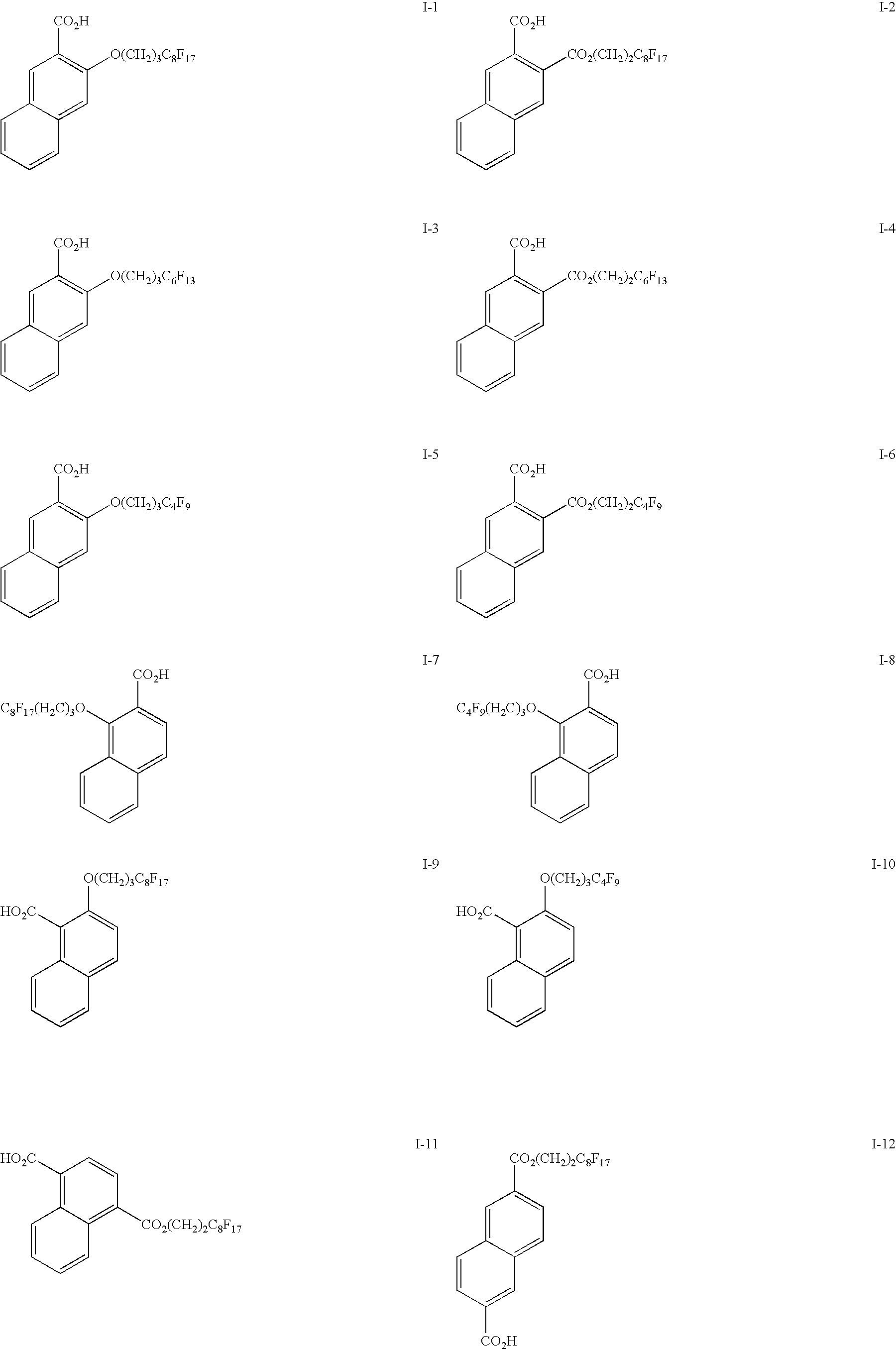

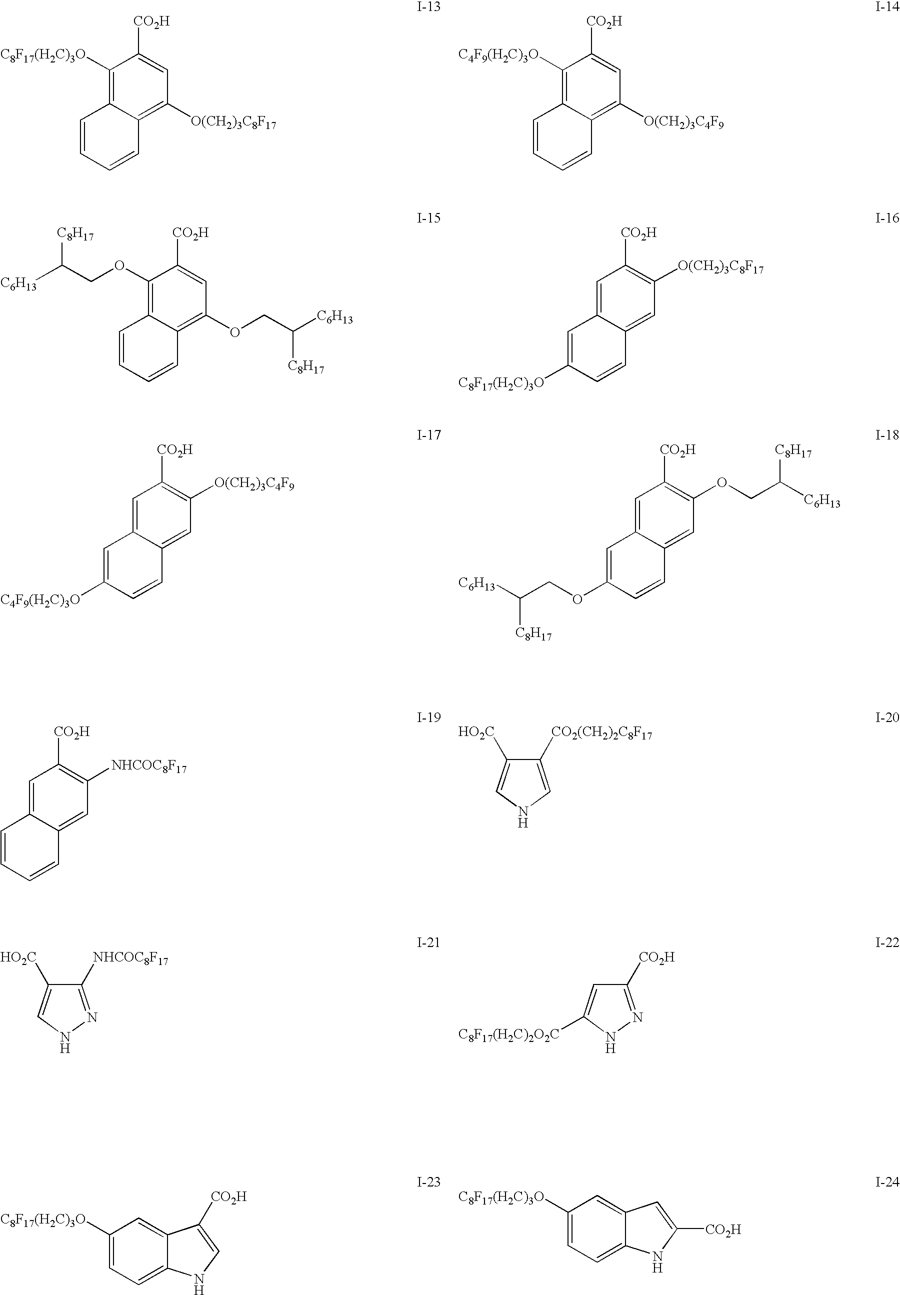

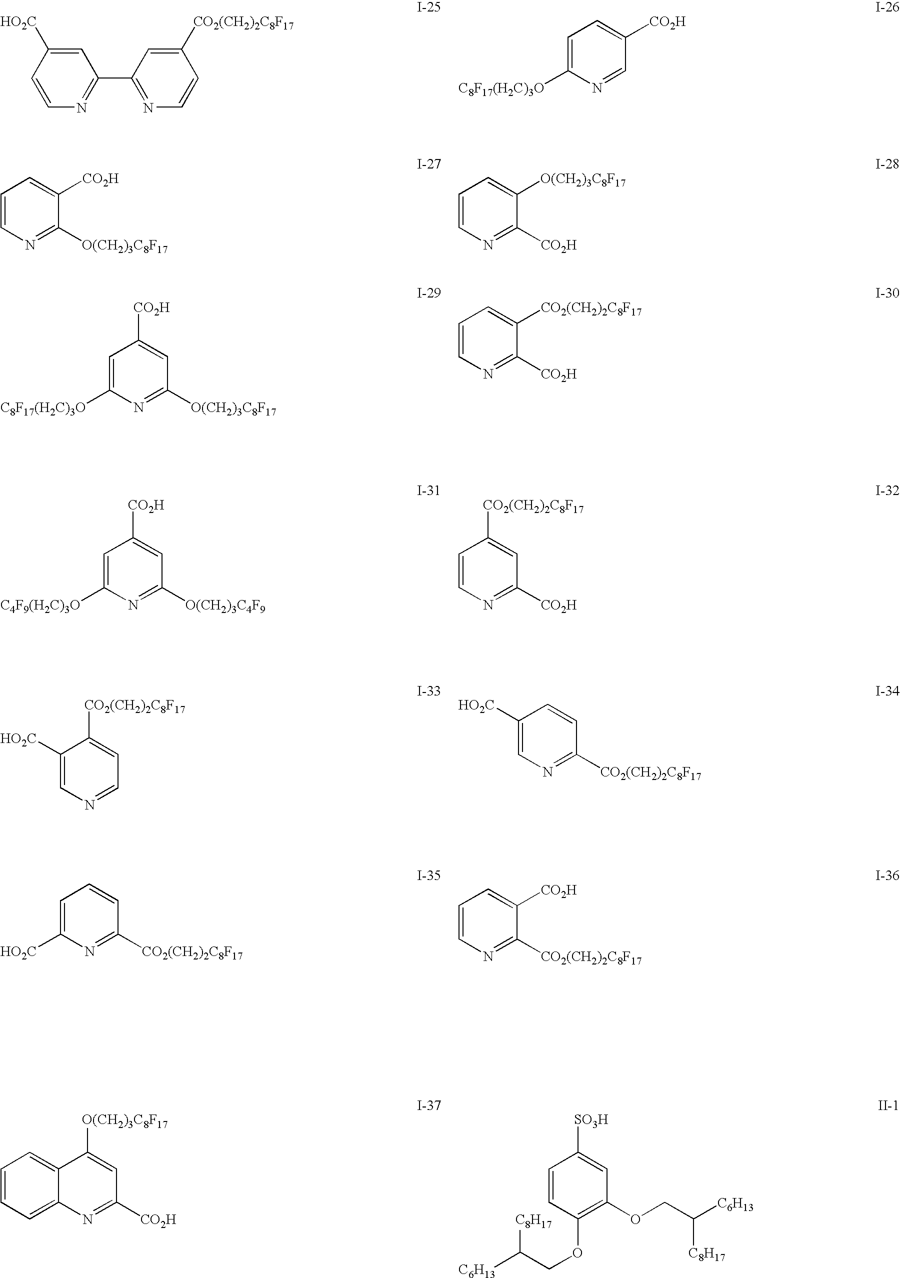

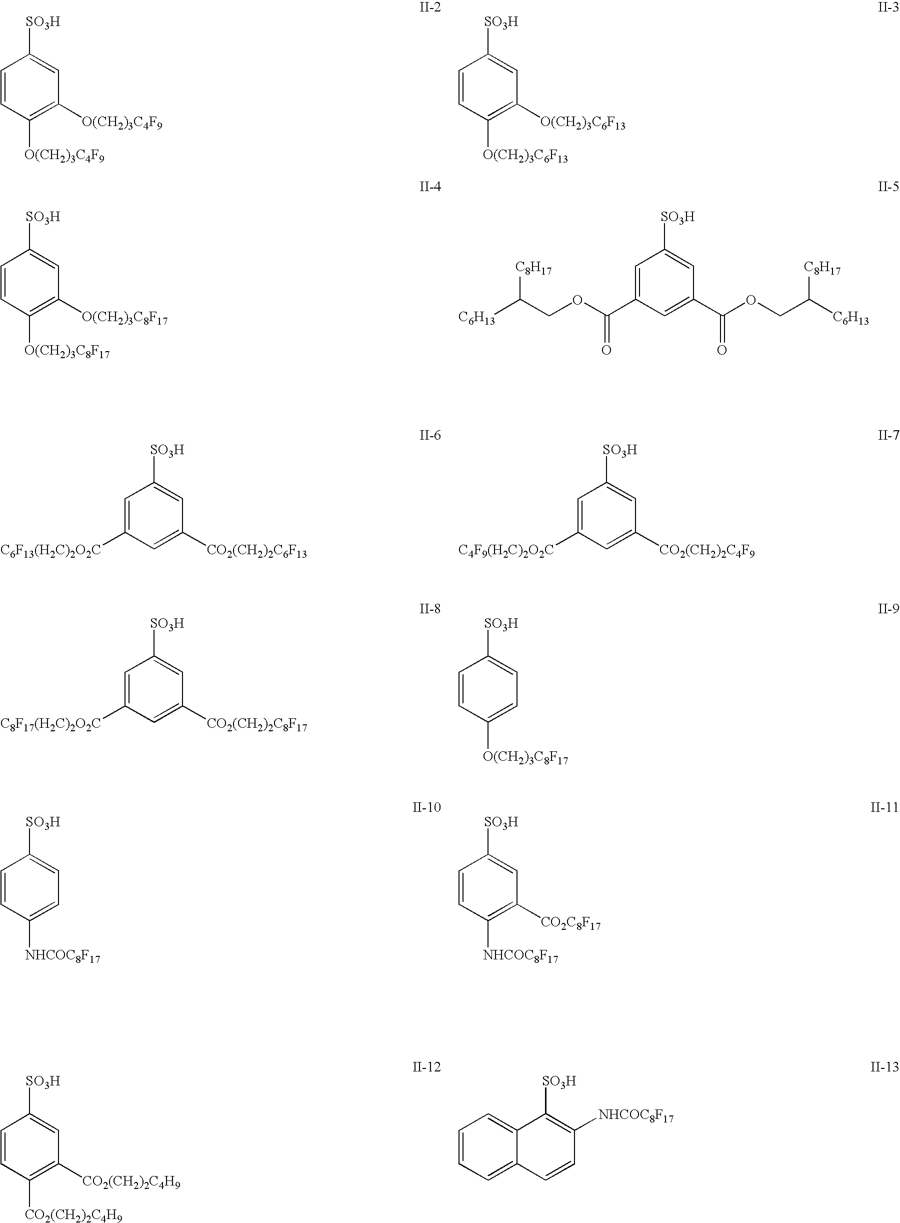

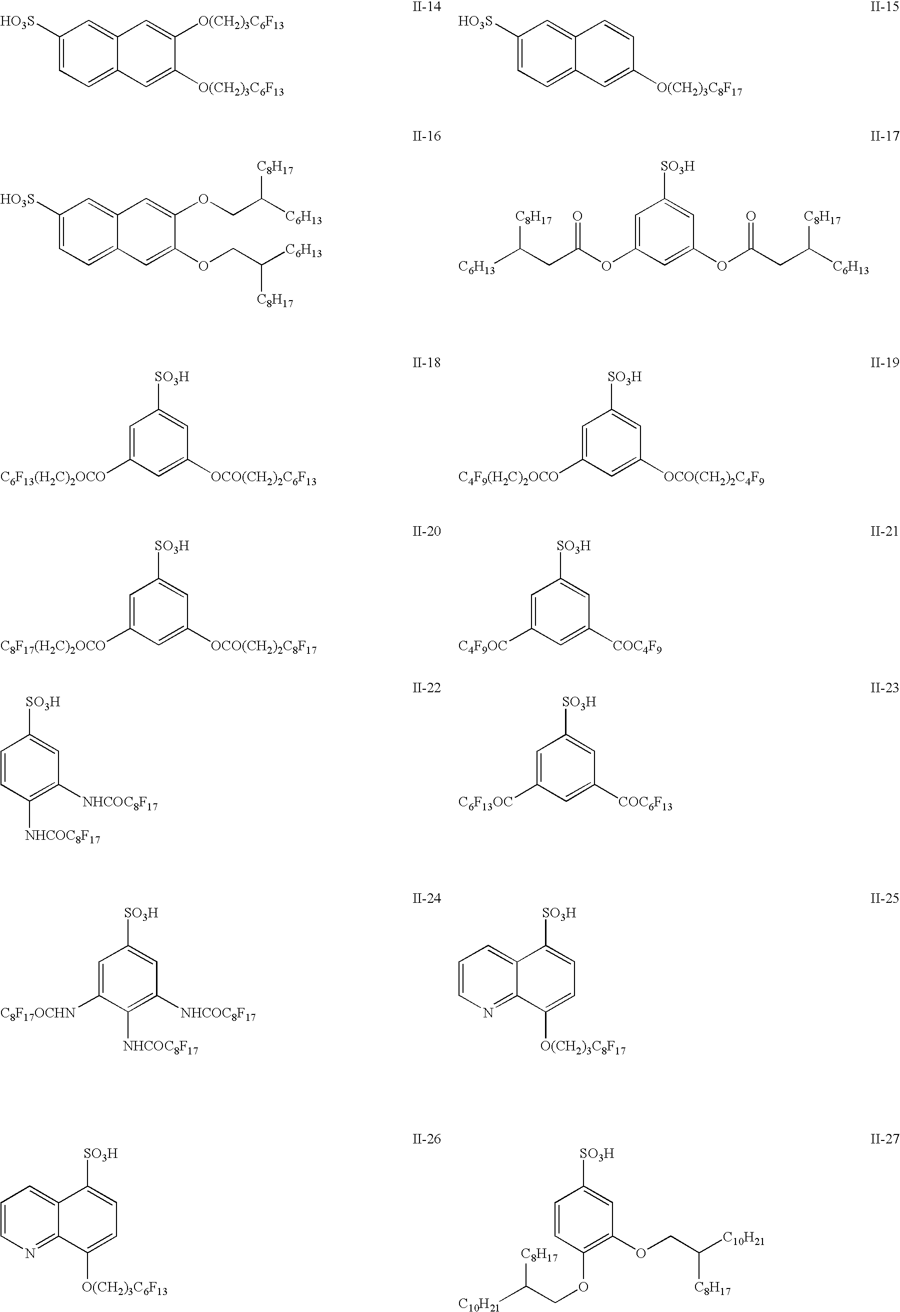

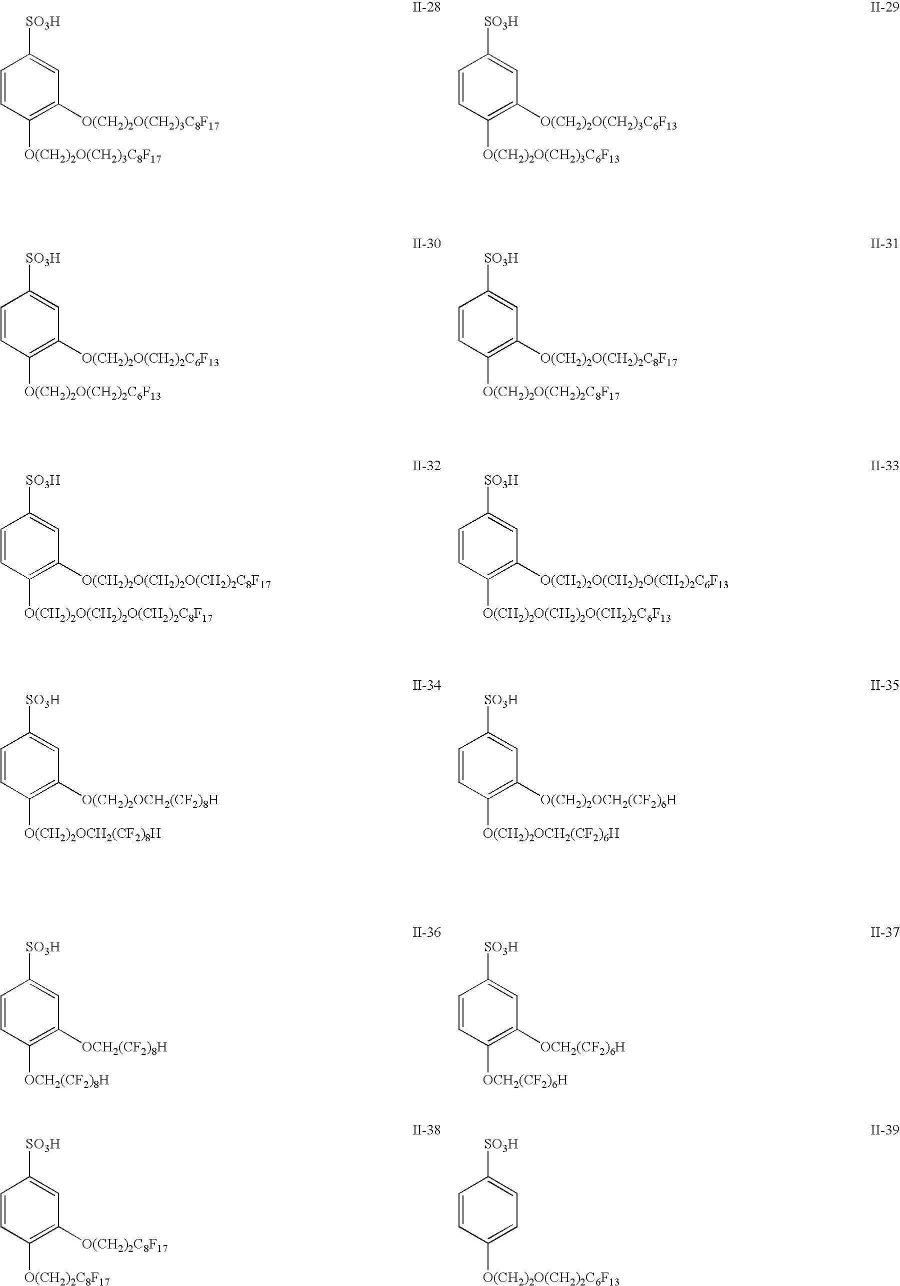

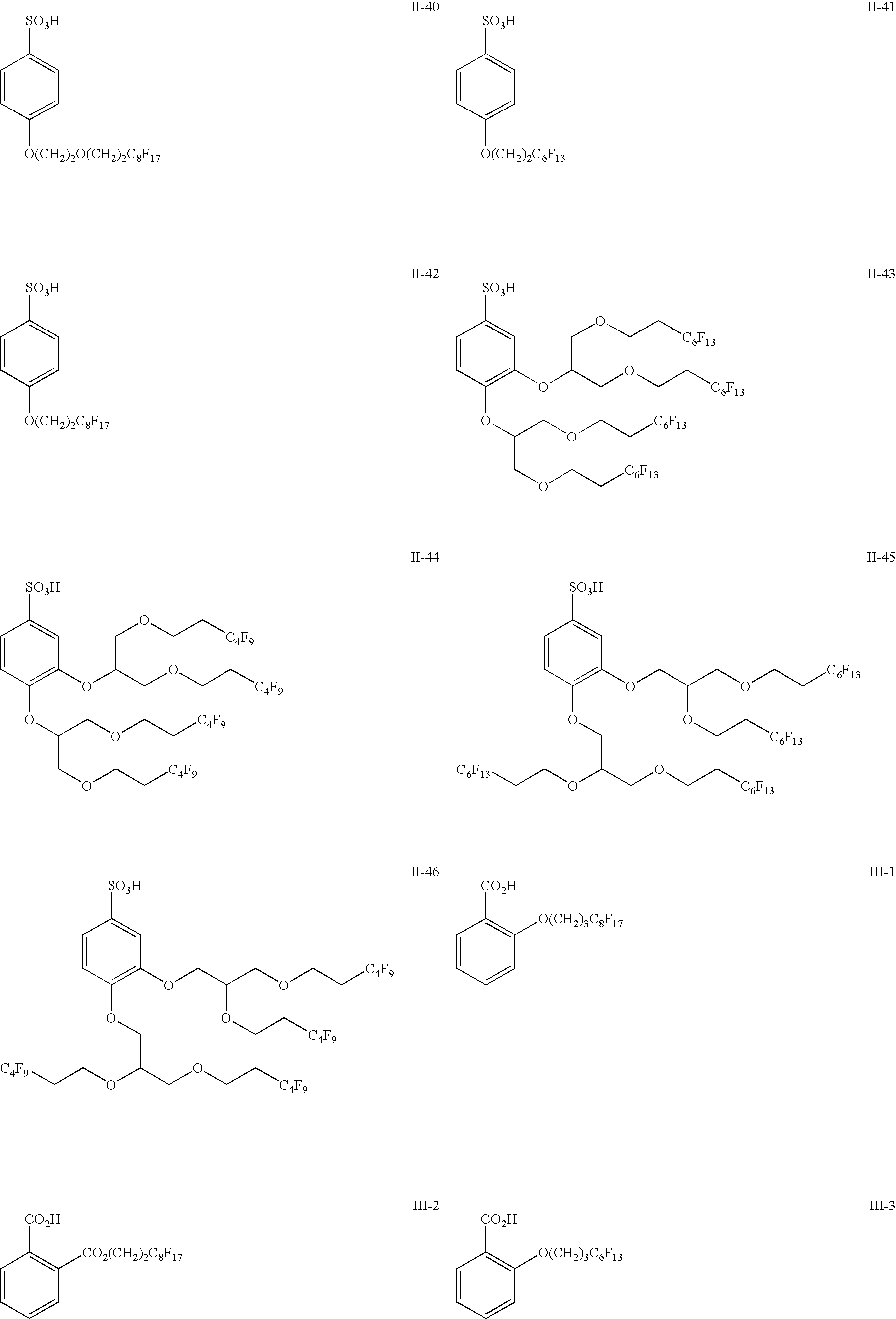

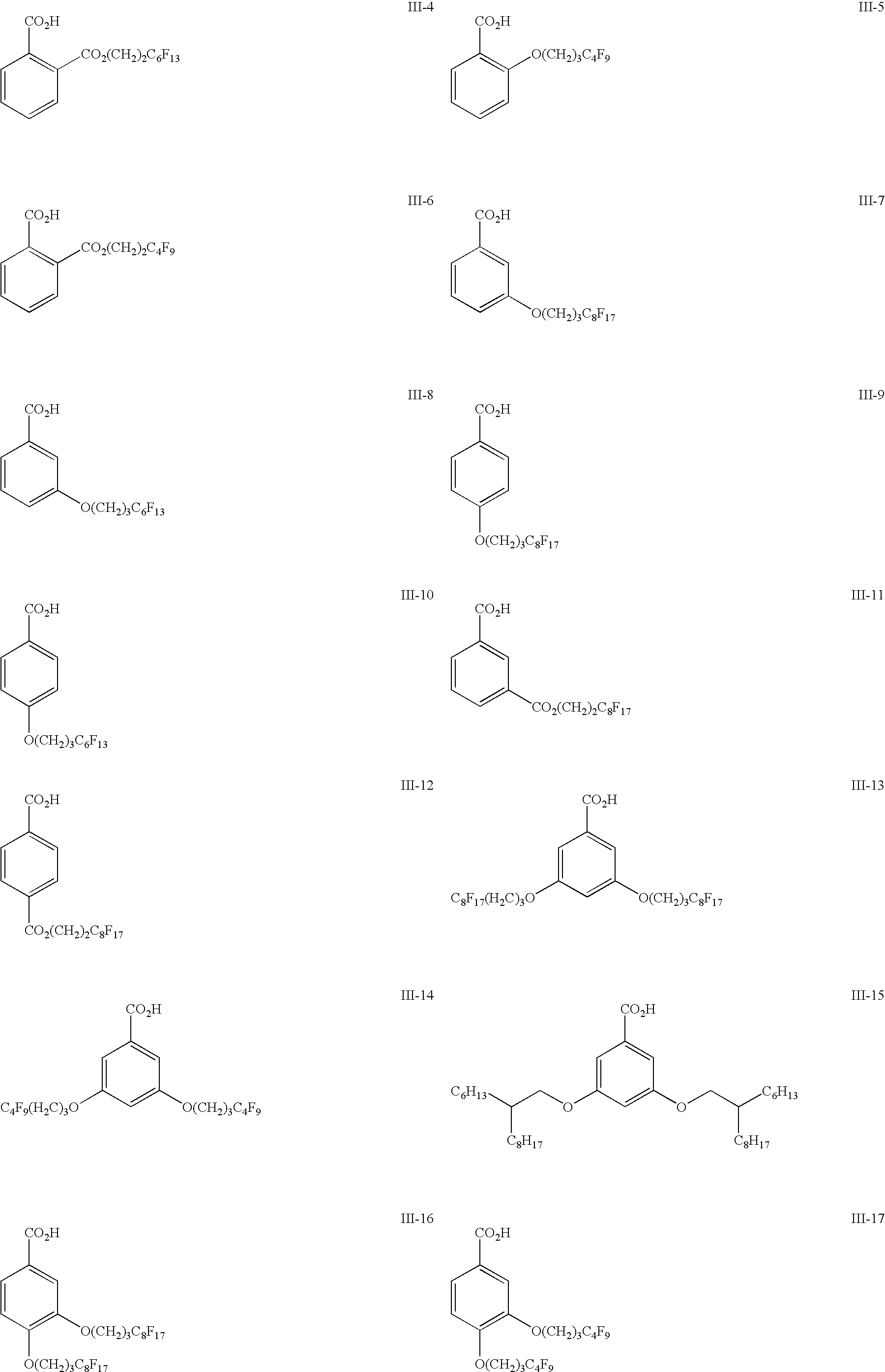

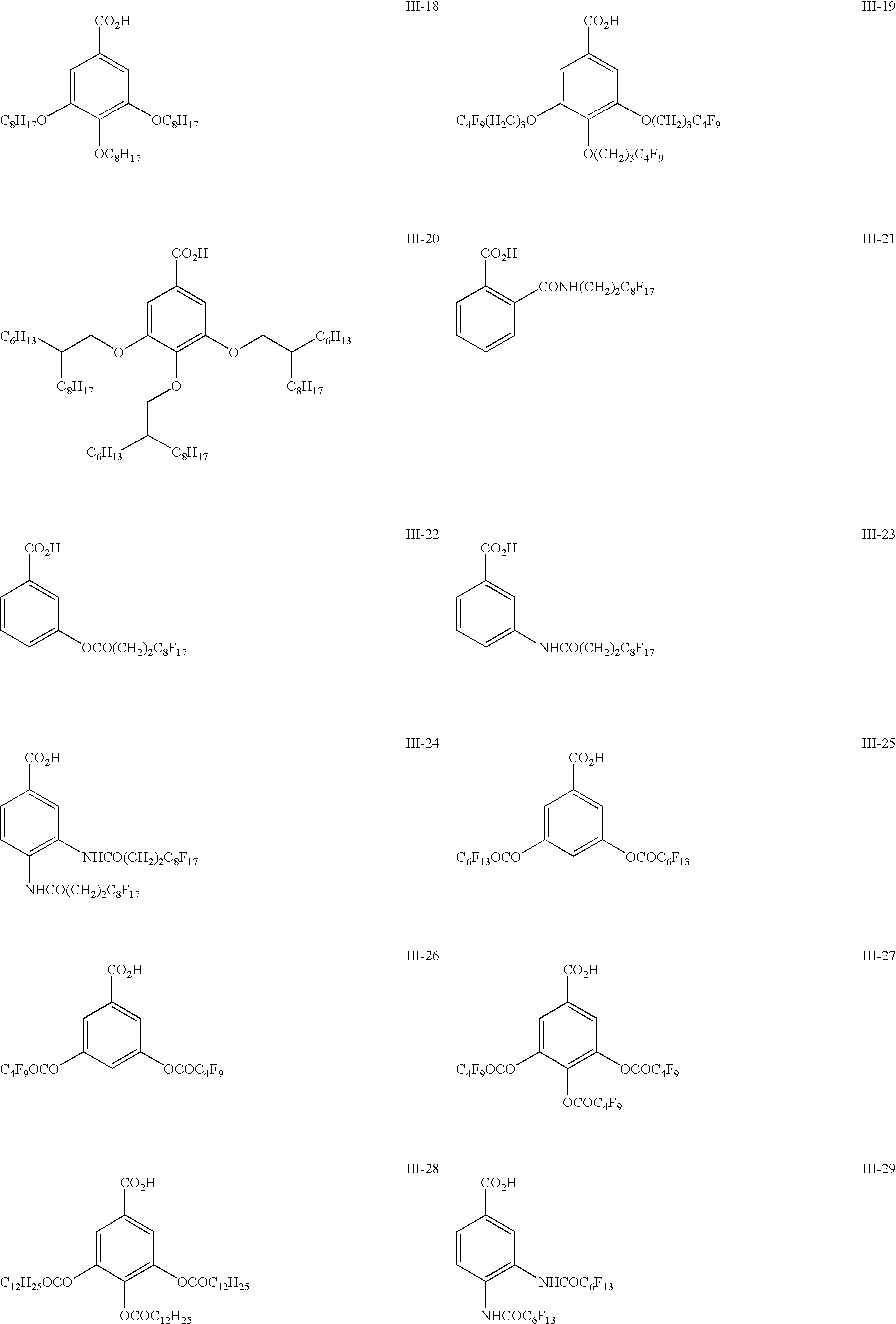

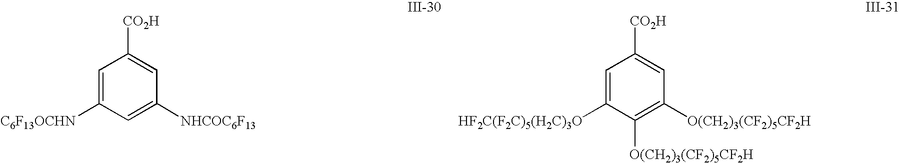

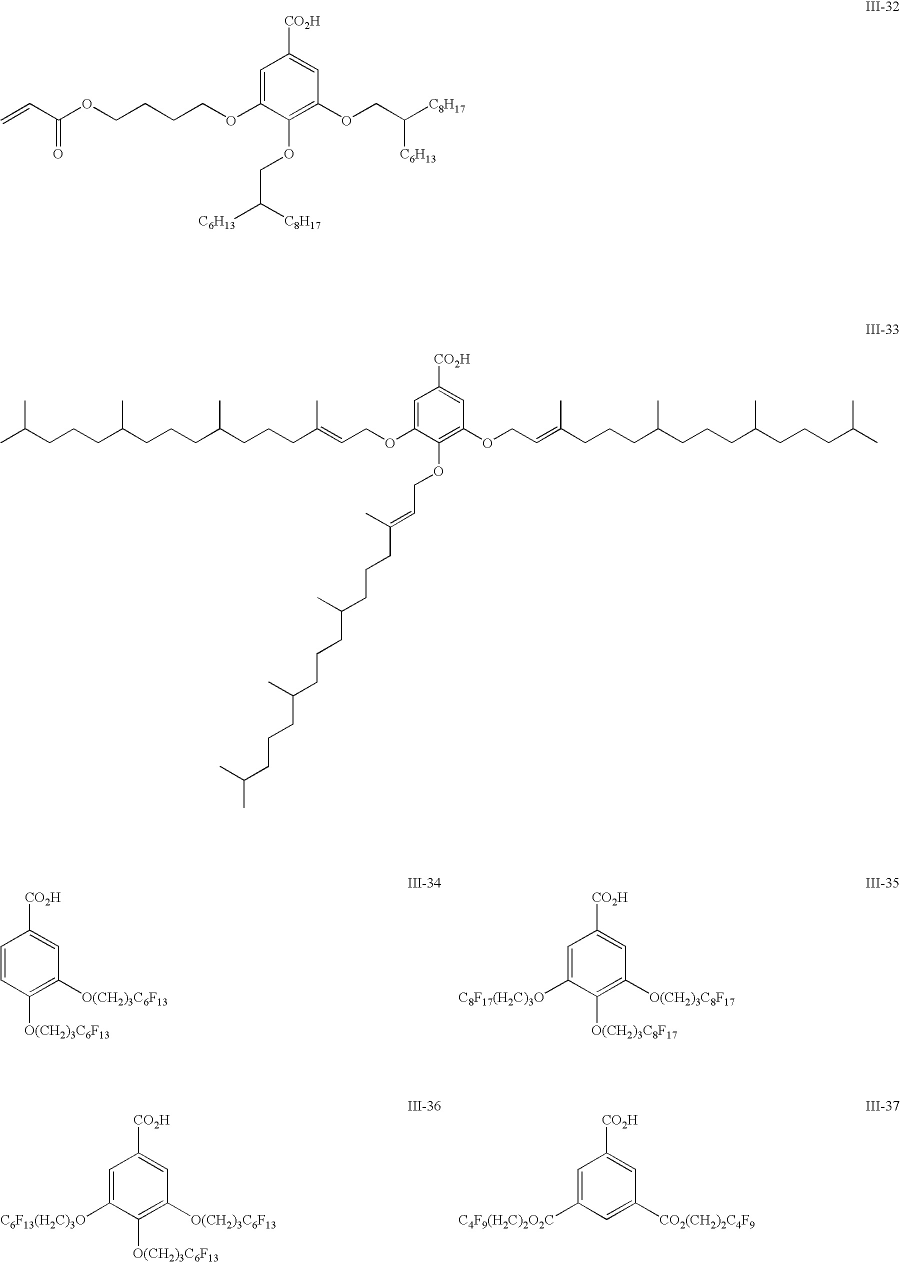

The compounds denoted respectively by the Formula (I), (II) and (III) can be prepared by a combinations of general reactions of hydroxy such as alkylation, esterification and amination.

According to the present invention, the amount of the compound denoted by the Formula (I), (II) or (III) is desirably 0.01 to 20 weight %, preferably 0.05 to 10 weight %, more preferably 0.1 to 5 weight % with respect to weight of liquid crystal compound. Two or more species of the compounds denoted by the Formula (I), (II) or (III) may be employed in combination in the present invention. The combined use of compounds denoted respectively by the Formula (I) and (II), (II) and (III), (I) and (III) or (I), (II) and (III) may be carried out.

[Preparing Optically Anisotropic Layers]

The present invention relates to a method for preparing an optically anisotropic layer formed of a liquid crystal compound hybrid-aligned, comprising a first step of aligning the liquid crystal compound in homogenous alignment, a second step of aligning the homogenous-aligned liquid crystal compound in hybrid alignment, and a third step of fixing the hybrid-aligned liquid crystal compounds. According to the present invention, optically anisotropic layers can be rapidly prepared without defects such as schlieren defects by transferring liquid crystal compounds from homogenous alignment state to hybrid alignment state.

Although it is not the actual condition, if it is expressed with an image, “hybrid alignment” means alignment in which an angle (hereinafter referred to as “a tilt angle”) between a long axis direction of a liquid crystal compound and a horizontal plane of a layer formed of the compound changes continuously in the thickwise direction of the layer. If the compound is a discotic liquid crystal compound and the layer of the compound is provided on a support, the tilt angle is an angle between the disk-like plane of the molecule and the surface of the support. And “homogenous alignment” means alignment in which a long axis direction of a liquid crystal compound is parallel to a horizontal plane of a layer formed of the compound, however, they are not required to be exactly parallel each other, in the present Specification. In the present Specification, “homogenous alignment” means alignment in which the tilt angle is less than 10°. According to the present invention, the tilt angle of the homogenous alignment in the first step is desirably not greater than 5°, preferably not greater than 3°, more preferably not greater than 2°, and most preferably not greater than 1°. Needless to say, the tilt angle may be 0°.

In the first and/or second step, electric field, magnetic field, radiation ray, heat or combinations thereof maybe applied to the liquid crystal compounds in order to align the compound in a homogenous and/or hybrid alignment. It is also possible to control the alignment of the compound by varying the amount of energy, for example heating temperature, applied to the compound between the first and second steps. From the aspect of adequacy of production, it is preferred that heating is applied to a liquid crystal compound in both of the first and second steps in order to align the compound in homogenous and hybrid alignments and the temperatures is changed between the first and second steps in order to transfer the compound from the homogenous alignment to the hybrid alignment.

According to the present invention, the compounds may be aligned in desired alignments by application of external energies described above, utilization of alignment layers and preparation of optically anisotropic layers on the alignment layers or addition of agents for controlling alignments (e.g. homogenous alignment promoters) to optically anisotropic layers. Especially, utilization of homogenous alignment promoters such as 1,3,5-triazine compounds described hereinafter allows rapid preparation of defect-free optically anisotropic layers.

Next, two preferred embodiments of the present invention will be described. The first embodiment of the present invention is the method wherein the temperature for homogenous alignment in the first step is higher than that for hybrid alignment in the second step; and the second embodiment is the method wherein the temperature for homogenous alignment in the first step is lower than that for hybrid alignment in the second step.

### (1) First Embodiment (T¹>T²)

In the first embodiment, at first a solution of dissolved a discotic liquid crystal compound, if necessary, and one or more additives such as 1,3,5-triazine compounds in solvent is applied to an alignment layer and dried. The solution is heated up to a temperature at which a nematic phase of the liquid crystal compound appears, and subsequently heated up to a temperature, T₁ (degrees Celsius), at which the liquid crystal compound is aligned in homogenous alignment. Subsequently, cooled by a temperature, T₂ (<T₁) (degrees Celsius), at which the liquid crystal compound is aligned in hybrid alignment. Next, polymerization, for example initiated by irradiation of UV light, of the liquid crystal compound and/or optionally added additives are carried out, thereby fixing the hybrid alignment. According to the method, optically anisotropic layers formed of hybrid aligned liquid crystal compounds can be prepared rapidly without schlieren defects.

In the present embodiment, controlling temperatures in the first and second steps is important. T₁ at which homogenous alignment appears is desirably 50 to 200 degrees Celsius, preferably 70 to 200 degrees Celsius, and more preferably 90 to 150 degrees Celsius.

In the first embodiment, T₁ at which homogenous alignment appears is higher than T₂ at which hybrid alignment appears. The temperature difference, (T₁−T₂), is desirably not smaller than 10 degrees Celsius, and preferably not smaller than 20 degrees Celsius. T₂ at which the liquid crystal compounds transfer from homogenous alignment to hybrid alignment, is desirably 50 to 200 degrees Celsius, preferably 70 to 150 degrees Celsius, and more preferably 90 to 130 degrees Celsius.

The T₁ and T₂ may be measured as a temperature on surface side of a layer.

T₁ and T₂ vary according to the species of the liquid crystal compounds, or the kinds or the amount of additives described hereinafter, and T₁ and T₂ may be decided based on them. The periods the temperatures are maintained at T₁ and T₂ and the period for changing from T₁ to T₂ may be decided according to the species of the liquid crystal compounds or the like.

Next, homogenous alignment promoters which may be used in the first embodiment will be described in detail.

According to the first embodiment, 1,3,5-triazine compounds are desirably used with liquid crystal compounds. The 1,3,5-triazine compounds may not only promote homogenous alignment of the liquid crystal compounds in the first step, but also promote the liquid crystal compounds transferring from homogenous alignment state to hybrid alignment state in the second step by the cooperative actions of the molecular interaction. Adding the 1,3,5-triazine compounds to layers may also bring about the improvement in wetability between the layers and the substrates supporting them.

The 1,3,5-triazine compounds used in the present embodiment are not limited as long as they have promoting abilities described above, the 1,3,5-triazine compounds represented by Formula (IV) bellow are desirably.

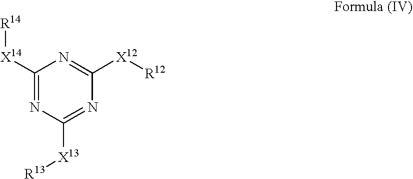

In the formula, X¹², X¹³ and X¹⁴ denote respectively a single bond or divalent linking group; R¹², R¹³ or R¹⁴ respectively denote a hydrogen atom or substituent group.

The divalent linking group denoted respectively by X¹², X¹³ and X¹⁴ is desirably a divalent linking group selected from the group consisting of an alkylene group, alkenylene group, arylene group, divalent heterocyclic group, —CO—, —NR^{a}— (R^{a} denotes a C1-5 alkyl group or hydrogen atom), —O—, —S—, —SO—, —SO₂— and combinations thereof; preferably a divalent linking group selected form the group consisting of alkylene group, alkenylene group, —CO—, —NR^{a}—, —O—, —S—, —SO₂— and combinations thereof; and more preferably a divalent linking group selected from the group consisting of alkylene group, —CO—, —NR^{a}—, —O—, —S—, —SO₂— and the combination of two or three thereof. The number of carbon atoms included in the alkylene group is desirably 1 to 12. The number of carbon atoms included in the alkenylene group is desirably 2 to 12. The number of carbon atoms included in the arylene group is desirably 6 to 10. The alkylene group, alkenylene group and arylene group may be substituted with one or more substituents exemplified hereinafter as substituents for R¹², R¹³ and R¹⁴, such as an alkyl group, halogen atom, cyano, alkoxy group and acyloxy group.

Examples of the substituents respectively denoted by R¹², R¹³ and R¹⁴ include alkyl groups (desirably alkyl groups having from 1 to 20 carbon atoms, preferably having from 1 to 12 carbon atoms, and more preferably having from 1 to 8 carbon atoms; examples are methyl, ethyl, isopropyl, tert-butyl, n-octyl, n-decyl, n-hexadecyl, cyclopropyl, cyclopentyl, and cyclohexyl), alkenyl groups (desirably alkenyl groups having from 2 to 20 carbon atoms, preferably from 2 to 12 carbon atoms, and more preferably having from 2 to 8 carbon atoms; examples are vinyl, allyl, 2-butenyl, and 3-pentenyl), alkynyl groups (desirably alkynyl groups having from 2 to 20 carbon atoms, preferably from 2 to 12 carbon atoms, and more preferably from 2 to 8 carbon atoms; examples are propargyl and 3-pentinyl), aryl groups (desirably aryl groups having from 6 to 30 carbon atoms, preferably having from 6 to 20 carbon atoms, and more preferably having from 6 to 12 carbon atoms; examples are phenyl, p-methylphenyl, and naphthyl), optionally substituted amino groups (desirably amino groups having from 0 to 20 carbon atoms, preferably having from 0 to 10 carbon atoms, and more preferably having from 0 to 6 carbon atoms; examples are unsubstituted amino, methylamino, dimethylamino, diethylamino and anilino), alkoxy groups (desirably alkoxy groups having from 1 to 20 carbon atoms, preferably having from 1 to 12 carbon atoms, and more preferably having from 1 to 8 carbon atoms; examples are methoxy, ethoxy, and butoxy), aryloxy groups (desirably aryloxy groups having from 6 to 20 carbon atoms, preferably having from 6 to 16 carbon atoms, and more preferably having from 6 to 12 carbon atoms; examples are phenyloxy and 2-naphthyloxy), acyl groups (desirably acyl groups having from 1 to 20 carbon atoms, preferably having from 1 to 16 carbon atoms, and more preferably having from 1 to 12 carbon atoms; examples are acetyl, benzoyl, formyl, and pivaloyl), alkoxycarbonyl groups (desirably alkoxycarbonyl groups having from 2 to 20 carbon atoms, preferably having from 2 to 16 carbon atoms, and more preferably having from 2 to 12 carbon atoms; examples are methoxycarbonyl and ethoxy carbonyl), aryloxycarbonyl groups (desirably aryloxycarbonyl groups having from 7 to 20 carbon atoms, preferably having from 7 to 16 carbon atoms, and more preferably having from 7 to 10 carbon atoms; examples include phenyloxycarbonyl), acyloxy groups (desirably acyloxy groups having from 2 to 20 carbon atoms, preferably having from 2 to 16 carbon atoms, and more preferably having from 2 to 10 carbon atoms; examples are acetoxy and benzoyloxy), acylamino groups (desirably acylamino groups having from 2 to 20 carbon atoms, preferably having from 2 to 16 carbon atoms, and more preferably having from 2 to 10 carbon atoms; examples are acetylamino and benzoylamino), alkoxycarbonylamino groups (desirably alkoxycarbonylamino groups having from 2 to 20 carbon atoms, preferably having from 2 to 16 carbon atoms, and more preferably having from 2 to 12 carbon atoms; examples include methoxycarbonylamino), aryloxycarbonylamino groups (desirably aryloxycarbonylamino groups having from 7 to 20 carbon atoms, preferably having from 7 to 16 carbon atoms, and more preferably having from 7 to 12 carbon atoms; examples include phenyloxycarbonylamino), sulfonylamino groups (desirably sulfonylamino groups having from 1 to 20 carbon atoms, preferably having from 1 to 16 carbon atoms, and more preferably having from 1 to 12 carbon atoms; examples are methanesulfonylamino and benzenesulfonylamino), sulfamoyl groups (preferably sulfamoyl groups having from 0 to 20 carbon atoms, preferably having from 0 to 16 carbon atoms, and more preferably having from 0 to 12 carbon atoms; examples are sulfamoyl, methylsulfamoyl, dimethylsulfamoyl and phenylsulfamoyl), carbamoyl groups (desirably carbamoyl groups having from 1 to 20 carbon atoms, preferably having from 1 to 16 carbon atoms, and more preferably having from 1 to 12 carbon atoms; examples are unsubstituted carbamoyl, methylcarbamoyl, diethylcarbamoyl and phenylcarbamoyl), alkylthio groups (desirably alkylthio groups having from 1 to 20 carbon atoms, preferably having from 1 to 16 carbon atoms, and more preferably having from 1 to 12 carbon atoms; examples are methylthio and ethylthio), arylthio groups (desirably arylthio groups having from 6 to 20 carbon atoms, preferably having from 6 to 16 carbon atoms, and more preferably having from 6 to 12 carbon atoms; examples include phenylthio), sulfonyl groups (desirably sulfonyl groups having from 1 to 20 carbon atoms, preferably having from 1 to 16 carbon atoms, and more preferably having from 1 to 12 carbon atoms; examples are mesyl and tosyl), sulfinyl groups (desirably sulfinyl groups having from 1 to 20 carbon atoms, preferably having from 1 to 16 carbon atoms, and more preferably having from 1 to 12 carbon atoms; examples are methanesulfinyl and benzenesulfinyl); ureido groups (desirably ureido groups having from 1 to 20 carbon atoms, preferably having from 1 to 16 carbon atoms, and more preferably having from 1 to 12 carbon atoms; examples are unsubstituted ureido, methylureido and phenylureido), phosphoramide groups (desirably phosphoramide groups having from 1 to 20 carbon atoms, preferably having from 1 to 16 carbon atoms, and more preferably having from 1 to 12 carbon atoms; examples are diethyl phosphoramide and phenyl phosphoramide), hydroxy, mercapto, halogen atoms (for example, fluorine, chlorine, bromine and iodine), cyano, sulfo, carboxyl, nitro, hydroxamic acid groups, sulfino, hydrazino, imino, heterocyclic groups (desirably heterocyclic groups having from 1 to 30 carbon atoms, preferably having from 1 to 12 carbon atoms; examples are heterocyclic groups having a hetero atom such as nitrogen, oxygen, or sulfur; examples are imidazolyl, pyridyl, quinolyl, furyl, piperidyl, morpholino, benzoxazolyl, benzimidazolyl, and benzthiazolyl), and silyl groups (desirably silyl groups having from 3 to 40 carbon atoms, preferably having from 3 to 30 carbon atoms, and more preferably having from 3 to 24 carbon atoms; examples are trimethylsilyl and triphenylsilyl). These substituents maybe further substituted with these substituents. Further, when there are two or more substituents, they may be identical or different. When possible, they may be bonded together to form a ring.

The substituent group denoted respectively R¹², R¹³ and R¹⁴ is desirably an alkyl group, aryl group, substituted or non-substituted amino group, alkoxy group, aryloxy group, aryloxycarbonyl group, acyloxy group, acylamino group, aryloxycarbonylamino group, sulfonylamino group, sulfamoyl group, carbamoyl group, arylthio group, sulfonyl group, ureido group or heterocyclic group; and preferably an aryl group, substituted or non-substituted amino group, aryloxy group, aryloxycarbonyl group, acyloxy group, acylamino group, aryloxycarbonylamino group, sulfonylamino group, sulfamoyl group, carbamoyl group, arylthio group or heterocyclic group.

The compounds represented by the Formula (IV) are desirably represented by Formula (IVa).

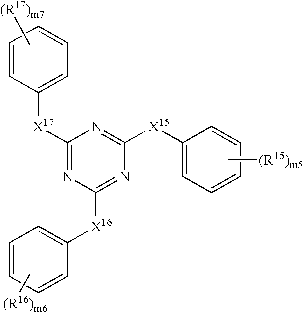

In the formula (IVa), X¹⁵, X¹⁶ and X¹⁷ respectively denote a divalent linking group selected from the group consisting of —CO—, —NR^{a}— (R^{a} denotes a C1-5 alkyl group or hydrogen atom), —O—, —S—, —SO—, —SO₂— and combinations thereof; and preferably X¹⁵, X¹⁶ and X¹⁷ respectively denote —NR^{a}—, —N(R^{a}) CO—, —N(R^{a}) SO₂—, —O— or —S—. R^{a} is desirably hydrogen.

In the formula (IVa), R¹⁵, R¹⁶ and R¹⁷ respectively denote a substituted or non-substituted alkoxy group; m⁵, m⁶ and m⁷ are respectively integers from 1 to 5. m⁵, m⁶ and m⁷ are respectively 2 or 3. When m⁵, m⁶ and m⁷ are not smaller than 2, plural R¹⁵, R¹⁶ and R¹⁷ are respectively identical or different each other.

The compounds represented by the Formula (IV) are preferably represented by Formula (IVb).

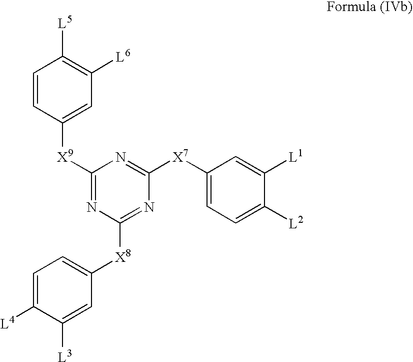

In the formula, X⁷, X⁸ and X⁹ respectively denote —NH—, —NHCO—, —NHSO₂—, —O— or —S—; L¹, L², L³, L⁴, L⁵ and L⁶ respectively denote the group denoted by Formula (IVc) or (IVd).

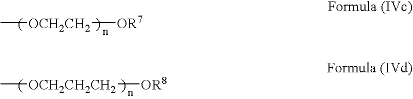

In the formulae (IVc) and (IVd), R⁷ and R⁸ respectively denote a substituted or non-substituted alkyl group. The alkyl group may have a straight or branching structure. The number of carbon atoms included in the alkyl group is desirably from 1 to 20, preferably from 4 to 16 and more preferably 8 to 16. The alkyl group may be substituted with one or more substituents exemplified above as substituents denoted by R¹², R¹³ and R¹⁴. The substituents for the alkyl group is preferably a halogen atom, and more preferably fluorine atom. n¹ is an integer from 1 to 12, preferably from 1 to 8 and more preferably from 2 to 6.

The compounds represented by the Formula (IV), (IVa) and (IVb) may have one or more polymerizable groups for fixing liquid crystal compounds in alignment states.

Specific examples of the compounds denoted respectively by the Formula (IV) are given below. However, compounds that can be employed in the present invention are not limited to these compounds.

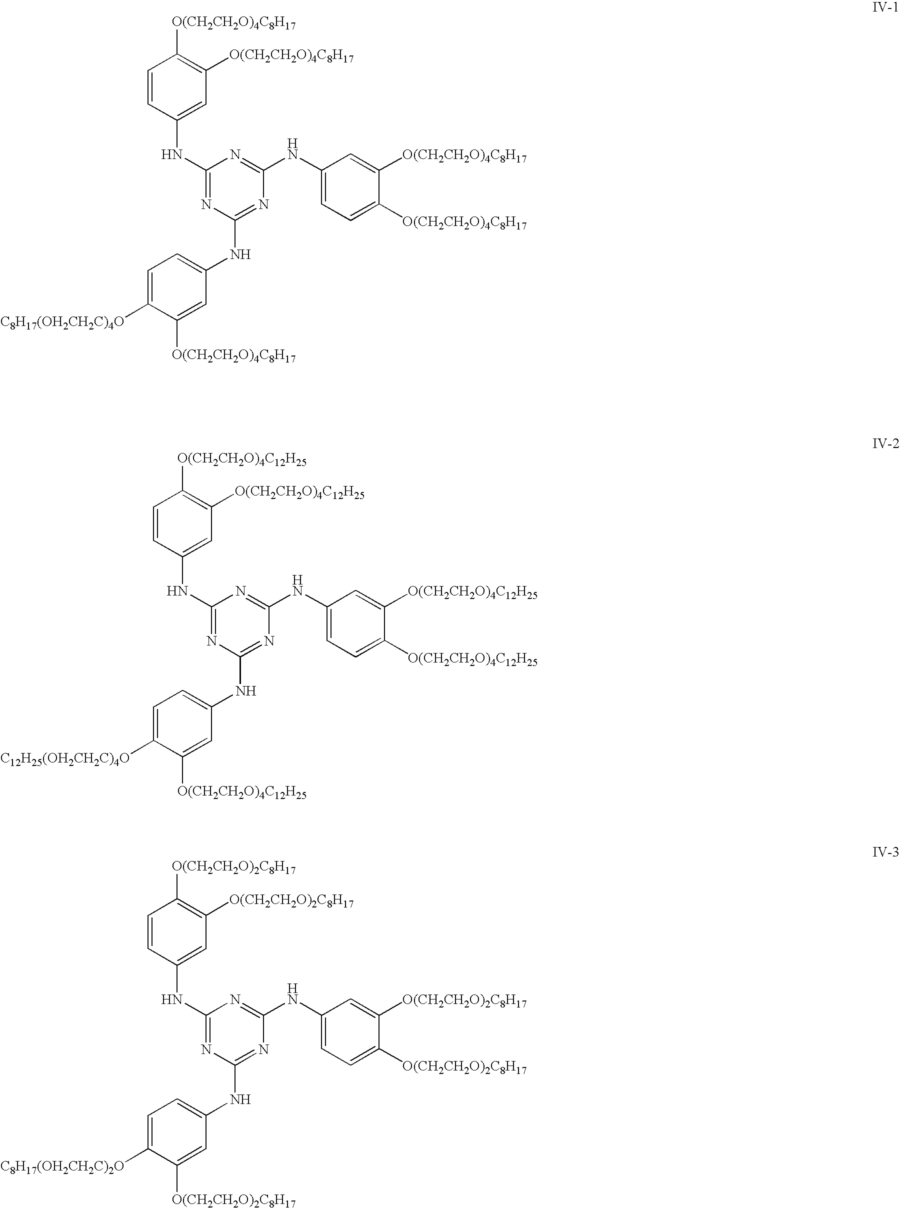

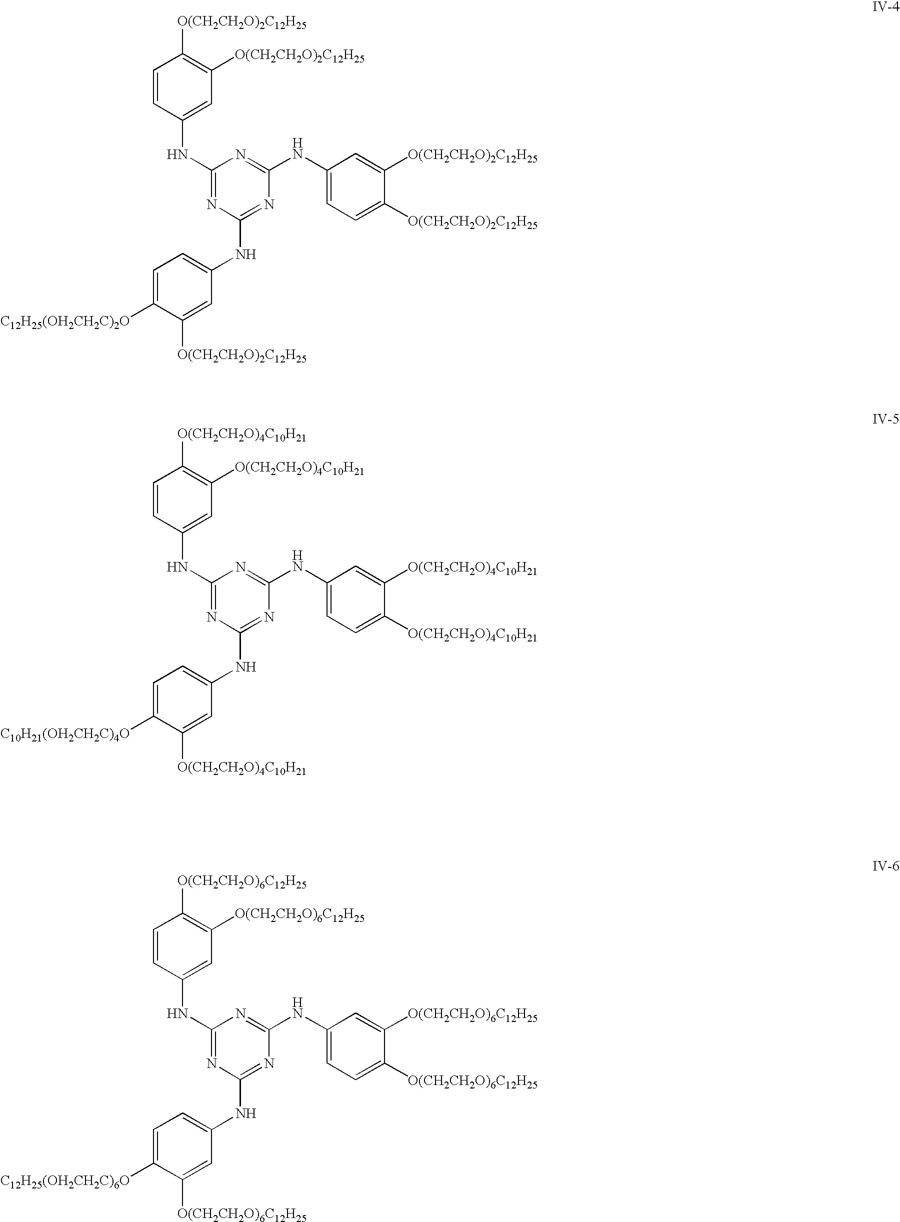

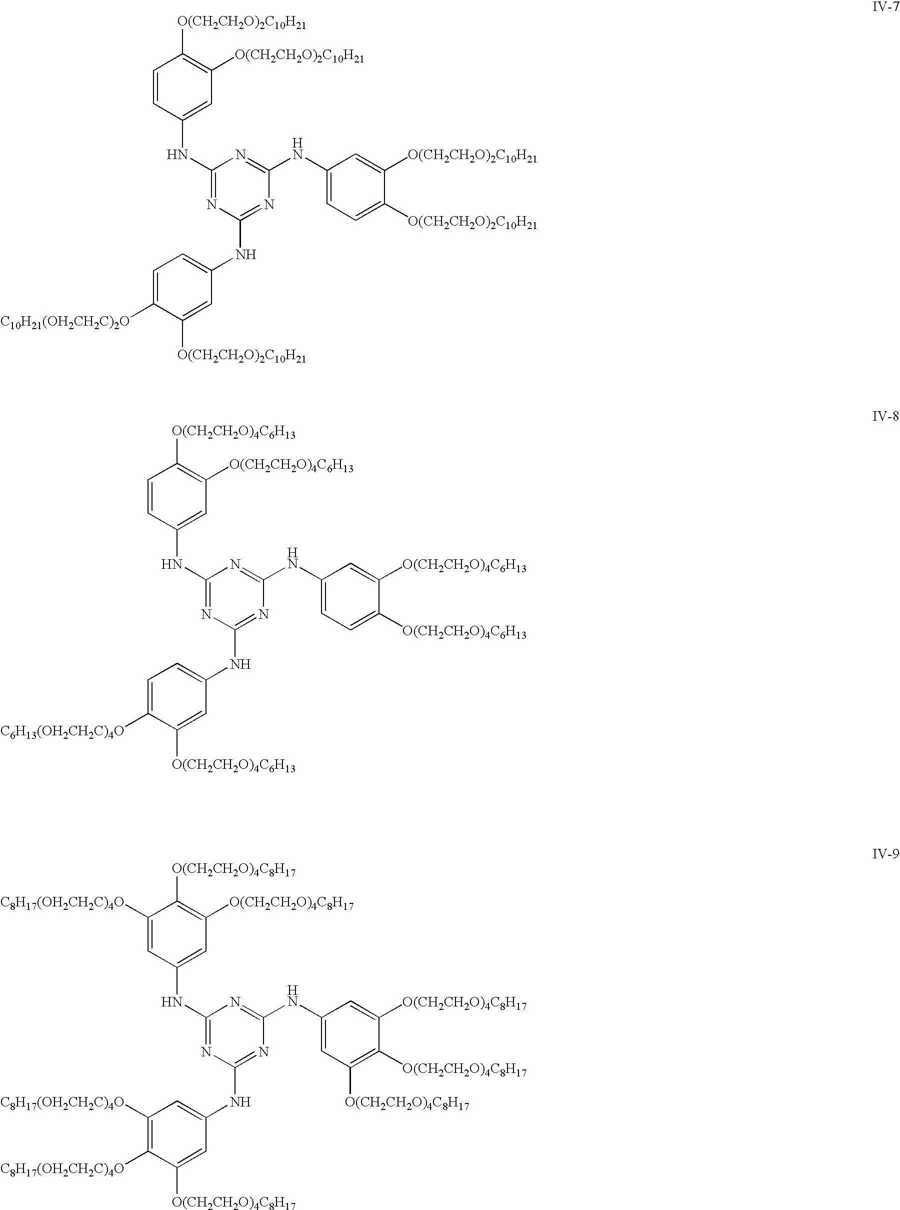

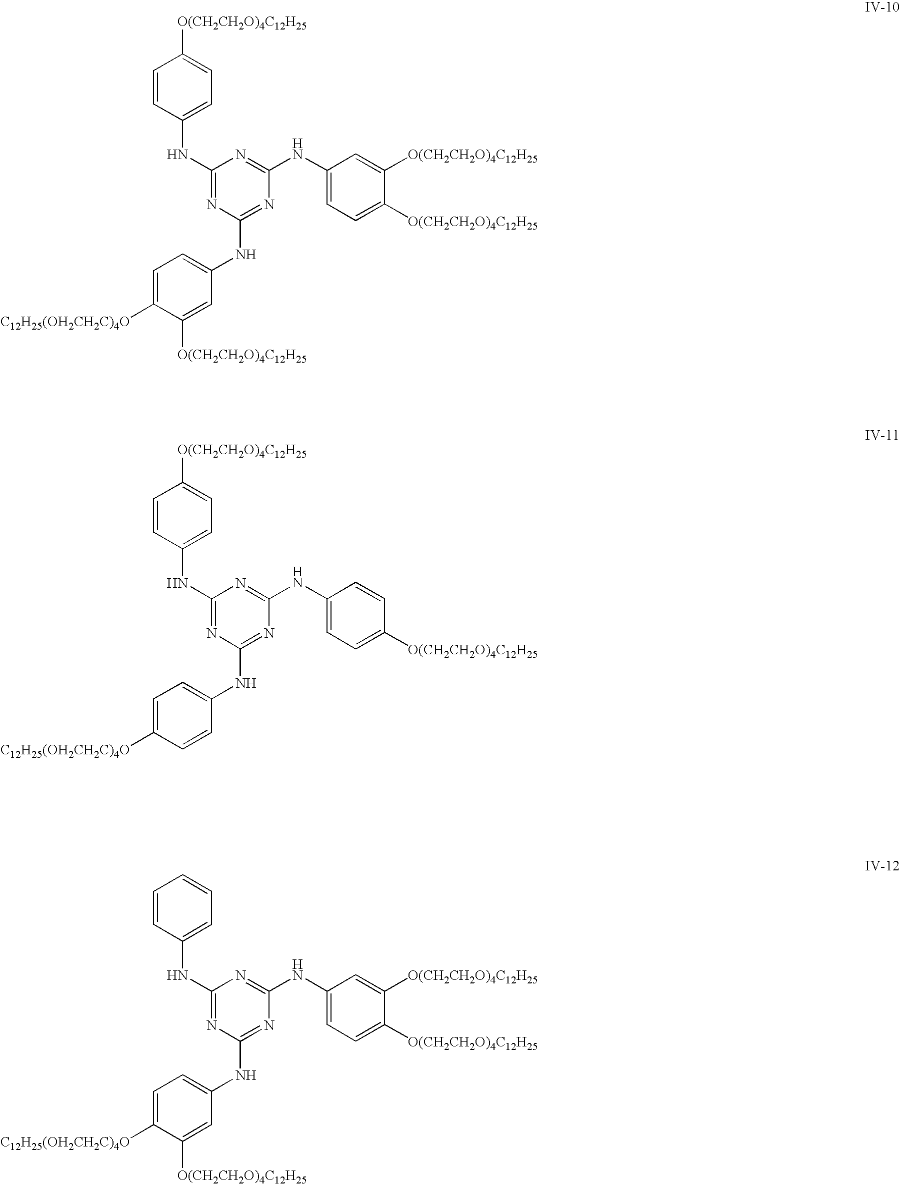

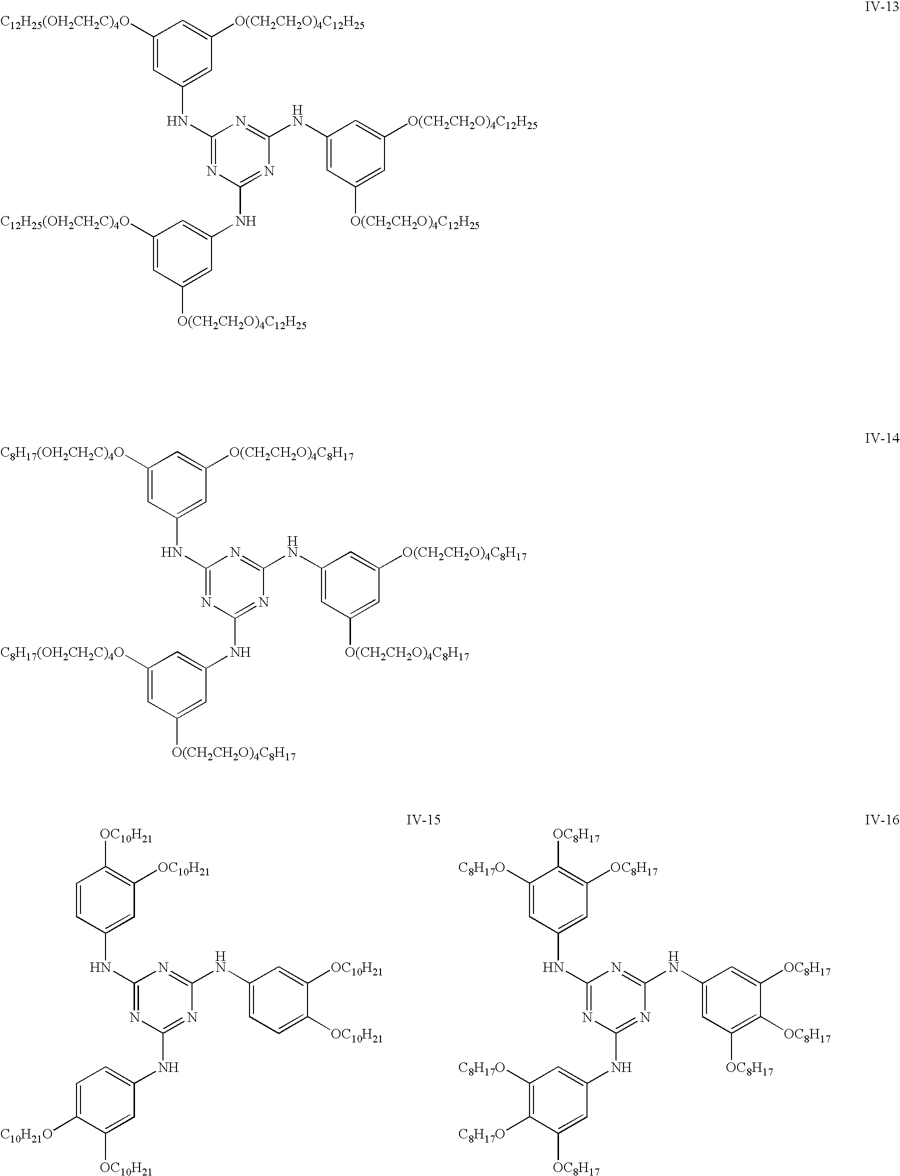

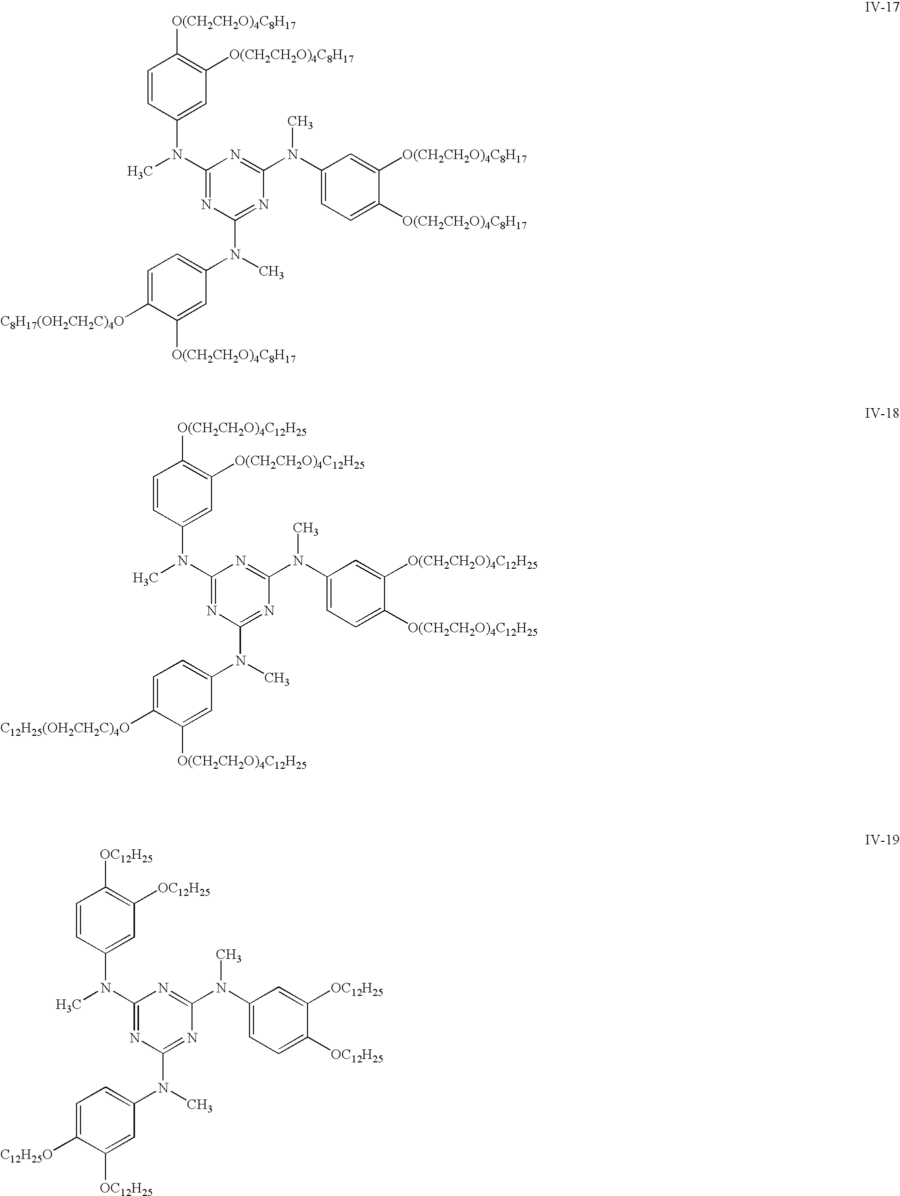

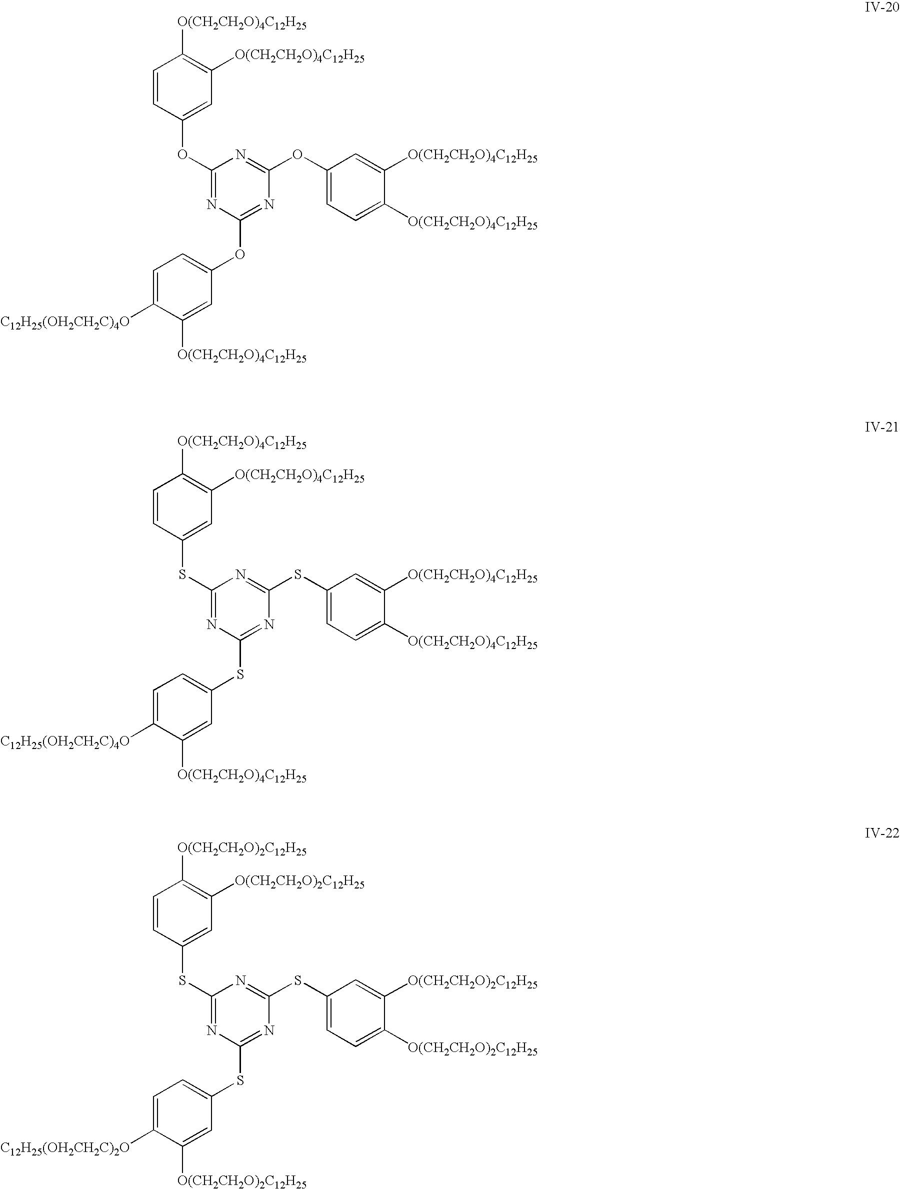

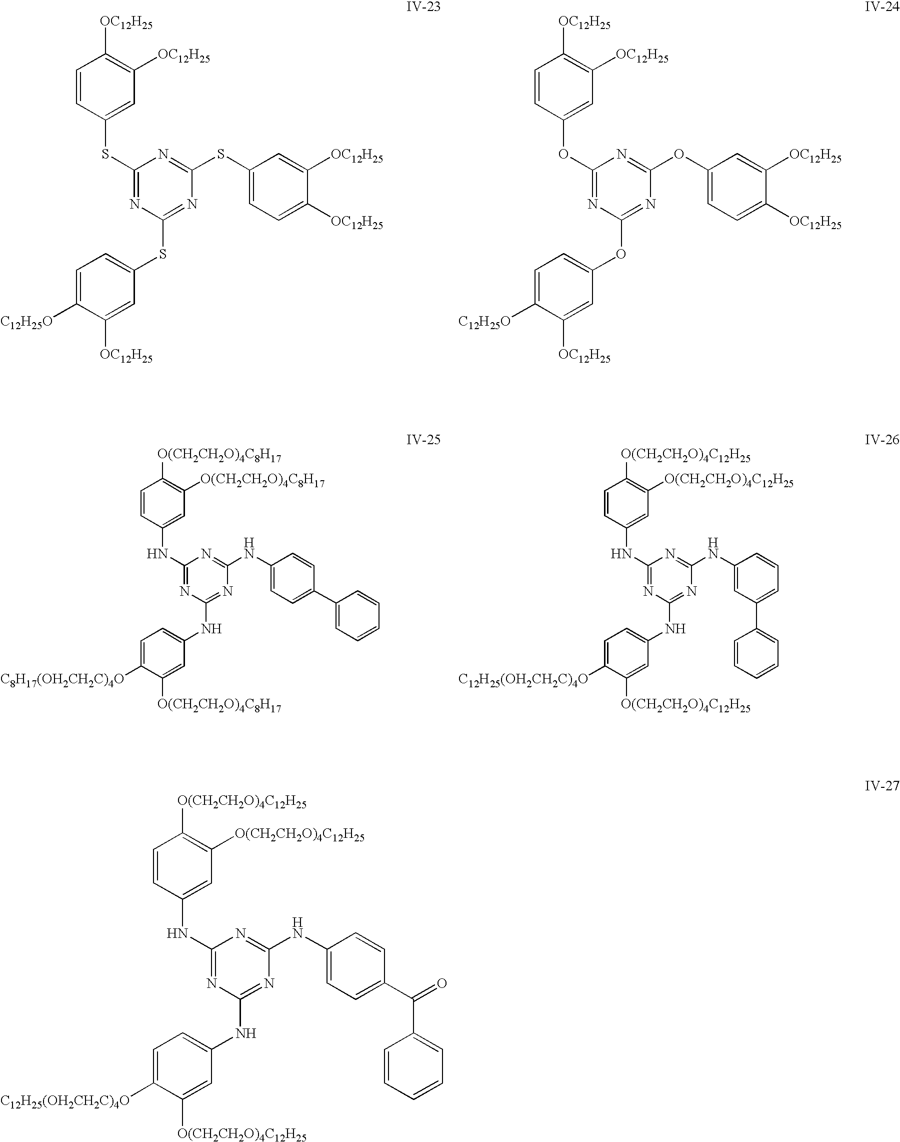

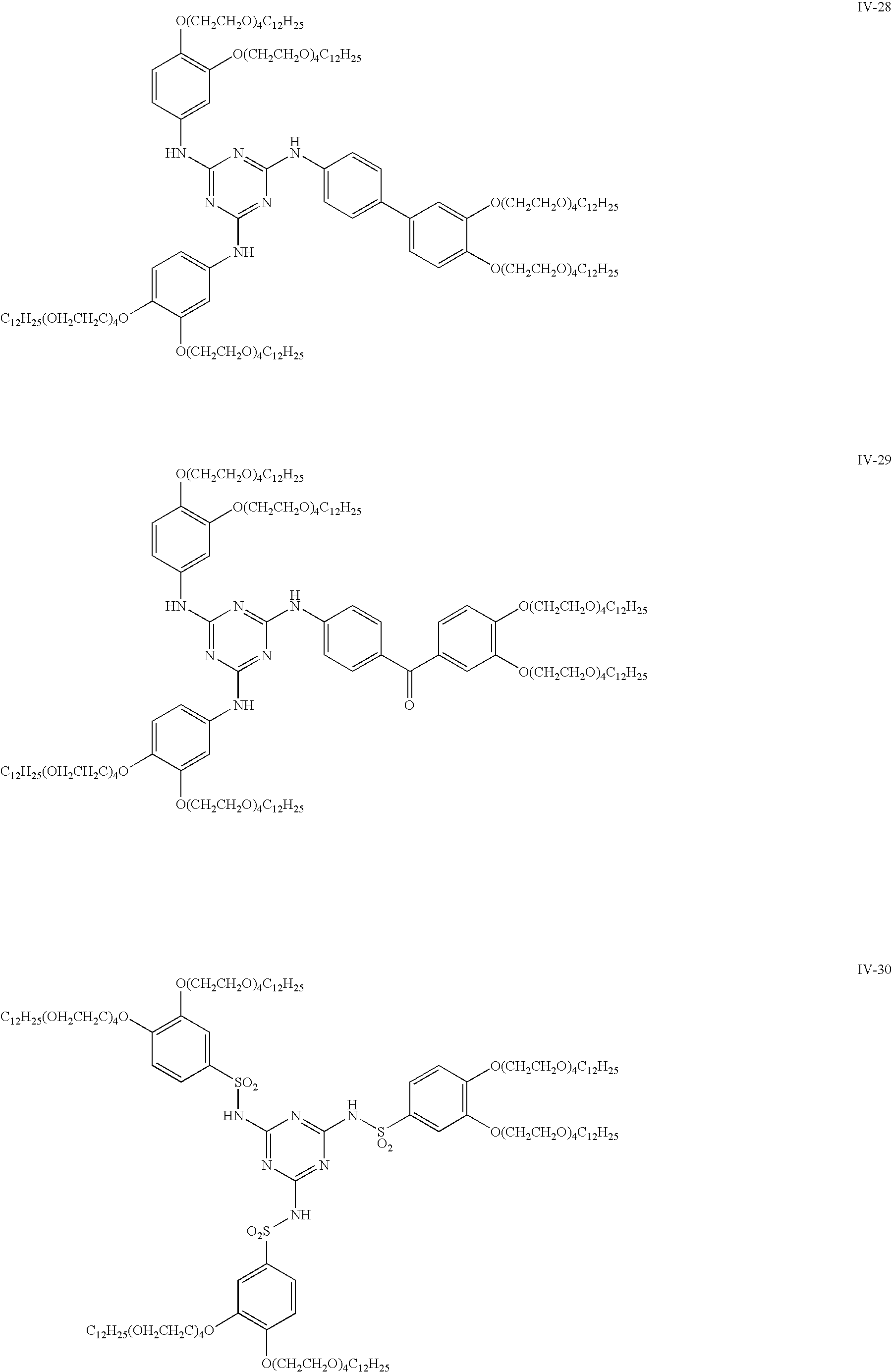

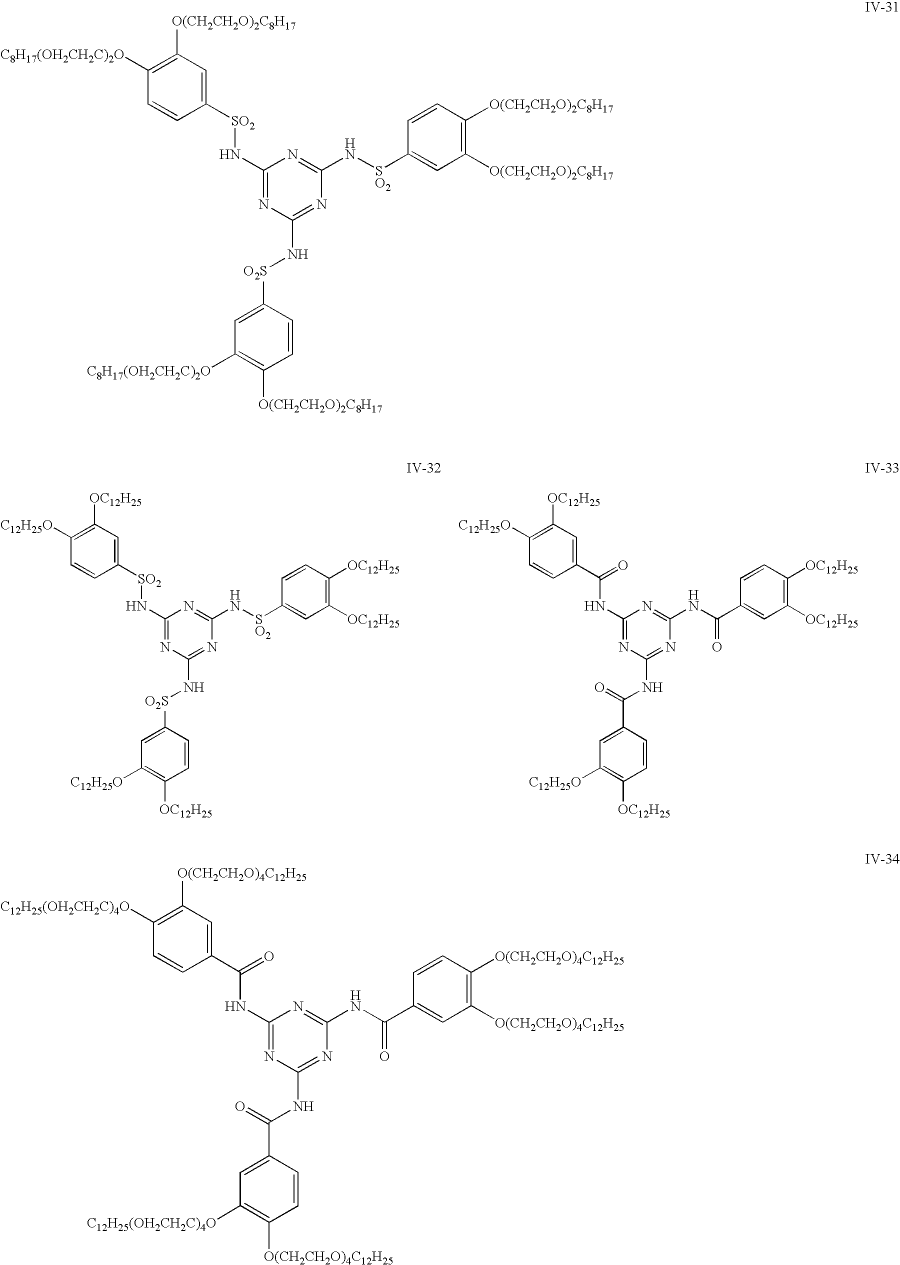

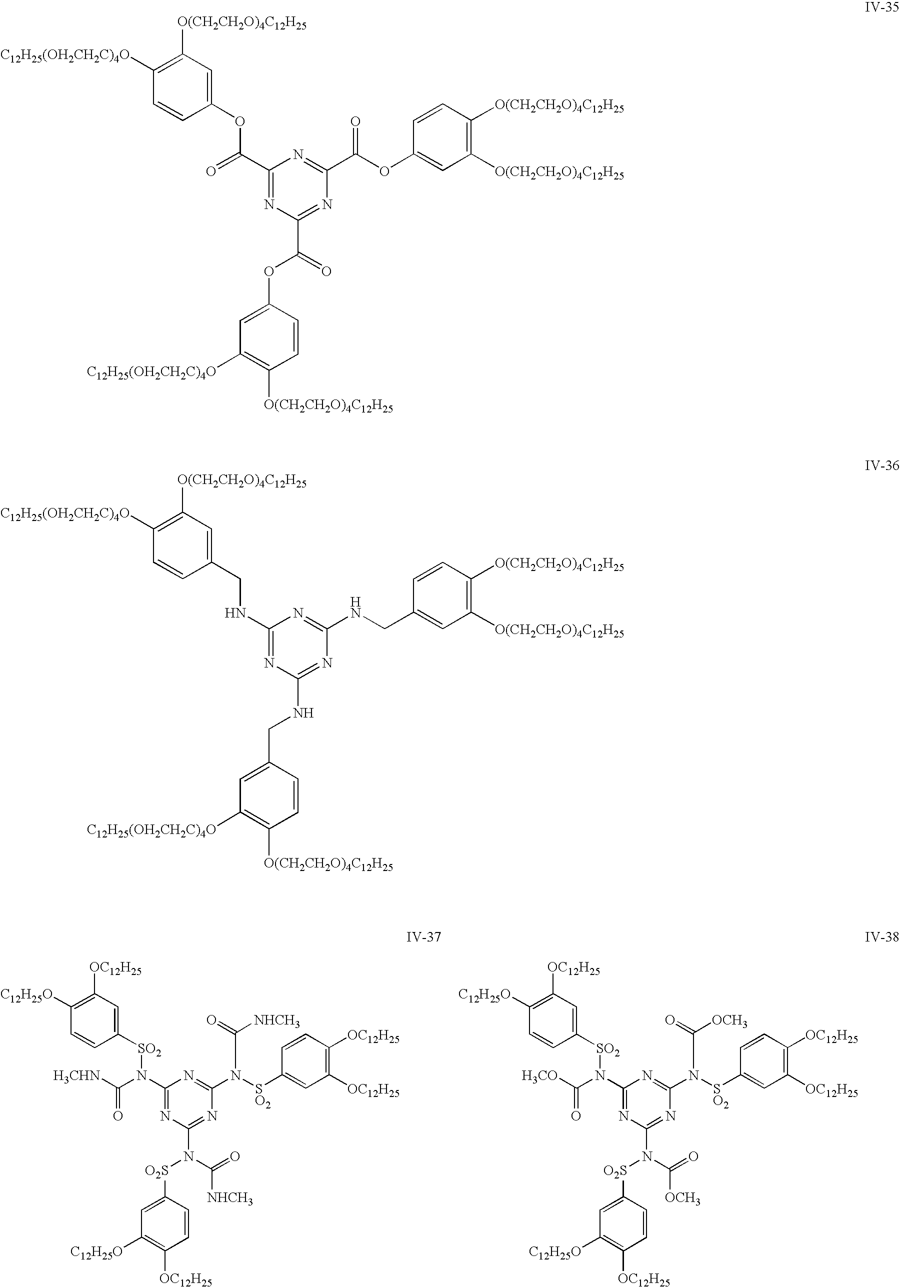

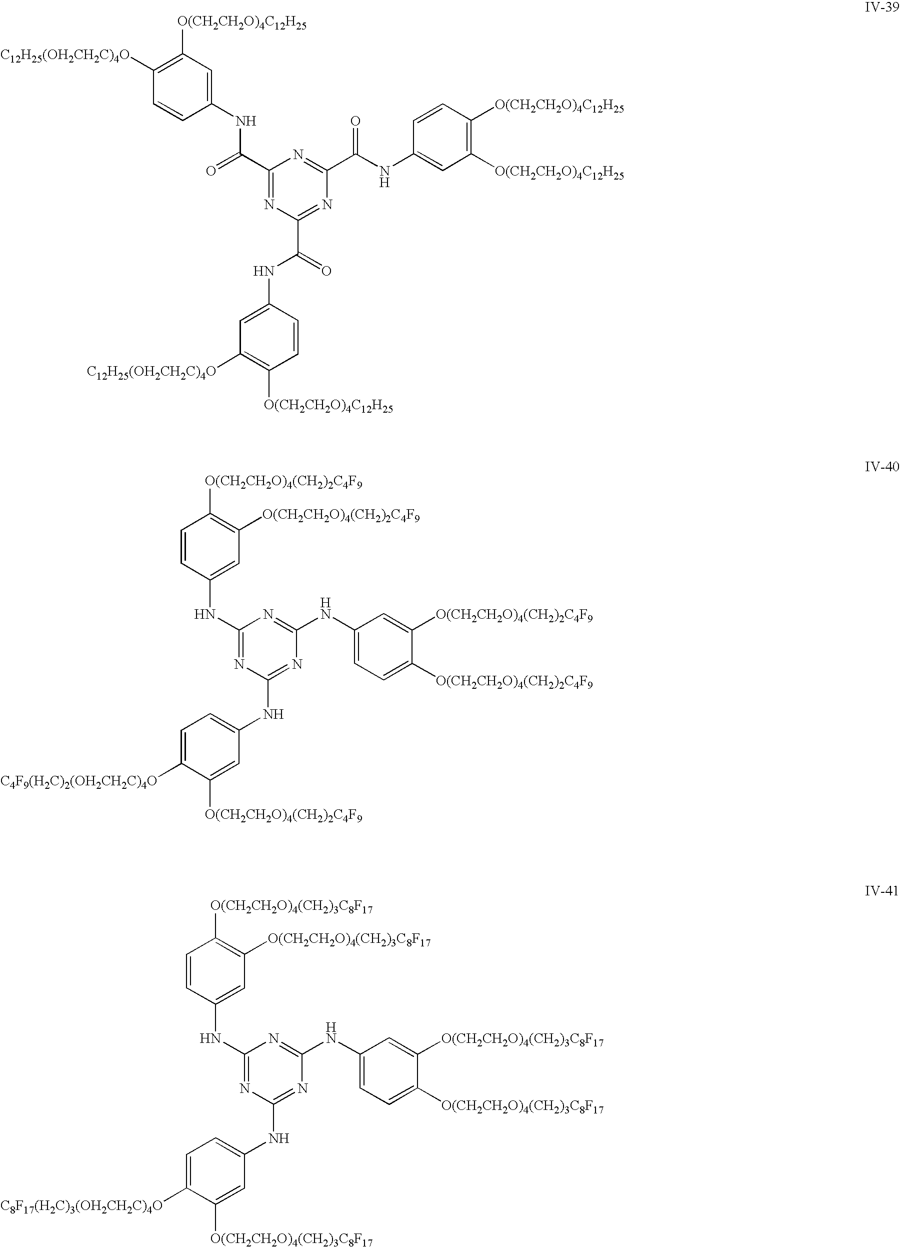

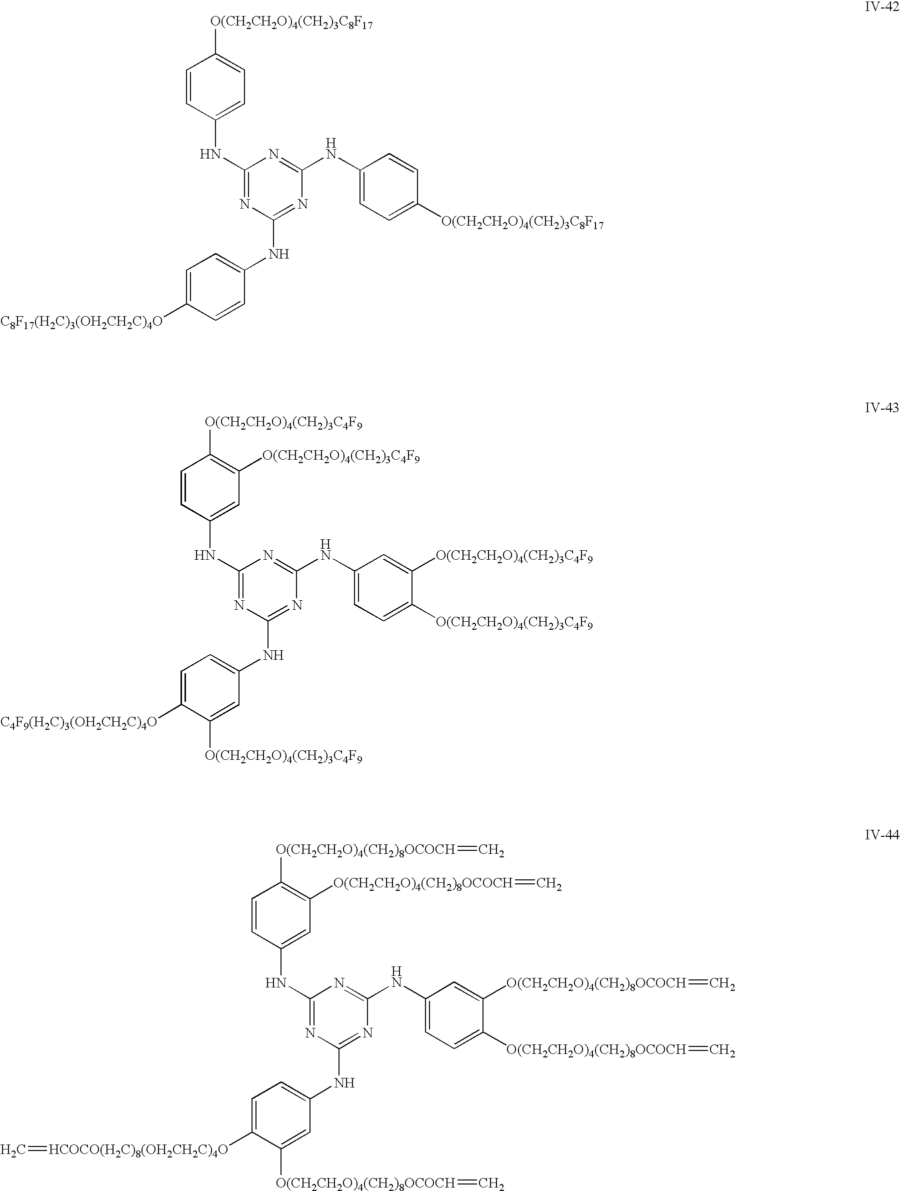

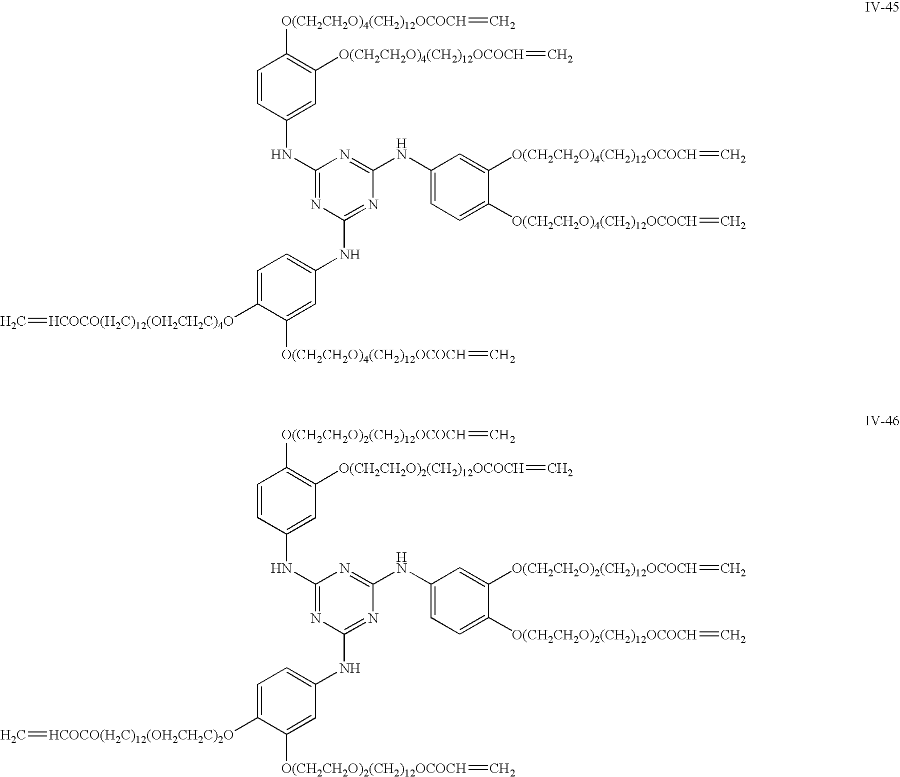

One or more species of the 1,3,5-triazine compounds may be used in the present embodiment. The amount of the 1,3,5-triazine compound is desirably from 0.01 to 20 wt % with respect to weight of liquid crystal compound preferably from 0.05 to 10 wt %, and more preferably from 0.1 to 5 wt %.

In the present embodiment, various homogenous alignment promoters other than 1,3,5-triazin compounds may also be used. The other homogenous alignment promoters may also have promoting ability similar to the 1,3,5-triazine compounds and contribute to rapid homogenous alignment of liquid crystal compound without defects. The other examples of homogenous alignment promoters include compounds having benzene rings substituted more than two long-chain alkoxy groups.

### (2) Second Embodiment (T₁<T₂)

The present embodiment relates to a method for preparing an optically anisotropic layer formed of a liquid crystal compound hybrid-aligned, comprising a first step of aligning the liquid crystal compound in homogenous alignment at T₁ (degrees Celsius) in the presence of at least two species of compounds having a function group capable of hydrogen bonding; a second step of aligning the homogenous-aligned liquid crystal compound in hybrid alignment at T₂ (T₁<T₂) (degrees Celsius) in the presence of them; and a third step of fixing the hybrid-aligned liquid crystal compound in the hybrid alignment.

In the present embodiment, for example, at first a solution dissolved a discotic compound, two species of compounds having a function group capable of hydrogen bonding, if necessary, and one or more additives in solvent is applied to an alignment layer and dried. The solution is heated up to a temperature, T₁, at which the liquid crystal compound is aligned in homogenous alignment (the first alignment step). Subsequently, heated up to a temperature, T₂ (>T₁), at which the liquid crystal compound is aligned in hybrid alignment (the second alignment step). According to the present embodiment, raising temperature may be carried out continuously or discontinuously, desirably continuously. Next, polymerization, for example initiated by irradiation of UV light, of the liquid crystal compound and/or optionally added additives are carried out, thereby fixing the hybrid alignment. According to the method, optically anisotropic layers formed of hybrid aligned liquid crystal compounds can be prepared rapidly without schlieren defects.

In the present embodiment, for example, at first absolution of dissolved a discotic liquid crystal compound and two species of compounds having a function group capable of hydrogen bonding in solvent is applied to an alignment layer and dried. The solution is heated up to a temperature at which a discotic-nematic phase of the liquid crystal compound appears and subsequently heated up to a temperature, T₁, at which the liquid crystal compound is aligned in homogenous alignment. Subsequently, heated up to a temperature, T₂ (>T₁), at which the liquid crystal compound is aligned in hybrid alignment. According to the present embodiment, raising temperature may be carried out continuously or discontinuously, desirably continuously. Next, polymerization, for example initiated by irradiation of UV light, of the liquid crystal compound and/or optionally added additives are carried out, thereby fixing the hybrid alignment. According to the method, optically anisotropic layers formed of hybrid aligned liquid crystal compounds can be prepared rapidly without schlieren defects.

Controlling temperatures in the first and second steps is also important in the second embodiment similar to the first embodiment. T₁ at which homogenous alignment appears is desirably 50 to 200 degrees Celsius, preferably 70 to 200 degrees Celsius, and more preferably 90 to 150 degrees Celsius.

In the second embodiment, T₁ at which homogenous alignment appears is lower than T₂ at which hybrid alignment appears. The temperature difference, (T₂−T₁), is desirably not smaller than 10 degrees Celsius, and preferably not smaller than 20 degrees Celsius. The T₁ and T₂ maybe measured as a temperature on surface side of a layer.

The T₁ and T₂ vary according to the kinds of the liquid crystal compounds, or the kinds or the amount of additives described hereinafter, and T₁ and T₂ may be decided based on them. The periods in which the temperatures are maintained at T₁ and T₂, and the period for changing from T₁ to T₂ may be decided according to the kinds of the liquid crystal compounds or the like.

Next, compounds having a function group capable of hydrogen bonding which are used in the second embodiment will be described in detail.

According to the second embodiment, at least two species of compounds having a function group capable of hydrogen bonding are used with liquid crystal compounds. Hydrogen bonds occur in molecules that have hydrogen atoms bound to electronic negative atoms such as O, N, F and Cl. For example, theoretical explanation of hydrogen bond is described in “Journal of American Chemical Society, vol. 99, p. 1316˜1332(1977), H. Uneyama and K. Morokuma”. The specific types of hydrogen bonds are described in FIG. 17 on page 98 of “Intermolecular and Surface Forces” written by Israelachvili, translated by T. Kondo and H. Ohshima. Specific examples of hydrogen bonds are described in “Angewante Chemistry International Edition English, vol. 34, p. 2311(1995), G. R. Desiraju” and the like. The compounds having a function group capable of hydrogen bonding may form complexes by hydrogen bonds, to thereby promote homogenous alignment in the first step. Being applied thermal energy, hydrogen bond cleavages may occur, to thereby promote the liquid crystal compounds transferring from the homogenous alignment state to a hybrid alignment state in the second step. Adding the compounds having a function group capable of hydrogen bonding to layers may also bring about the improvement in wetability between the layers and the substrates supporting them.

According to the present embodiment, the combinations of two compounds having different structures are desirably used as compounds having a function group capable of hydrogen bonding, so as to form complexes by hydrogen bonds and to exhibit promoting abilities described above. Preferred examples of the function group capable of hydrogen bonding include halogen atom, cyano, nitro, mercapto, hydroxy, amino, carboxamide, sulfonamide, acid amide, ureido, acyl group, carbamoyl, carboxyl, sulfo and N-containing heterocyclic group such as imidazolyl, benzimidazolyl, pyrazolyl, pyridyl, 1,3,5,-triazyl, pyrimidyl, pyridazil, quinolyl, benzimidazolyl, benzothiazolyl, succinimido, phthalimido, maleimide, uracil, thiouracil, barbituric acid, hydantoin, maleic acid hydrazide, isatine and uramil. More preferred examples of the function group capable of hydrogen bonding include amino, carboxamide, sulfonamide, acid amide, ureido, acyl, carbamoyl, carboxyl, sulfo, pyridyl, 1,3,5-triazyl, pyrimidyl, phthalimido, maleimide, uracil and barbituric acid.

In the present embodiment, the compounds having a function group capable of hydrogen bonding are desirably represented by Formulae (v) to (XXI).

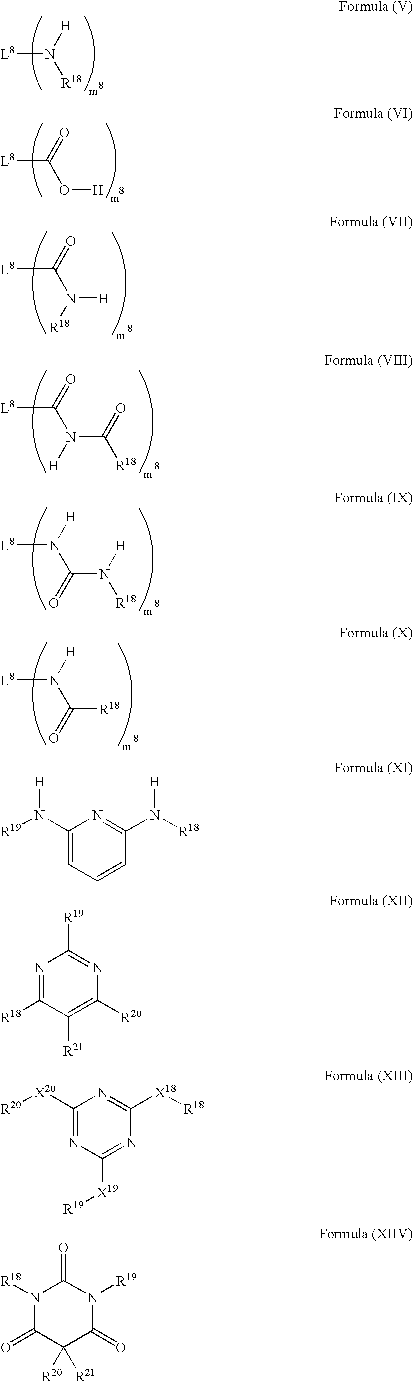

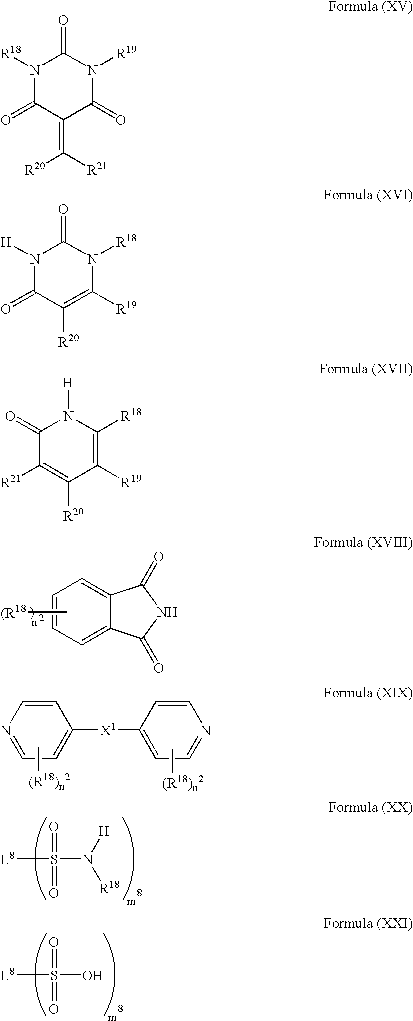

In the formulae, R¹⁸, R¹⁹, R²⁰ and R²¹ respectively denote a hydrogen atom or substituent group; L⁸ denotes a hydrogen atom or m⁸-valent group; X¹⁸, X¹⁹ and X²⁰ respectively denote a single bond or divalent linking group; m⁸ is an integer from 1 to 6 and n² is an integer from 0 to 6. When m⁸ and n² are respectively lower than 2, plural —NHR¹⁸, —CONHR¹⁸, —CONHCOR¹⁸, —NHCONHR¹⁸, —NHCOR¹⁸, R¹⁸ and R¹⁹ may be identical or different each other.

The substituents denoted by R¹⁸, R¹⁹, R²⁰ and R²¹ are identically defined with the substituents denoted by R¹², R¹³ and R¹⁴ in Formula (IV) above.

The substituent group denoted respectively by R¹⁸, R¹⁹, R²⁰ and R²¹ is desirably an alkyl group, aryl group, substituted or non-substituted amino group, alkoxy group, aryloxy group, acyl group, alkoxycarbonyl group, aryloxycarbonyl group, acyloxy group, acylamino group, sulfonyl amino group, sulfamoyl group, carbamoyl group, alkylthio group, arylthio group, sulfonyl, ureido, hydroxy, halogen atom, cyano, carboxyl or heterocyclic group; and preferably an alkyl group, aryl group, substituted or non-substituted amino, alkoxy group, acyl group, alkoxycarbonyl group, aryloxycarbonyl group, acyloxy group, acylamino group, sulfonylamino group, carbamoyl group, alkylthio group, ureido, hydroxy, halogen atom or cyano.

L⁸ denotes a hydrogen atom or an m⁸-valent group. The m⁸-valent group denoted by L⁸ is desirably an m⁸-valent alkyl group, alkenyl group, alkynyl, aryl group or heterocyclic group; preferably an m⁸-valent alkyl or aryl group. The number of carbon atoms included in the aryl group is desirably from 6 to 30, preferably from 6 to 20, and more preferably from 6 to 12. The number of carbon atoms included in the alkenyl or alkyl group is desirably from 1 to 40, preferably from 1 to 30, more preferably from 1 to 20, much more preferably from 1 to 15 and further much more preferably from 1 to 12. The number of carbon atoms included in the alkynyl group is desirably from 2 to 40, preferably form 2 to 30, more preferably form 2 to 20, much more preferably form 2 to 15 and further much more preferably form 2 to 12.

m⁸ is an integer from 1 to 6, desirably from 1 to 4, preferably 1 or 2 and more preferably 1.

Preferably X¹⁸, X¹⁹ and X²⁰ respectively denote a divalent linking group selected from the group consisting of an alkylene group, alkenylene group, arylene group, divalent heterocyclic group, —CO—, —NR^{a}— in which R^{a} is a C1-5 alkyl group or hydrogen atom, —O—, —S—, —SO—, —SO₂— and combinations thereof. More preferably X¹⁸, X¹⁹ and X²⁰ respectively denote a divalent group selected from the group consisting of alkylene group, alkenylene group, —CO—, —NR^{a}—, —O—, —S—, —SO₂— and combinations of two or more thereof. The number of carbon atoms included in the alkylene group is desirably from 1 to 12. The number of carbon atoms included in the alkenylene group is desirably from 2 to 12. The number of carbon atoms included in the arylene group is desirably from 6 to 10. The alkylene, alkenylene and arylene group may be substituted with one or more substituents exemplified above as substituents denoted by R¹², R¹³ and R¹⁴, such as an alkyl group, halogen atom, cyano, alkoxy group and acyloxy group.

Among the compounds denoted by the Formulae (V) to (XXI), the compounds denoted by the Formula (V), (VI), (IX), (XI), (XIII), (XIV), (XV), (XVIII), (XX) or (XXI) are preferred; and the compounds denoted by the Formula (VI), (XI), (XIII), (XIV), (XV), (XX) or (XXI) are more preferred.

The compounds denoted by Formula (XIIIa) or (XXII) are also preferred.

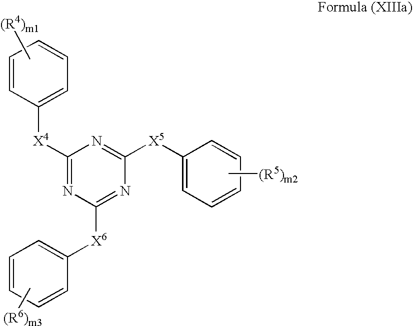

In the formula, R⁴, R⁵ and R⁶ respectively denote a hydrogen atom or substituent group; X⁴, X⁵ and X⁶ respectively denote a divalent linking group selected from the group consisting of —CO—, —NR^{a}— in which R^{a} is a C1-5 alkyl group or hydrogen atom, —O—, —S—, —SO—, —SO₂— and combinations thereof; m¹, m² and m³ respectively denote an integer from 1 to 5. When m¹, m² and m³ are respectively not smaller than 2, plural R⁴, R⁵, R⁶, X⁴, X⁵ and X⁶ may be respectively identical and different each other.
Ar³(-L⁷-Y²)ₘ₄ Formula (XXII)

In the formula, Ar³ is an aromatic carbocyclic group or aromatic heterocyclic group, Y² is sulfonyl or carboxyl, L⁷ is a single bond or divalent linking group, and m⁴ is an integer from 1 to 10.

At first, the compounds denoted by the Formula (XIIIa) will be described in detail.

In the formula, the substituents denoted by R⁴, R⁵ and R⁶ are identically defined with the substituents denoted by R¹⁸, R¹⁹, R²⁰ and R²¹ in the Formulae (V) to (XXI), and their preferred scopes are identical. Preferably R⁴, R⁵ and R⁶ respectively denote a hydrogen atom, alkyl group, aryl group, substituted or non-substituted amino group, alkoxy group, acyl group, alkoxycarbonyl group, aryloxycarbonyl group, acyloxy group, acylamino group, sulfonylamino group, carbamoyl group, alkylthio group, ureido, hydroxy, halogen atom or cyano; more preferably a hydrogen atom, alkyl group, alkoxy group, acyl group, aryloxycarbonyl group, acyloxy group or halogen atom.

In the formula, preferably X⁴, X⁵ and X⁶ respectively denote —NR^{a}—, —N(R^{a})CO—, —N(R^{a})SO₂—, —O— or —S—. R^{a} is desirably hydrogen.

Preferably m¹, m² and m³ respectively denote 1, 2 or 3.

Next, the compounds denoted by the Formula (XXII) will be described in detail.

In the Formula (XXII), the number of carbon atoms included in the aromatic carbocyclic group denoted by Ar³ is desirably from 6 to 30, preferably form 6 to 20, and more preferably from 6 to 12. The aromatic carbocyclic group is further more preferably a benzene or naphthalene ring. The number of carbon atoms included in the aromatic heterocyclic group denoted by Ar³ is desirably form 1 to 30, and preferably form 1 to 12. The aromatic heterocyclic group may include at least one hetero atom such as nitrogen, oxygen and sulphur. Examples of the aromatic heterocyclic group include pyridine, pyrimidine and 1,3,5-triazine. Ar³ is preferably an aromatic carbocyclic group.

The aromatic carbocyclic or heterocyclic groups denoted by Ar³ may be substituted with on or more substituents. The substituents for Ar³ are identically defined with substituents denoted by for R¹⁸, R¹⁹, R²⁰ and R²¹, and their preferred scopes are identical. The preferred examples of the substituents include an alkyl group, aryl group, alkoxy group, alkoxycarbonyl group, acyloxy group, acylamino group, sulfonylamino group and alkylthio group; and the more preferred examples include an alkyl group, alkoxy group, alkoxycarbonyl group and acyloxy group.

The divalent linking group denoted by L⁷ is identically defined with the divalent linking group denoted by X¹⁸, X¹⁹ and X²⁰ in the formulae (V) to (XXI), its preferred scope is identical. L⁷ is desirably a single bond or alkenylene group.

m⁴ is desirably 1.

Among the compounds denoted by the Formula (XXI), the compounds denoted by Formula (VIa) or (XXIa) are preferred.
(R¹¹¹—X¹¹¹)ₘ₁₁₁—(Ar¹¹¹)—COOH Formula (VIa)

In the formula, Ar¹¹¹ is a benzene or naphthalene ring; X¹¹¹ is —O—, —O(CH₂CH₂O)ₙ— in which n is an integer from 1 to 4, —OCO— or —COO—; R¹¹¹ is a substituted or non-substituted C8-20 alkyl group or C4-12 alkyl group which is terminated by —CHF₂ or —CF₃ and is substituted with fluorine atoms at not less than 60% of hydrogen positions; m¹¹¹ is an integer from 1 to 3.
(R²²²—X²²²)ₘ₂₂₂—(Ar²²²)—SO₃H Formula (XXIa)

In the formula, Ar²²², X²²², R²²² and m²²² are identically defined with each Ar¹¹¹, X¹¹¹, R¹¹¹ and m¹¹¹, in the Formula (VIa), and their preferred scopes are respectively identical.

The compounds having a function group capable of hydrogen bonding may have one or more polymerizable groups for fixing liquid crystal compounds in alignment state.

The specific examples of the compounds having a function group capable of hydrogen bonding are given below. However, compounds that can be employed in the present embodiment are not limited to these compounds. Among the specific examples, Compounds No. XIII-1 to 17 are the specific examples denoted by the Formula (XIII); Compounds No. VI-1 to 11 are the specific examples denoted by the Formula (VI); Compounds No. XI-1 to 3 are the specific examples denoted by the Formula (XI); Compounds No. XII-1 to 3 are the specific examples denoted by the Formula (XII); Compounds No. XIV-1 and 2 are the specific examples denoted by the Formula (XIV); Compounds No. XV-1 to 4 are the specific examples denoted by the Formula (XV); Compounds No. XVIII-1 and 2 are the specific examples denoted by the Formula (XVIII); Compounds No. XIX-1 and 2 are the specific examples denoted by the Formula (XIX); and Compounds No. XXI-1 to 23 are the specific examples denoted by the Formula (XXI).
XIII-1 is identical with IV-1 (See above).
XIII-2 is identical with IV-2 (See above).
XIII-3 is identical with IV-3 (See above).
XIII-4 is identical with IV-4 (See above).
XIII-5 is identical with IV-6 (See above).
XIII-6 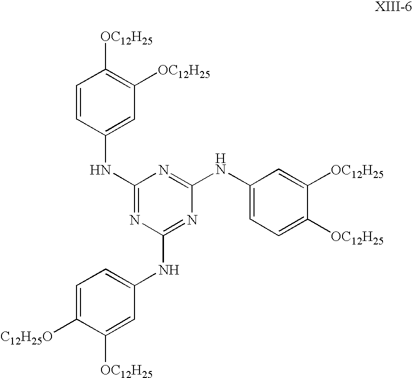
XIII-7 is identical with IV-20 (See above).
XIII-8 is identical with IV-21 (See above).
XIII-9 is identical with IV-23 (See above).
XIII-10 is identical with IV-24 (See above). 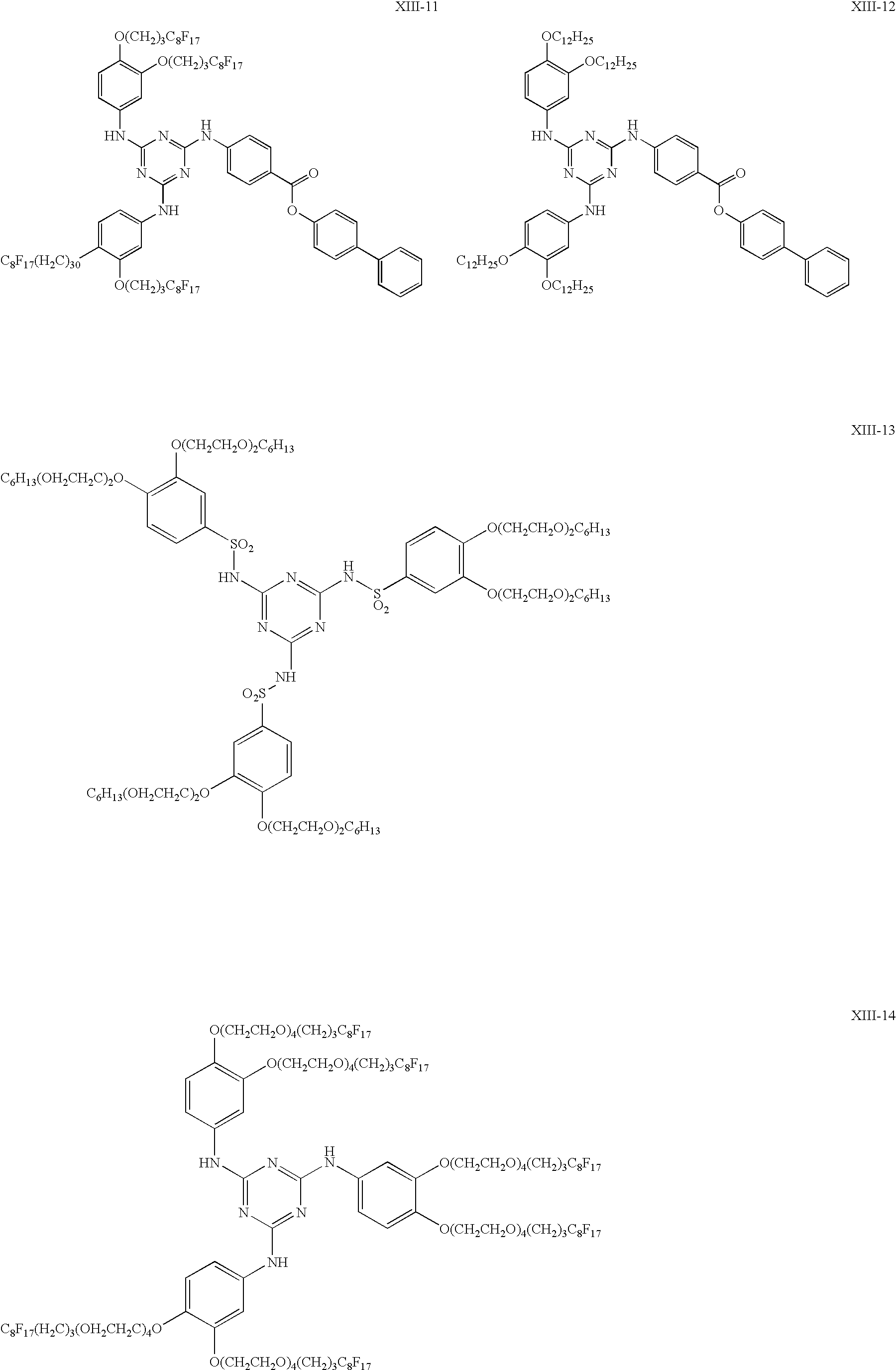 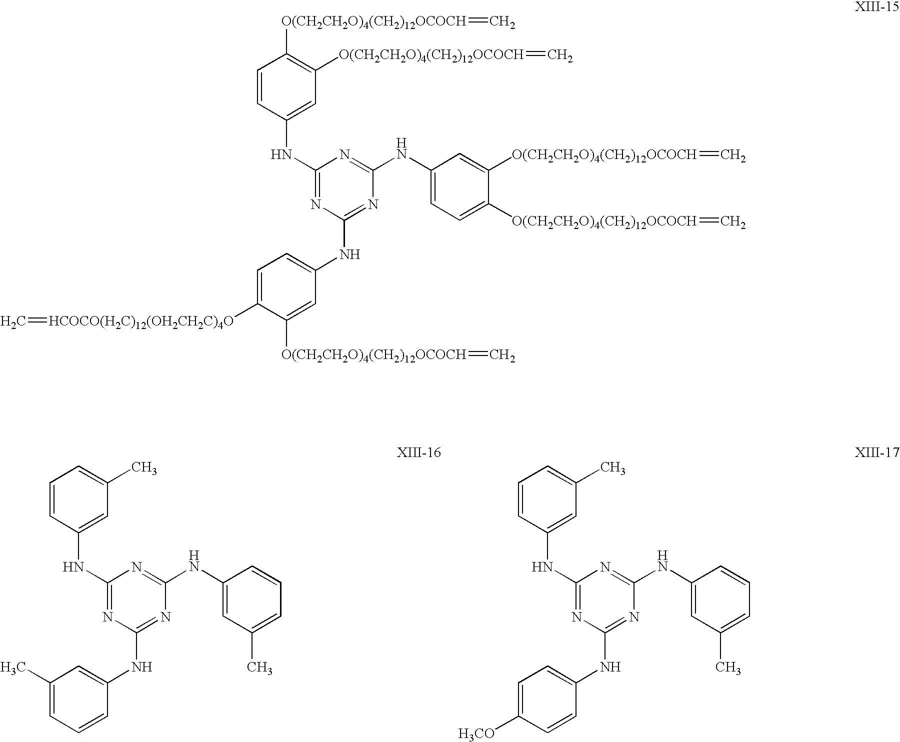
VI-1 is identical with III-15 (see above). 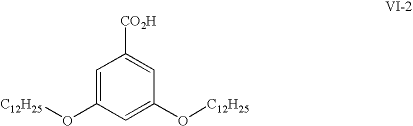
VI-3 is identical with III-18 (see above).
VI-4 is identical with III-13 (see above). 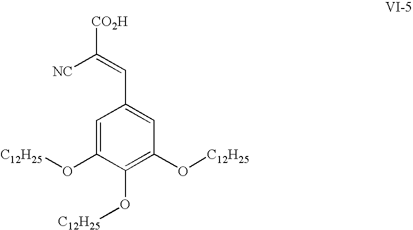
VI-6 is identical with I-1 (see above).
VI-7 is identical with I-2 (see above). 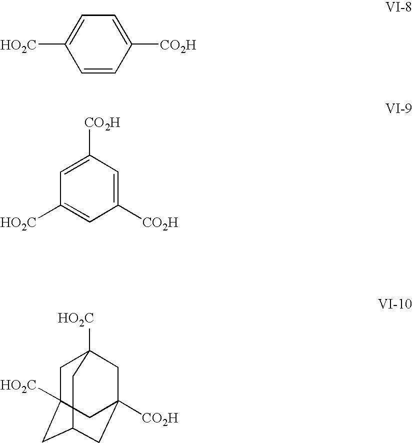
VI-11 is identical with III-7 (see above). 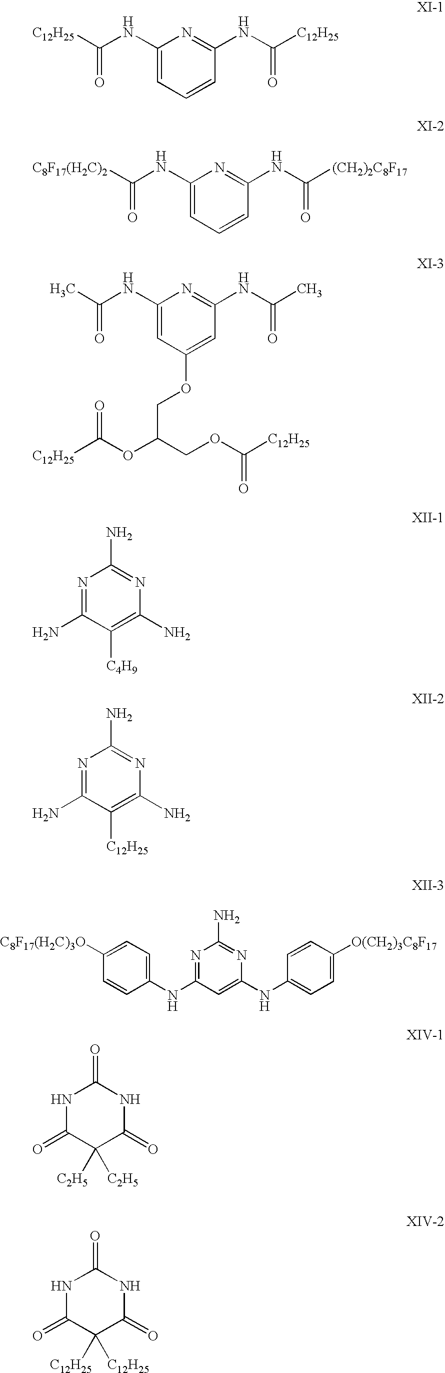 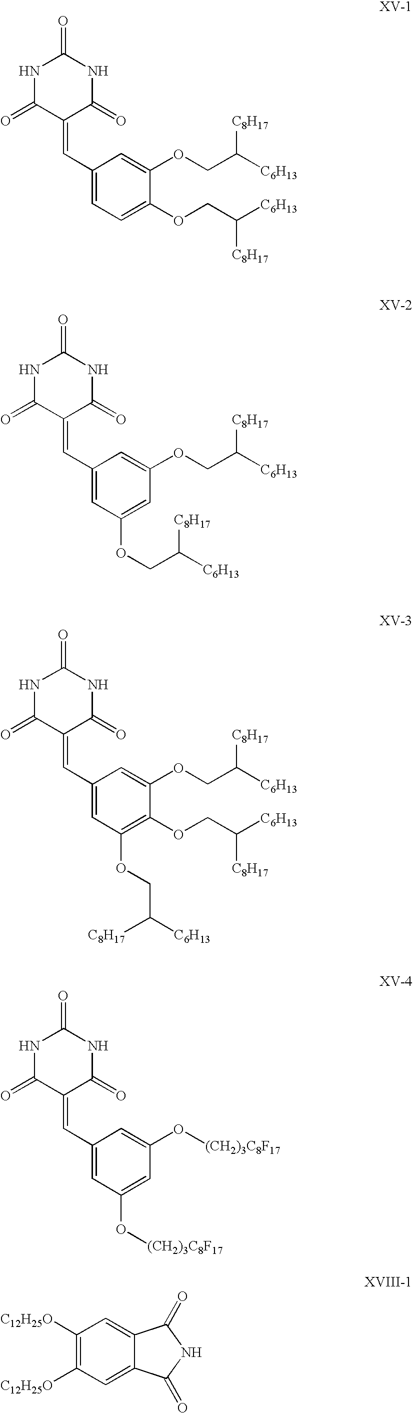 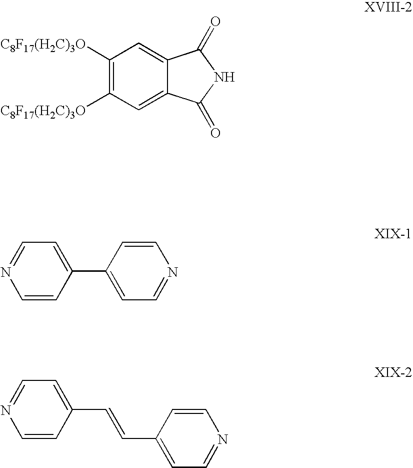
XXI-1 is identical with II-1 (see above).
XXI-2 is identical with II-2 (see above).
XXI-3 is identical with II-3 (see above).
XXI-4 is identical with II-4 (see above).
XXI-5 is identical with II-9 (see above).
XXI-6 is identical with II-27 (see above).
XXI-7 is identical with II-28 (see above).
XXI-8 is identical with II-29 (see above).
XXI-9 is identical with II-30 (see above).
XXI-10 is identical with II-31 (see above).
XXI-11 is identical with II-32 (see above).
XXI-12 is identical with II-33 (see above).
XXI-13 is identical with II-34 (see above).
XXI-14 is identical with II-35 (see above).
XXI-15 is identical with II-36 (see above).
XXI-16 is identical with II-37 (see above).
XXI-17 is identical with II-38 (see above).
XXI-18 is identical with II-39 (see above).
XXI-19 is identical with II-40 (see above).
XXI-20 is identical with II-41 (see above).
XXI-21 is identical with II-42 (see above).
XXI-22 is identical with II-43 (see above).
XXI-23 is identical with II-44 (see above).

As mentioned above, according to the present embodiment, combination of two kinds of the compounds having a function group capable of hydrogen bonding, which can form complexes by hydrogen bonding, are preferred. The preferred combinations are given bellow. However, combinations that can be employed in the present embodiment are not limited to these combinations.
Combination of the Formula (V) and the Formula (VI)
Combination of the Formula (VI) and the Formula (VI)
Combination of the Formula (VI) and the Formula (XI)
Combination of the Formula (VI) and the Formula (XIII)
Combination of the Formula (VI) and the Formula (XIX)
Combination of the Formula (IX) and the Formula (XIII)
Combination of the Formula (XI) and the Formula (XVI)
Combination of the Formula (XII) and the Formula (XIV)
Combination of the Formula (XIII) and the Formula (XIV)
Combination of the Formula (XIII) and the Formula (XV)
Combination of the Formula (XIII) and the Formula (XVIII)
Combination of the Formula (XIII) and the Formula (XX)
Combination of the Formula (XIII) and the Formula (XXI)
Combination of the Formula (XIV) and the Formula (XIV)
Combination of the Formula (XV) and the Formula (XV)

More preferred combinations are:

Among them, preferred are combinations of (VI) and (XIII), (XIII) and (XIV), (XIII) and (XV), (XIII) and (XX), and (XIII) and (XXI); more preferred are combinations of (VI) and (XIII), (XIII) and (XX), and (XIII) and (XXI); especially more preferred is a combination of (XIII) and (XXII); and most preferred are combinations of (XIIIa) and (VIa), and (XIIIa) and (XXIa).

According to the present embodiment, the amount of the each of the compounds having a function group capable of hydrogen bonding the compound invention is desirably form 0.01 to 20 wt % with respect to weight of liquid crystal compounds (desirably discotic liquid crystal compounds), preferably form 0.05 to 10 wt %, and more preferably from 0.1 to 5 wt %.

[Optically Anisotropic Layers]

Next, various materials employed in optically anisotropic layers of the present invention will be described.

(1) Liquid Crystal Compounds

In the present invention, examples of liquid crystal compounds employed in optically anisotropic layers include both of rod-like and discotic liquid crystal compounds and both of high and low molecular weight liquid crystal compounds. Additionally, the examples also include compounds no longer exhibiting liquid crystallinity after being cross-linked for formation of layers, in spite of originally exhibiting liquid crystallinity. Among them, discotic liquid crystal compounds are preferred.

Preferred examples of the rod-like liquid crystal compounds include azomethines, azoxys, cyanobiphenyls, cyanophenyl esters, benzoic acid esters, cyclohexanecarboxylic acid phenyl esters, cyanophenylcyclohexanes, cyano-substituted phenylpyrimidines, alkoxy-substituted phenylpyrimidines, phenyl dioxanes, tolans and alkenylcyclohexyl benzonitriles. Examples of the rod-like liquid crystal compounds include metal complexes of liquid crystal compounds. Liquid crystal polymers having one or more repeating units including a rod-like liquid crystal structure can also be used in the present invention. Namely, the rod-like crystal compounds bonded to a polymer may be use in the present invention. Rod-like liquid crystal compounds are described in fourth, seventh and eleventh chapters of “Published Quarterly Chemical Review vol. 22 Chemistry of Liquid Crystals (Ekisho no Kagaku)” published in 1994 and edited by Japan Chemical Society; and in third chapter of “Handbook of liquid Crystal Devices (Ekisyo Debaisu Handobukku)” edited by the 142 th committee of Japan Society for the Promotion of Science. The rod-like crystal compounds desirably have a birefringence index of 0.001 to 0.7. The rod-like crystal compounds desirably have one or more polymerizable groups for fixing themselves in alignment state. Examples of the rod-like crystal compounds are described from on line 7 of p. 50 to on last line of p. 57 in WO01/88574A1.

Examples of discotic liquid-crystal compounds include benzene derivatives described in “Mol. Cryst., vol. 71, page 111 (1981), C. Destrade et al.”; truxane derivatives described in “Mol. Cryst., vol. 122, page 141 (1985), C. Destrade et al.” and “Physics lett. A, vol. 78, page 82 (1990),”; cyclohexane derivatives described in “Angew. Chem., vol. 96, page 70 (1984), B. Kohne et al.”; and microcycls based aza-crowns or phenyl acetylenes described in “J. Chem. Commun., page 1794 (1985), M. Lehn et al.” and “J. Am. Chem. Soc., vol. 116, page 2, 655 (1994), J. Zhang et al.”. Examples of the discotic liquid crystal compounds also include compounds having a discotic core and substituents, such as alkyl or alkoxy straight chains or substituted benzoyloxy groups, radiating form the core. Such compounds exhibit liquid crystallinity. Preferred examples of the discotic liqud crystal compounds are described in JP-A No. hei 8-50206.

Triphenylene liquid crystals are desirably employed in the present invention. Examples of the triphenylene liquid crystals include triphenylene derivatives described in “Mol. Cryst., vol. 71, page 111 (1981), C. Destrade et al.” and “Mol. Cryst., vol. 84, page 193 (1982), B. Mourey et al.”. Especially preferred examples of the triphenylene liquid crystals include triphenylene derivatives denoted by the formulae (1) to (3) described in JP-A No. hei 7-306317; triphenylene derivatives denoted by the formula (I) described in JP-A No. hei 7-309813; and triphenylene derivatives denoted by the formula (I) described in JP-A No. 2001-100028.

The Liquid crystal compounds employed in preparing optically anisotropic layers are not required to maintain liquid crystallinity after contained in the optically anisotropic layers. For example, when a low-molecular-weight liquid crystal compound, having a reacting group initiated by light and/or heat, is employed in preparation of an optically anisotropic layer, polymerization or cross-linking reaction of the compound is initiated by light and/or heat, and carried out, to thereby form the layer. The polymerized or cross-linked compounds may no longer exhibit liquid crystallinity. The polymerization of discotic liquid-crystal compounds is described in JP-A No. hei 8-27284.

One example of the methods for fixing discotic liquid crystal compounds by polymerization is a method comprising carrying out polymerization of discotic liquid crystal compounds, having a discotic core and one or more polymerizable groups as substituents for the core, after aligning the liquid crystal compounds in hybrid alignment. It is necessary to bond a polymerizable group as a substituent to the disk-shaped core of a discotic liquid-crystal molecule to better fix the discotic liquid-crystal molecules by polymerization. However, when a polymerizable group is directly bonded to the disk-shaped core, it tends to be difficult to maintain alignment during the polymerization reaction. Accordingly, the discotic liquid-crystal compound desirably comprise a linking group between the disk-shaped core and the polymerizable group. That is, the discotic liquid-crystal compound is desirably denoted by Formula (XXIII) below.
D-(L-P)ₙ Formula (XXIII)

In the formula, D denotes the disk-shaped core, L denotes a divalent linking group, P denotes a polymerizable group, and n denotes an integer from 2 to 12. Examples of the discotic liquid crystal compounds are described from on line 6 of page 58 to on line 8 of page 65 in WO01/99574A1.

The most preferred examples of the liquid crystal compounds employed in the present invention are triphenylene derivatives comprising a triphenylene core, one or more polymerizable groups and linking groups between the core and the polymerizable groups, among triphenylene derivatives denoted by the formulae (1) to (3) described in JP-A No. hei 7-306317, denoted by the formula (I) described in JP-A No. hei 7-309813, or denoted by the formula (I) described in JP-A 2001-100028.

Two or more species of liquid-crystal compounds may be employed in combination. For example, the above-described polymerizable liquid-crystal compounds and non-polymerizable liquid-crystal compounds may be employed in combination. The non-polymerizable discotic liquid-crystal compound may be a compound in which polymerizable group (P) of the above-described polymerizable discotic liquid-crystal compound has been replaced with a hydrogen atom or alkyl group. That is, the nonpolymerizable discotic liquid-crystal compound is desirably a compound having formula (XXIV) below.
D-(L-R)ₙ Formula (XXIV)

In the formula, D denotes a disk-shaped core, L denotes a divalent linking group, R denotes a hydrogen atom or alkyl group, and n denotes an integer from 4 to 12.

(2) Additives for Optically Anisotropic Layers

In the present invention, the optically anisotropic layer may further comprise some additives with the liquid crystal compound and the compound denoted by the Formula (I), (II) or (III) above or a homogenous alignment promoter. Examples of the additives include additives for reducing repelled spots, additives for controlling pre-tilt angle (tilt angle of a liquid crystal compound at an interface between an optically anisotropic layer and an alignment layer), polymerization initiators, additives for lowering alignment temperature (plasticizers) and porlymerizable monomers.

(2)-1 Additive for Reducing Repelled Spots

Polymers are generally added to layers formed of discotic liquid crystal compounds in order to reduce repelled spots in the layers. The polymers that can be employed in the present invention are without limitation so far as they can be compatible with the discotic liquid crystal compounds without remarkably disturbing changes of tilt angles and alignments of liquid crystal compounds, however.

Examples of the polymers are described in JP-A No. hei 8-95030, among them, cellulose esters are preferred. Examples of the cellulose esters include cellulose acetate, cellulose acetate propionate, cellulose hydroxy propionate, and cellulose acetate butyrate. The amount of the polymer is desirably from 0.1 to 10 wt % with respect to weight of discotic liquid crystal compound, so as not to disturb alignment of the liquid crystal compound, preferably from 0.1 to 8 wt %, and more preferably from 0.1 to 5 wt %.

(2)-2 Additives for Controlling Pre-Tilt Angles of Alignment Layers

Compounds having both of a polar group and a non-polar group are added to layers in order to control pre-tilt angles of the layers.

Examples of the polar group include R—OH, R—COOH, R—O—R, R—NH₂, R—NH—R, R—SH, R—S—R, R—CO—R, R—COO—R, R—CONH—R, R—CONHCO—R, R—SO₃H, R—SO₃—R, R—SO₂NH—R, R—SO₂NHSO₂—R, R—C═N—R, HO—P(—R)₂, (HO—)₂P—R, P(—R)₃, HO—PO(—R)₂, (HO—)₂PO—R, PO(—R)₃, R—NO₂ and R—CN. Organic salts such as ammonium salts, pyridinium salts, carboxylate salts, sulfonate salts and phosphate salts may be also employed in the layers.

Preferred examples of the polar group are R—OH, R—COOH, R—O—R, R—NH₂, R—SO₃H, HO—PO(—R)₂, (HO—)₂PO—R, PO(—R)₃ and organic salts.

In the formulae, R is a non-polar group described bellow.

Examples of the non-polar group include a substituted or non-substituted alkyl group which may have a straight, branching or cyclic structure, and desirably has from 1 to 30 carbon atoms; a substituted or non-substituted alkenyl group which may have a straight, branching or cyclic structure, and desirably has from 2 to 30 carbon atoms; a substituted or non-substituted alkynyl group which may have a straight, branching or cyclic structure, and desirably has from 2 to 30 carbon atoms; a substituted or non-substituted aryl group desirably having from 6 to 30 carbon atoms; and a substituted or non-substituted silyl group desirably having form 3 to 30 carbon atoms.

The non-polar group may be substituted with one or more substituents such as a halogen atom, alkyl group including cycloalkyl group and bi-cycloalkyl group, alkenyl group including cycloalkenyl group and bi-cycloalkenyl group, alkynyl group, aryl group, heterocyclic group, cyano, hydroxy, nitro, carboxyl, alkoxy, aryloxy, silyloxy, heterocyclic oxy group, acyloxy group, carbamoyloxy group, alkoxycarbonyloxy group, aryloxycarbonyloxy group, amino group (including anilino group), acylamino group, aminocarbonylamino group, alkoxycarbonylamino group, aryloxycarbonylamino group, sulfamoylamino group, alkylsulfonylamino group, arylsulfonylamino group, mercapto group, alkylthio group, arylthio group, heterocyclic thio group, sulfamoyl group, sulfo, alkylsulfinyl group, arylsulfinyl group, alkylsulfonyl group, arylsulfonyl group, acyl group, aryloxycarbonyl group, alkoxycarbonyl group, carbamoyl group, arylazo group, heterocyclic azo group, imido, phosphino group, phosphinyl group, phosphinyloxy group, phosphinylamino group and silyl group.

Addition of such additives contributes to changes of pre-tilt angles of alignment layers. Rubbing densities of the alignment layers are also associated with the variations of the tilt angles. When two alignment layers contain a same amount of a same additive, the pre-tilt angle of the layer subjected to rubbing treatment with a lower density is easier to change than that of the other layer subjected to rubbing treatment with a higher density.

Accordingly, the preferred amount of the additive for controlling pre-tilt angles may vary according to rubbing density subjected to the layer and desired pre-tilt angle, however, in general, the amount is desirably from 0.001 to 20 wt %, preferably from 0.001 to 20 wt %, and more preferably from 0.005 to 10 wt %, with respect to weight of liquid crystal compound.

The specific examples of the additives for controlling pre-tilt angles are given bellow. However, the additives that can be employed in the present invention are not limited to these compounds.

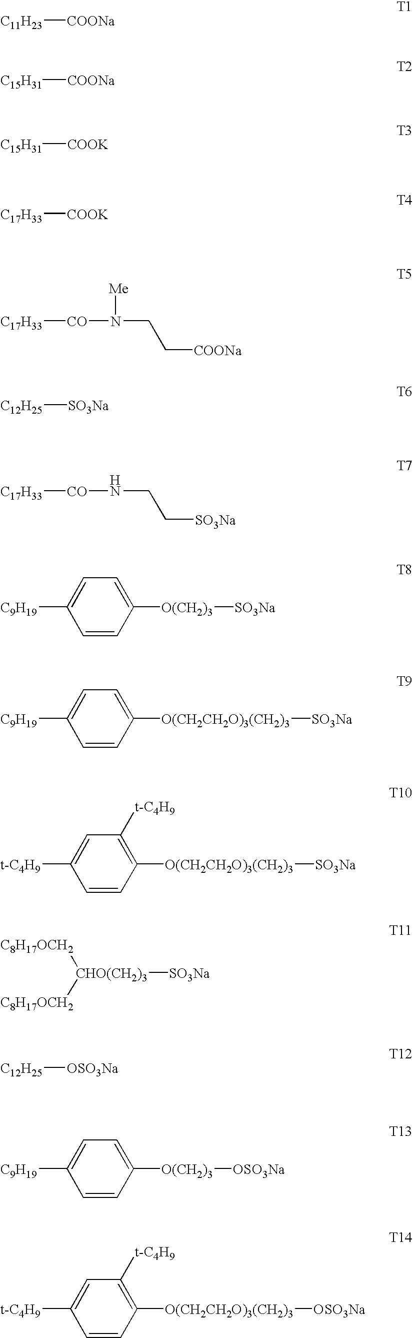

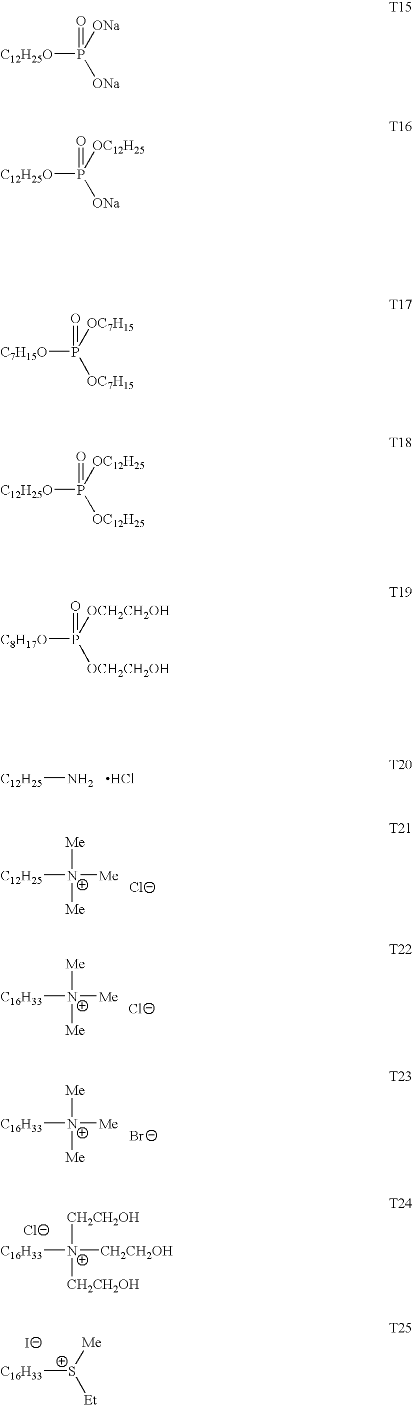

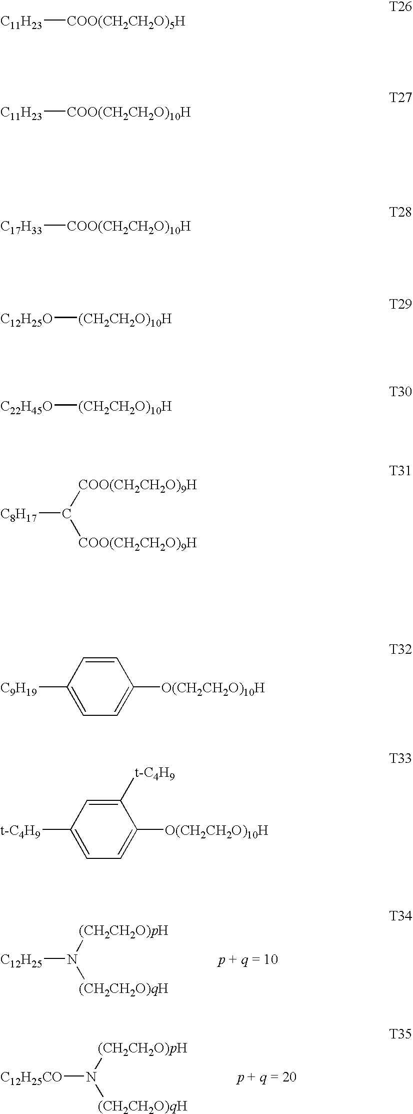

(2)-3 Polymerization Initiators

According to the present invention, liquid crystal compounds are desirably fixed in alignment state, and preferably fixed by polymerization reaction. Polymerization reactions include thermal polymerization reactions employing a thermal polymerization initiator and photo-polymerization reactions employing a photo-polymerization initiator. A photo-polymerization reaction is preferred since it is possible to prevent deformation and degeneration of a substrate supporting an optically anisotropic layer due to heat. Examples of photo-polymerization initiators are alpha-carbonyl compounds (described in U.S. Pat. Nos. 2,367,661 and 2,367,670), acyloin ethers (described in U.S. Pat. No. 2,448,828), alpha-hydrocarbon-substituted aromatic acyloin compounds (described in U.S. Pat. No. 2,722,512), polynuclearquinone compounds (described in U.S. Pat. Nos. 3,046,127 and 2,951,758), combinations of triarylimidazole diners and p-aminophenyl ketones (described in U.S. Pat. No. 3,549,367), acridine and phenazine compounds (described in JP-A No. sho 60-105667 and U.S. Pat. No. 4,239,850), and oxadiazole compounds (described in U.S. Pat. No. 4,212,970). The amount of photo-polymerization initiator employed is desirably from 0.01 to 20 wt %, preferably from 0.5 to 5 wt %, of the solid portion of the coating liquid. Irradiation for polymerization of discotic liquid-crystal molecules is desirably conducted with ultraviolet radiation. The irradiation energy is from 20 mJ/cm² to 50 J/cm² desirably, preferably from 100 to 800 mJ/cm². Irradiation may be conducted under heated conditions to promote the photo-polymerization reaction.

(2)-4 Polymerizable Monomers

Polymerizable monomers that can be used with liquid crystal compounds are without limitation so far as they can be compatible with the liquid crystal compounds without remarkably disturbing changes of the tilt angles and alignments of the liquid crystal compounds. Among them, the polymerizable monomers having one or more polymerizable functions including ethylene based non-saturated group such as vinyl group, vinyloxy group, acryloyl group and methacryloyl group are preferred. In general, the amount of the polymerizable monomer is desirably from 1 to 50 wt %, and preferably from 5 to 30 wt %, with respect to weight of liquid crystal compound. Use of the polymerizable monomers having two ore more polymerizable groups may improve in adhesiveness between an alignment layer and an optically anisotropic layer thereon, and is preferred.

(4) Solvents of Coating solutions for Optically Anisotropic Layers

Organic solvents are desirably used for preparing coating solutions for optically anisotropic layers. Examples of the organic solvents include amides such as N,N-dimethylformamide, sulfoxides such as dimethyl sulfoxide, heterocyclic compounds such as pyridine, hydrocarbons such as benzene and hexane, alkyl halides such as chloroform and dichloromethane, esters such as methyl acetate and butyl acetate, ketones such as acetone and methyl ethyl ketone and ethers such as tetrahydrofuran and 1,2-dimethoxyethane. Alkyl halides and ketones are preferred. One or more kinds of solvents may be used for preparing the coating solutions.

(5) Applying Processes

According to the present invention, an optically anisotropic layer may be prepared by applying a solution dissolved a liquid crystal compound in such solvent to a surface of an alignment layer and aligning the liquid crystal compound on the alignment layer. The coating solution can be applied by known techniques (e.g., wire bar coating, extrusion coating, direct gravure coating, reverse gravure coating and die coating). The coating solution desirably contains a liquid crystal compound of 10 to 50 wt %, and preferably of 20 to 40 wt %.

(6) Properties of Optically Anisotropic Layers

According to the present invention, the optically anisotropic layer desirably has a thickness of 01. to 20 micrometers, preferably of 0.5 to 15 micrometers, and more preferably of 1 to 10 micrometers.

Applying a coating solution containing a liquid crystal compound to an alignment layer, the liquid crystal compound on the side of the alignment layer interface may be aligned along with a pre-tilt angle of the alignment layer, on the other hand, the liquid crystal compound on the side of the air interface may be aligned along with a pre-tilt angle of the air interface. Accordingly, being uniformly aligned (mono domain aligned) the liquid crystal compound after applying, although it is not the actual condition, if it is expressed with an image, the hybrid alignment in which the tilt angle of the liquid crystal compound (for example the “tilt angle” of a discotic liquid crystal compound means the angle between a normal line of the disk surface of the discotic liquid crystal compound and a normal line of a plane of a substrate provided the alignment layer thereon) in the optically anisotropic layer varies continuously between the air interface and the alignment layer interface, namely in-depth direction, can be accomplished. Optical compensatory sheet of the present invention has an optically anisotropic layer formed of a hybrid aligned liquid crystal compound, and can be contribute to broadening viewing angle, reducing decreases of contrast according to changing angle, preventing gradation and black-white inversions, change of hue and so on.

In order to exhibit preferred properties, the optical compensatory sheet of the present invention includes a proper hybrid alignment structure. For building up the proper hybrid alignment, the pre-tilt angle of the air interface is desirably not smaller than 50°, and the pre-tilt angle of the alignment layer is desirably from 3 to 30°. When the optical compensatory sheet of the present invention may be mounted in a LCD, the hybrid alignment structure included in the sheet is required to adjust to the display mode of the LCD. The pre-tilt angles of alignment layers can be controlled by the above mentioned factors such as rubbing densities and additives for controlling pre-tilt angles of alignment layers, and the tilt angles of liquid crystal compounds near the surfaces (namely air interfaces) of the optically anisotropic layers can be generally controlled by selections of the liquid crystal compounds and/or other materials (the compounds represented by the Formula (I), (II) or (III), or homogenous alignment promoters describes above) employed with them. Thus, the hybrid alignment structure adjusting to the display modes can be build up.

(7) Pre-tilt Angles

The term of “pre-tilt angle” means an angle between a long axis of a liquid crystal compound and a normal line of an interface (an air interface or an alignment layer interface). The pre-tilt angle of the alignment layer interface is desirably from 3 to 30°, and the pre-tilt angle of the air interface is desirable from 40 to 80°.

When the pre-tilt angles are too small, it takes long time to align the liquid crystal compound in mono-domain alignment. Thus, the lager pre-tilt angles are preferred. However, when the pre-tilt angles are too large, it is difficult to obtain excellent properties as an optical compensatory sheet. From the viewpoint of compatibility between shortening of the period for the mono-domain alignment and excellent optical properties, the pre-tilt angle of the alignment layer interface is desirably from 5 to 30°, preferably from 7 to 20°, and much more preferably from 9 to 20°; and the pre-tilt angle of the air interface is desirably from 40 to 80°, preferably from 50 to 80°, and much more preferably from 50 to 70°

The pre-tilt angles are controllable in a range from several degrees to several dozens degrees by addition of the above-mentioned additives or controlling rubbing densities according to the method described bellow.

[Alignment Layers]

The alignment layer that can be employed in the present invention may be provided by rubbing a layer formed of an organic compound (preferably a polymer), oblique vapor deposition, the formation of a layer with microgrooves, or the deposition of organic compounds (for example, omega-tricosanoic acid, dioctadecylmethylammonium chloride, and methyl stearate) by the Langmuir-Blodgett (LB) film method. Further, alignment layers imparted with orientation functions by exposure to an electric or magnetic field or irradiation with light are also known. From the view point of controlling pre-tilt angles, alignment layers formed by rubbing polymer layers are particularly desirable. In the rubbing treatment, the surface of a polymer layer is rubbed several times in a constant direction with paper or cloth. The rubbing treatment is desirably carried out according to the method described in “Handbook of Liquid Crystals (Ekisho Binran)” published by Maruzen co., Ltd.

The thickness of the alignment layer is desirably from 0.01 to 5 micrometers, preferably from 0.05 to 1 micrometer.

The examples of polymers employed in the alignment layers are described in various literatures and can be available as marketed products. The preferred examples of polymers employed in the alignment layers are polyvinyl alcohols or derivatives thereof, the especially preferred examples are denatured polyvinyl alcohols bonded to hydrophobic groups. It is possible to refer to descriptions from line 24 on page 43 to line 8 on page 49 in WO001/88574A1 for the alignment layers.

[Rubbing Densities of Alignment Layers]

In order to vary rubbing densities of alignment layers, it is possible to adopt methods described in “Handbook of Liquid Crystals (Ekisho Binran)” published by Maruzen co., Ltd. A rubbing density (L) can be defined by Formula (A) bellow.
L=N·l·(1+2πr·n/60v) Formula (A)

N is a number of rubbing, l is a contact length of a rubbing roller, r is a radius of the roller, n is a rotation speed (rpm) of the roller, and v is a moving velocity of a stage (per a sec).

When increasing rubbing density, rubbing treatment may be carried out with a higher N, longer l, longer r or lower n; on the other hand, when decreasing rubbing density, rubbing treatment may be carried out in opposite ways.

There is a relationship between a rubbing density and a pre-tilt angle of an alignment layer that the higher rubbing density the alignment layer is treated with the lower pre-tilt angle of the alignment layer is; and the smaller rubbing density the alignment layer is treated with, the larger pre-tilt angle of the alignment layer is.

[Transparent Supports]

The transparent support employed in the present invention is desirably an optically isotropic polymer film. Stating that the support is “transparent” means that light transmittance is greater than or equal to 80 percent.

Examples of materials for the transparent support, however not limited to them, include cellulose esters such as cellulose diacetate and cellulose triacetate, norbornene polymers, poly(meth)acrylates and norbornene resin. Various marketed products of the polymers can be used. From the viewpoint of optical properties, cellulose esters are desirably and cellulose esters of lower fatty acids are preferably. “Lower fatty acid” means fatty acid having not greater than 6 of carbon atoms. The number of carbon atoms included in the fatty acid is desirably 2 (cellulose acetate), 3 (cellulose propionate) or 4 (cellulose butyrate). Cellulose triacetate is preferably. Films formed of cellulose esters of mixed fatty acids such as cellulose acetate propionate and cellulose acetate butyrate may be employed in the present invention as a transparent support. The films of the known polycarbonates and polysulfones, which are easy to generate birefringence, and the films of the modified polymers described in WO00/26705, which are not easy to generate birefringence by the modification, may be employed in the present invention.

Polymer films of cellulose acetates having an acetylation rate from 55.0 to 63.5%, preferably from 57.0 to 62.0%, are desirably employed in the present invention as a transparent support. An acetylation rate means an amount of acetic acid bonding to cellulose per unit weight of cellulose. The acetylation rate can be measured according to the measurement and calculation of acetylation degree of ASTM:D-817-91 (tests of cellulose acetates and the like). The Viscosity-average degree of polymerization (DP) of the cellulose acetate is desirably not lower than 250, and preferably not lower than 290. The Mw/Mn value (Mw is a weight-average molecular weight, and Mn is a number-average molecular weight) of the cellulose ester obtained by gel permeation chromatography desirably have a narrow distribution. In particular, the Mn/Mw is desirably from 1.0 to 1.7, preferably from 1.3 to 1.65 and more preferably from 1.4 to 1.6.

Generally, hydroxys of 2-, 3- and 6-positions in cellulose are not equally substituted in one third of the substituted degree in whole, and the substituted degree of hydroxy of 6-position tends to be lower than others. According to the present invention, the 6-position hydroxy is desirably higher than 2- and 3-positions. The 6-position is desirably substituted with an acyl group at from 30 to 40%, preferably not lower than 31%, more preferably not lower than 32%, of the substituted degree in whole. The substituted degree of the 6-position is desirably not lower than 0.88. The hydroxy of the 6-position may be substituted with an acyl group, other than acetyl, having not less than 3 carbon atoms such as propionyl, butyryl, valeryl, benzoyl and acryloyl. The substituted degree of each position can be obtained by NMR measurement. The cellulose esters having a high substituted degree can be prepared according to the methods described as “Preparation Example 1” in columns 0043 to 0044, as “Preparation Example 2” in columns 0048 to 0049, and “Preparation Example 3” in columns 0051 to 0052 of JP-A No. hei 11-5851.

Retardation in-depth (Rth) of a film is defined as a product of the birefringence rate and the thickness of the film. In particular, Rth of a film can be estimated by extrapolation of the retardation in-plane, which is measured on the basis of a slow axis with incident light of the vertical direction to the film surface, and the values which are measured with incident lights of various directions inclined to the vertical direction. The measurement can be carried out by using an ellipsometer such as “M-15” provided by JASCO International co., ltd. In-plane retardation (Re) and in-depth retardation (Rth) of the transparent support are defined by the following equations:
Re=(nx−ny)×d
Rth={(nx+ny)/2−nz}×d

In the equations, nx and ny denote the in-plane refractive indexes of the transparent support, nz denotes the refractive index of the transparent support in the direction of thickness, and d denotes the thickness of the transparent support.

According to the present invention, the in-plane retardation (Re) of the transparent support is desirably from 20 to 70 nm, and the in-depth retardation (Rth) is desirably from 70 to 400 nm. When two optical compensatory sheets of the present invention are incorporated in a liquid crystal display, the Rth's of the transparent supports are desirably from 70 to 250 nm. On the other hand, when an optical compensatory sheet of the present invention is incorporated in a liquid crystal display, the Rth of the transparent support is desirably from 150 to 400 nm.

The in-plane birefringence rate (nx−ny) of the transparent support is desirably from 0.00028 to 0.020, and the in-depth birefringence rate ((nx+ny)/2−nz) is desirably from 0.001 to 0.04.

Aromatic compounds having two ore more aromatic rings may be used to control retardations of the polymer films, especially cellulose acetate films. The amount of the aromatic compound is preferably 0.01 to 20 wt %, more preferably 0.05 to 15 wt %, and much more preferably 0.1 to 10 wt %, with respect to weight of cellulose acetate. One or more kinds of the aromatic compounds may be used.

The term of “aromatic ring” is used as a meaning including not only aromatic hydrocarbon rings but also aromatic hetero rings.

The aromatic hydrocarbon ring is desirably 6-membered, namely benzene.

In general, aromatic hetero rings are belonging to unsaturated hetero rings. The aromatic hetero ring is desirably 5-, 6- or 7-membered, and preferably 5- or 6-membered. In general, aromatic hetero rings have the maximum number of double bonds. Hetero atoms included in the aromatic hetero rings are preferably nitrogen, oxygen and sulfur, and more preferably nitrogen. Examples of the aromatic hetero rings include furan, thiophene, pyrrole, oxazole, isoxazole, thiazole, isothiazole, imidazole, pyrazole, furazan, triazole, pyrane, pyridine, pyridazine, pyrimidine, pyrazine and 1,3,5-triazine.

The aromatic ring is desirably benzene, furan, thiophene, pyrrole, oxazole, thiazole, imidazole, triazole, pyridine, pyrimidine, pyrazine or 1,3,5-triazine, and preferably benzene or 1,3,5-triazine. The aromatic ring having at least one 1,3,5-triazine ring is preferred.

The number of aromatic rings included in the aromatic compound is desirably from 2 to 20, preferably from 2 to 12, more preferably from 2 to 8, and much more preferably from 2 to 6.

Bonding manners between two aromatic rings may be classified into three groups, (a) condensed each other, (b) bonded each other with a single bond and (c) bonded each other with a linking group. The aromatic compounds including two aromatic rings bonded by (a), (b) or (c) manners can be employed. The aromatic compounds contributing to increase of retardation are disclosed in WO01/88574A1, WO00/2619A1, JP-A No. 2000-111914, JP-A No. 2000-275434 and JP-A No. 2002-363343.

The cellulose acetate film that can be employed in the present invention as a transparent support are desirably prepared according to solvent casting method with a prepared solution (dope) of cellulose acetate. The aromatic compound is desirably added to the dope.

According to the solvent casting method, the dope is cast on a drum or band and dried on it to form a film. The solid content of the dope before casting is desirably from 18 to 35%. The surface of the band and drum are desirably applied mirror finish treatment. Casting processes and drying processes are described in U.S. Pat. No. 2,336,310, No. 2,367,603, No. 2,492,078, No. 2,492,977, No. 2,492,978, No. 2,607,704, No. 2,739,069 and No. 2,739,070; G.B. patents No. 640731 and 736892; JP-B No. sho 45-4554 (the term “JP-B” as used herein means an “examined published Japanese patent application”) and No. sho 49-5614; and JP-A No. sho 60-176834, No. sho 60-203430 and No. sho 62-115035.

The dope is desirably cast on the drum or band whose surface temperature is not higher than 10 degrees Celsius. After casting, the dope may be winded for not shorter than 2 seconds and dried. The solvent remained in the dope may be evaporated subsequently with hot-air whose temperature is changed stepwise from 100 to 160 degrees Celsius, after peeling the polymer film from the band or drum. The method is described in JP-B No. hei 5-17844. According to the method, it is possible to shorten the time from a casting step to a peeling step. In order to carry out the method, the dope is required to set to gel at the surface temperature on the drum or band for casting.

The film may be prepared by casting a prepared cellulose acetate solution (dope) to form two or more layers. The dope is cast on a drum or band and dried on it to form a film. The solid content of the dope before casting is desirably from 10 to 40%. The surface of the band and drum are desirably applied mirror finish treatment.

Two or more dopes may be respectively cast on a drum or band from each of two or more casting outlets which are placed at some spaces each other along the moving direction of the drum or band. The two ore more layers of the dopes may be stacked to form a film. The methods described in JP-A No. sho 61-158414, JP-A No. hei 1-122419, JP-A No. hei 11-198285 and the like may be used. The dope may be cast on a band or drum from two casting outlets to form a film. The methods described in JP-B No. sho 60-27562, JP-A NO. sho 61-94724, No. sho 61-947245, No. sho 61-104813, No. sho 61-158413, No. hei 6-134933 and the like may be used. The casting method described in JP-A No. sho 56-162617 may be used. According to the method, both of a high viscosity dope and a low viscosity dope are cast at once, so as that the flow of the high viscosity dope wrapped with the low viscosity dope, may be used.

Stretching treatment of the cellulose acetate film may be carried out in order to control its retardations. The stretch ratio is desirably from 3 to 100%. The cellulose acetate film is desirably stretched by tenders. For controlling the slow axis of the film to high accuracy, the deference in velocities, departure times and the like of the left and right tenter clips are desirably as small as possible.

Plasticizes may be added to the cellulose acetate films in order to improve the mechanical properties of the films and the drying speed. Examples of the plasticizers include phosphate esters and carboxylic acid esters. Examples of the phosphate esters include triphenylphosphate (TPP) and tricresylphosphate (TCP). Typical carboxylic acid esters are phthalates and citrates. Examples of phthalates include dimethyl phthalate (DMP), diethyl phthalate (DEP), dibutyl phthalate (DBP), dioctyl phthalate (DOP), diphenyl phthalate (DPP) and dietylhexyl phthalate (DEHP). Examples of citrates include o-acetyl citrate triethyl (OACTE) and o-acetyl citrate tributyl (OACTB). Examples of other carboxylic acid esters include butyl oleate, methyl acetyl ricinate, dibutyl sebacate and various trimellitic acid esters. A phthalate based plasticizer such as DMP, DEP, DBP, DOP, DPP or DEHP is desirably employed in the film, and DEP or DPP is preferably employed. The amount of the plasticizer is desirably from 0.1 to 25 wt %, preferably from 1 to 20, and more preferably from 3 to 15, with respect to weight of cellulose acetate.

Anti-degradation agents such as antioxidants, decomposers of peroxides, inhibitors of radicals, in-activators of metals, trapping agents of acids or amines, and UV ray protective agents, may be added to the cellulose acetate film. The antioxidants are described in JP-A No. hei 3-199201, No. hei 5-1907073, No. hei 5-194789, No. hei 5-271471, No. hei 6-107854 and the like. The amount of the anti-degradation agents in the dope is desirably from 0.01 to 1 wt %, and preferably from 0.01 to 0.2 wt %. When the amount is smaller than 0.01 wt %, the effect of the agent can hardly be recognized. On the other hand, when the amount is larger than 1 wt %, the agent sometimes bleeds out from the film surface. The preferred example of the anti-degradation agent is butylated hydroxy toluene. UV ray protective agents are described in JP-A No. hei 7-11056.

The polymer film is preferably subjected to surface treatment. Examples of surface treatments include corona discharge treatment, glow discharge treatment, flame treatment, acid treatment, alkali treatment and UV irradiation treatment. The polymer film may have an under coating layer as disclosed in JP-A hei 7-333,433.

From the viewpoint of planarity of the film, the surface treatment is desirably carried out at a temperature not greater than Tg (glass transition temperature) of the polymer, and practically not greater than 170 degrees Celsius.

From the view point of adhesiveness, the film is desirably subjected to acid treatment or alkali treatment, so as that the cellulose acetate of the film is saponified. The surface energy of the polymer film is preferably 55 mN/m or more, and more preferably 60 to 75 mN/m.

Next, alkali saponification of the film will be described specifically. The alkali solution that can be employed in the saponification may be a potassium hydrate or sodium hydrate solution. The concentration of the alkali solution is desirably from 0.1 to 3.0 N, and preferably from 0.5 to 2.0 N. the temperature of the alkali solution is desirably from room temperature to 90 degrees Celsius, and preferably from 40 to 70 degrees Celsius.

A surface energy of a solid may be calculated by a contact angle method, a heat of wetting method or an adsorption method, as described in “Bases and Applications of Wettability (Nure No Kiso to ouyou)” published at Dec. 10, 1989 by SIPEC Corporation (former Realize Corporation). A contact angle method is proper for the polymer film of the present invention. Specifically, a surface energy of the polymer film according to the present invention can be calculated by a contact angle method with two contact angles of droplets of which surface energies are respectively known. A contact angle of a droplet on the polymer film is defined as an angle between the polymer film surface and a tangent line to the surface curve of the droplet, which is drawn at an intersection point of the droplet surface and the polymer film surface. There are two angles between the polymer film surface and such tangent line, however, a contact angle is an angle at the side containing the droplet.

The cellulose acetate film has, in general, a thickness from 5 to 500 micrometers, desirably from 20 to 250 micrometers, preferably from 30 to 180 micrometers, and more preferably from 30 to 110 micrometers.

[Optical Compensatory Sheets]

One preferred embodiment of the present invention is an optical compensatory sheet comprising a transparent support and thereon, an alignment layer and an optically anisotropic layer.

The optical compensatory sheet of the present invention may be combined with a polarizing film and employed as an elliptical polarizing plate. It may also be combined with a polarizing film and used to broaden the viewing angle in a transmitting liquid-crystal display.

Elliptical polarizing plates and liquid-crystal devices employing the optical compensatory sheet of the present invention are described below.

[Elliptical Polarizing Plates]

The optical compensatory sheet of the present invention may be laminated with a polarizing film to produce an elliptical polarizing plate. The use of the optical compensatory sheet of the present invention provides an elliptical polarizing plate capable of broadening the viewing angle of a liquid-crystal display.

The polarizing film may be an iodine-based polarizing film, dye-based polarizing film employing a dichroic dye, or a polyene-based polarizing film. Iodine-based polarizing films and dye-based polarizing films can generally be formed of polyvinyl alcohol-based films. The polarizing axis of the polarizing film corresponds to a direction normal to the direction of orientation of the film.

The polarizing film is deposited on the optically anisotropic layer side of the above-described optical compensatory sheet. A transparent protective film is desirably formed on the side opposite the side of the optical compensatory sheet on which the polarizing film has been deposited. The transparent protective film desirably has optical transmittance of greater than or equal to 80 percent. Generally, a cellulose ester film, preferably a triacetyl cellulose film, is employed as the transparent protective film. The cellulose ester film is desirably formed by the solvent casting method. The transparent protective film is desirably 20 to 500 micrometers, preferably 50 to 200 micrometers, in thickness.

[The liquid-Crystal Display]

The use of an optical compensatory sheet in the present invention makes it possible to provide a liquid-crystal display with a broadened viewing field. The optical compensatory sheets of the present invention that can be employed in a TN-mode LCD are described in JP-A No. hei 6-214116, U.S. Pat. Nos. 5,583,679 and No. 5,646,703, and German Patent No. 3911620A1. The optical compensatory sheets of the present invention that can be employed in IPS and FLC-mode LCDs are described in JP-A No. 10-54982. The optical compensatory sheets of the present invention that can be employed in OCB- and HAN-mode LCDs are described in U.S. Pat. No. 5,805,253 and WO96/37804. The optical compensatory sheets of the present invention that can be employed in a STN-mode LCD are described in JP-A No. hei 9-26572. The optical compensatory sheets of the present invention that can be employed in a VA-mode LCD are described in JP Patent No. 2866372.

The optical compensatory sheets for LCDs of various modes may be prepared based on descriptions above. The optical compensatory sheets of the present invention may be combined with liquid-crystal cells driven by various modes such as TN (Twisted Nematic), IPS (In-Plane Switching), FLC (Ferroelectric Liquid Crystal), OCB (Optically Compensatory Bend), STN (Supper Twisted Nematic), VA (Vertically Aligned), and HAN (Hybrid Aligned Nematic) modes; and employed in various liquid-crystal displays. The optical compensatory sheet of the present invention is particularly effective in TN or OCB mode liquid-crystal displays.

### EXAMPLES

The present invention will further be detailed referring to specific Examples. It is to be noted that any materials, reagents, ratios of use thereof and operations shown in the Examples below can properly be modified without departing from the spirit of the present invention. Thus the present invention is by no means limited to the Examples described below.

At first, examples related to improvement of tilt angles will be described.

### Example 1

(Preparation of an Optical Compensatory Sheet)

A triacetyl cellulose film having a thickness of 100 micrometers and a size of 270 mm×100 mm, “FUJI TAC” manufactured by FUJI FILM, was used as a transparent support. A solution of alkyl-modified polyvinylalcohol, “MP-203” manufactured by KURARAY CO., LTD, was applied to the film in 0.5 micrometers, dried and its surface was subjected to rubbing treatment, to form an alignment layer. The coating liquid containing following components was applied to the alignment layer by a bar-coater. A Coating Solution for an optically anisotropic layer

| | |
|---|---|
| Compound No. I-1, denoted by the Formula (I) | 0.6 weight parts |
| Triphenylene liquid crystal (I) disclosed in | |
| JP-A No. hei 7-306317 as Compound No. TP-53: | 100 weight parts |
| 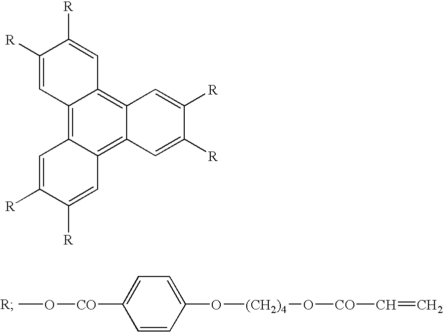 | |
| Ethylene oxide-modified trimethylolpropane | 9.9 weight parts |
| triacrylate (V#360 made by Osaka | |
| Organic Chemicals (Ltd.)) | |
| Polymerization initiator (IRGACURE 907 made | 3.3 weight parts |
| by Ciba-Geigy) | |
| Sensitizer (KAYACURE DETX made by | 1.1 weight parts |
| NIPPON KAYAKU CO., LTD.) | |
| Methylethyl ketone | 220 weight parts |

The coated layer was heated for 150 seconds at 125 degrees Celsius of a surface temperature, so as that the alignment of the liquid crystal was maturated, and after that, the temperature was decreased by 80 degrees Celsius for about 20 seconds. Subsequently, the layer was irradiated at the same temperature with UV light of 0.4 J to fix the alignment. The obtained layer had a thickness of 1.8 micrometers. Thus the optically anisotropic layer was prepared and the optical compensatory sheet was obtained.

(Evaluation of Optical Compensatory Sheet)

The tilt angles near the alignment layer and the air interface are estimated based on the retardations, which were measured for various detection angles by an ellipsometer (APE-100 made by SHIMADZU CORPORATION), with using a virtual refractive index ellipsoid model, according to the method described in “Designing Concepts of the Discotic Negative Birefringence Compensation Films SID98 DIGEST”. The wave length for the measurement is 632.8 nm.

The results are shown in Table 1.

### Examples 2 to 12 and Comparative Examples 1 and 2

Optical compensatory sheets were prepared in the same manner as Example 1, except that compounds shown in Table 1 were respectively-used in the place of the Compound (I-1), and their tilt angles were estimated in the same manner as Example 1.

TABLE 1

| | Specifc compound | | | |
|---|---|---|---|---|
| | denoted by the | | | |
| | Formula (I), (II) or (III) | | | |
| | | Amount | Tilt angle | |
| Compensatory | | (weight | Alignment | Air interface |
| sheet | No. | parts) | layer side | side |
| Example 1 | No. I-1 | 0.6 | 12° | 70° |
| Example 2 | No. I-2 | 0.6 | 12° | 70° |
| Example 3 | No. I-3 | 0.8 | 12° | 70° |
| Example 4 | No. I-4 | 0.8 | 13° | 71° |
| Example 5 | No. II-1 | 0.4 | 14° | 73° |
| Example 6 | No. II-3 | 0.1 | 14° | 83° |
| Example 7 | No. II-4 | 0.1 | 14° | 83° |
| Example 8 | No. II-28 | 0.1 | 12° | 72° |
| Example 9 | No. II-34 | 0.3 | 12° | 70° |
| Example 10 | No. III-7 | 1.0 | 14° | 73° |
| Example 11 | No. III-13 | 0.06 | 16° | 77° |
| Example 12 | No. III-15 | 1.0 | 11° | 66° |
| Comparative | — | — | 7° | 55° |
| Example 1 | | | | |
| Comparative | Comparative | 0.1 | 7° | 55° |
| Example 2 | Compound A | | | |

Comparative Compound A described in JP-A No. 2001-330725 as Compound FS-73:

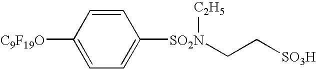

As indicated the results presented in Table 1 above, it can be understood that the optically anisotropic layers containing the compound denoted by the Formula (I), (II) or (III) allow the hybrid alignments in which triphenylene liquid crystals were aligned with high tilt angles, especially high tilt angles of the air interfaces.

Next, examples related to a method for rapid building up hybrid alignment will be described. At first, examples of the method wherein the first step for homogenous alignment is carried out at a higher temperature than that for hybrid alignment in the second step, will be described bellow.

### Example 13

An optical compensatory sheet was prepared in the same manner as Example 1, except that 4.5 weight parts of 1,3,5-triazin compound shown in Table 2 was used in the place of the 0.6 weight parts of Compound (I-1) and an alignment process as follows was carried out in the place of the alignment process above. The tilt angles shown in Table 2, were estimated in the same manner as Example 1.

(Alignment Process)

The coated layer was heated up to 120 degrees Celsius for about 20 seconds and after that, the temperature was decreased by 80 degrees Celsius for about 20 seconds. Subsequently the layer was irradiated at the same temperature with UV light of 0.4 J to fix the alignment. The obtained layer had a thickness of 1.75 micrometers. Thus the optically anisotropic layer was prepared and the optical compensatory sheet was obtained.

### Comparative Example 3

An optical compensatory sheet was prepared in the same manner as Example 13, except that an alignment process as follows was carried out in the place of the above process.

The coated layer was heated up to 120 degrees Celsius for about 20 seconds and after that, was irradiated at the same temperature with UV light of 0.4 J to fix the alignment. The tilt angles, shown in Table 2, were estimated in the same manner as Example 1.

### Comparative Example 4

An optical compensatory sheet was prepared in the same manner as Example 13, except that an alignment process as follows was carried out in the place of the above process.

The coated layer was heated up to 120 degrees Celsius for about 20 seconds and subsequently heated at the same temperature for about 20 seconds. Subsequently the layer was irradiated at the same temperature with UV light of 0.4 J to fix the alignment. The tilt angles, shown in Table 2, were estimated in the same manner as Example 1.

### Comparative Example 5

An optical compensatory sheet was prepared in the same manner as Example 1, except that 1,3,5-triazin compound was not added to the layer and an alignment process as follows was carried out in the place of the alignment process above.

The coated layer, which didn't contain the 1,3,5-triazine compound, was heated up to 120 degrees Celsius for about 20 seconds and subsequently heated at the same temperature for about 20 seconds. After the temperature was decreased by 80 degrees Celsius for about 20 seconds, the layer was irradiated at the same temperature with UV light of 0.4 J to fix the alignment. The tilt angles, shown in Table 2, were estimated in the same manner as Example 1.

### Comparative Example 6

An optical compensatory sheet was prepared in the same manner as Example 1, except that 1,3,5-triazin compound was not added and an alignment process as follows was carried out in the place of the alignment process above.

The coated layer, which didn't contain the 1,3,5-triazine compound, was heated up to 120 degrees Celsius for about 20 seconds. After that, the temperature was decreased by 80 degrees Celsius for about 20 seconds, and subsequently the layer was irradiated at the same temperature with UV light of 0.4 J to fix the alignment. The tilt angles, shown in Table 2, were estimated in the same manner as Example 1.

### Example 14

An optical compensatory sheet was prepared in the same manner as Example 13, except that 0.3 weight parts of 1,3,5-triazin compound (IV-2) was used in the place of the 4.5 weight parts of Compound (IV-1). The tilt angles, shown in Table 2, were estimated in the same manner as Example 1.

### Comparative Example 7

An optical compensatory sheet was prepared in the same manner as Example 14, except that an alignment process as follows was carried out in the place of the above process.

The coated layer was heated up to 120 degrees Celsius for about 20 second and after that irradiated at the same temperature by UV light of 0.4 J to fix the alignment. The tilt angles, shown in Table 2, were estimated in the same manner as Example 1.

### Example 15

An optical compensatory sheet was prepared in the same manner as Example 13, except that 0.5 weight parts of 1,3,5-triazin compound (IV-6) was used in the place of the 4.5 weight parts of Compound (IV-1). The tilt angles, shown in Table 2, were estimated in the same manner as Example 1.

### Comparative Example 8

An optical compensatory sheet was prepared in the same manner as Example 15, except that an alignment process as follows was carried out in the place of the above process.

The coated layer was heated up to 120 degrees Celsius for about 20 second and after that, irradiated at the same temperature by UV light of 0.4 J to fix the alignment. The tilt angles, shown in Table 2, were estimated in the same manner as Example 1.

### Example 16

An optical compensatory sheet was prepared in the same manner as Example 13, except that 0.3 weight parts of 1,3,5-triazin compound (IV-41) was used in the place of the 4.5 weight parts of Compound (IV-1). The tilt angles, shown in Table 2, were estimated in the same manner as Example 1.

### Comparative Example 9

An optical compensatory sheet was prepared in the same manner as Example 16, except that an alignment process as follows was carried out in the place of the above process.

The coated layer was heated up to 120 degrees Celsius for about 20 second and after that, irradiated at the same temperature by UV light of 0.4 J to fix the alignment. The tilt angles, shown in Table 2, were estimated in the same manner as Example 1.

TABLE 2

| | | Tem- | Tilt angle | | |
|---|---|---|---|---|---|
| Compensa- | | perature | | Air | |
| tory | Triazine | for | Alignment | interface | Alignment |
| sheet | compound | fixing | layer side | side | state |
| Example 13 | No. IV-1 | 80° C. | 7° | 55° | hybrid |
| Comparative | No. IV-1 | 120° C. | 2° | 0° | homogenous |
| Example 3 | | | | | |
| Comparative | No. IV-1 | 120° C. | 2° | 0° | homogenous |
| Example 4 | | | | | |
| Comparative | — | 120° C. | *1 | | |
| Example 5 | | | | | |
| Comparative | — | 80° C. | *1 | | |
| Example 6 | | | | | |
| Example 14 | No. IV-2 | 80° C. | 7° | 56° | hybrid |
| Comparative | No. IV-2 | 120° C. | 1° | 0° | homogenous |
| Example 7 | | | | | |
| Example 15 | No. IV-8 | 80° C. | 7° | 55° | hybrid |
| Comparative | No. IV-8 | 120° C. | 3° | 0° | homogenous |
| Example 8 | | | | | |
| Example 16 | No. IV-41 | 80° C. | 7° | 55° | hybrid |
| Comparative | No. IV-41 | 120° C. | 3° | 0° | homogenous |
| Example 9 | | | | | |

*1: It was impossible to obtain the data due to schlieren defects.

As indicated results presented in Table 2 above, it can be understood as follows. According to the Examples 13, 14, 15 and 16, comprising the first alignment process at a high temperature (120 degrees Celsius) and the second alignment process at a low temperature (80 degrees Celsius) in preparation of the optically anisotropic layers, the liquid crystal compounds was aligned in homogenous alignment at the high temperature, and the compounds was transferred from the homogenous alignment to the hybrid alignment at the low temperature. Although some schlieren defects were found in the optically anisotropic layers of the Comparative Examples 5 and 6, any schlieren defects were not found in those of the examples 13, 14 and 16.

Next, examples of the method wherein the first step for homogenous alignment is carried out at a lower temperature than that for hybrid alignment in the second step, will be described bellow.

### Example 17

An optical compensatory sheet was prepared in the same manner as Example 1, except that 0.4 weight parts of Compound (XIII-2) and 0.6 weight parts of Compound (VI-7) were used in the place of the 0.6 weight parts of Compound (I-1) and an alignment process as follows was carried out in the place of the alignment process above. The tilt angles shown in Table 3, were estimated in the same manner as Example 1.

(Alignment Process)

The coated layer was heated up to 70 degrees Celsius for about 10 seconds and after that, the temperature was increased by 125 degrees Celsius for about 10 seconds. Subsequently the layer was heated at the same temperature for about 10 seconds so as to be maturated and irradiated at the same temperature with UV light of 0.4 J to fix the alignment. The obtained layer had a thickness of 1.9 micrometers. Thus the optically anisotropic layer was prepared and the optical compensatory sheet was obtained.

### Comparative Example 10

An optical compensatory sheet was prepared in the same manner as Example 17, except that an alignment process as shown in Table 3 was carried out in the place of the alignment process above.

TABLE 3

| | Conditions of | Tilt angle | | |
|---|---|---|---|---|
| Compensatory | heating and | Alignment | Air interface | Alignment |
| sheet | maturation | layer side | side | state |
| Example 17 | *1 | 12° | 68° | hybrid |
| Comparative | *2 | 2° | 0° | homogenous |
| Example 10 | | | | |

*1: After heated up to 70 degrees Celsius for about 10 seconds, the layer was heated up to 125 degrees Celsius for about 10 seconds and subsequently maturated at the same temperature.
*2: After heated up to 70 degrees Celsius for about 10 seconds, the layer was maturated at the same temperature for 20 seconds.

As indicated by results presented in Table 3, according to the optical compensatory sheet of the Example 17 containing two compounds having a function group capable of hydrogen bonding, the liquid crystal compound was aligned in homogenous alignment at low temperature (70 degrees Celsius) and after that, the compound was transferred from the homogenous alignment state to hybrid alignment state during heating up to a high temperature (125 degrees Celsius).

### Examples 18 to 20 and Comparative Examples 11 to 17

Optical compensatory sheets were prepared in the same manner as Example 17, except that compounds shown in Table 4 were respectively used in the place of the compounds having a function group capable of hydrogen bonding.

The tilt angles shown in Table 4, were estimated in the same manner as Example 1.

TABLE 4

| | Compound having | | Compound having | | | | |
|---|---|---|---|---|---|---|---|
| | a function | | a function | | | | |
| | group capable of | | group capable of | | | | |
| | hydorgen bonding | | hydorgen bonding | | Tilt angle | | |
| | | Amount | | Amount | | Air | |
| Compensatory | | (weight | | (weight | Alignment | interface | Alignment |
| sheet | No. | parts) | No. | parts) | layer side | side | state |
| Example 17 | No. XIII-2 | 0.4 | No. VI-7 | 0.6 | 12° | 68° | hybrid |
| Comparative | No. XIII-2 | 0.4 | — | — | 2° | 0° | homogenous |
| Example 11 | | | | | | | |
| Comparative | — | — | No. VI-7 | 0.6 | *1 | | |
| Example 12 | | | | | | | |
| Example 18 | No. XIII-2 | 0.2 | No. VI-11 | 0.1 | 7° | 55° | hybrid |
| Comparative | — | — | No. VI-11 | 0.1 | *1 | | |
| Example 13 | | | | | | | |
| Example 19 | No. XIII-2 | 0.2 | No. XXI-4 | 0.1 | 31° | 80° | hybrid |
| Comparative | — | — | No. XXI-4 | 0.1 | *1 | | |
| Example 14 | | | | | | | |
| Example 20 | No. XIII-2 | 1.0 | No. VI-1 | 1.0 | 12° | 68° | hybrid |

| | | | | | |
|---|---|---|---|---|---|
| Comparative | No. XIII-2 | 1.0 | — | — | *1 |
| Example 15 | | | | | |
| Comparative | — | — | No. VI-1 | 1.0 | *1 |
| Example 16 | | | | | |
| Comparative | — | — | — | — | *1 |
| Example 17 | | | | | |

*1: It was impossible to obtain the data due to schlieren defects.

As indicated by results of the examples 17 to 20 presented in Table 4, according to the optical compensatory sheets having an optically anisotropic layer containing two compounds having a function group capable of hydrogen bonding, hybrid alignments whose tilt angles, especially tilt angles of air interface side, were sufficiently large, can be achieved. On the other hand, as indicated by results of the comparative examples 11 to 17 presented in Table 4, according to the optical compensatory sheets having an optically anisotropic layer containing less than two compounds having a function group capable of hydrogen bonding, such hybrid alignments can not be achieved. According to the comparative examples 12 to 17, a lot of schlieren defects were generated in the layers due to slow alignment speed and their tilt angles could not be measured; according to the comparative example 11, although the alignment speed was fast, the homogenous alignment appeared due to low tilt angle. For achievement of hybrid alignments with high tilt angles without schlieren defects, it is necessary to use two compounds having a function group capable of hydrogen bonding together.

Next, examples of LCD will be described. At first, effects of improvement of tilt angles will be described.

### Example 21

(Preparation of the Transparent Support)

The following components were charged to a mixing tank and stirred with heating to prepare a cellulose acetate solution (dope).

Composition of Cellulose Acetate Solution Composition

| | |
|---|---|
| Cellulose acetate with a 60.9 percent | 100 weight parts |
| Degree of acetation | |
| Triphenyl phosphate | 6.5 weight parts |
| Biphenyldiphenyl phosphate | 5.2 weight parts |
| Retardation enhancer (1) described below | 0.1 weight part |
| Retardation enhancer (2) described below | 0.2 weight part |
| Methylene chloride | 310.25 weight parts |
| Methanol | 54.75 weight parts |
| 1-Butanol | 10.95 weight parts |
| Retardation enhancer (1) | |
| 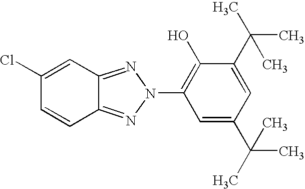 | |
| Retardation enhancer (2) | |
| 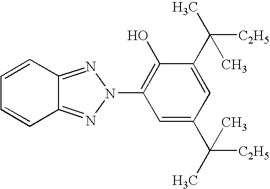 | |

The dope obtained was made to flow out of a nozzle onto a drum cooled to 0 degrees Celsius. It was peeled off while having a solvent content of 70 weight percent, the two edges of the film in the transverse direction were fixed with a pin tenter, and in the area where the solvent content was from 3 to 5 weight percent, the film was dried while maintaining a spacing yielding a stretching rate of 3 percent in the traverse direction (direction perpendicular to the machine direction). Subsequently, the film was further dried by passing it between the rolls of a heat treatment device and adjusted to achieve a ratio between the stretching rate in the transverse direction and the stretching rate in the machine direction of 0.75 with an essentially 0 percent stretching rate in the machine direction in the area in which the glass transition temperature exceeded 120 degrees Celsius (taking into account 4 percent stretching in the machine direction during separation). This yielded a cellulose acetate film 100 micrometers thick. Measurement of the retardation of the film thus prepared at a wavelength of 632.8 nm revealed a thickness retardation of 40 nm and an in-plane retardation of 4 nm. The cellulose acetate film thus prepared was employed as transparent support.

(Formation of a First Undercoating Layer)

A coating liquid of the composition indicated below was applied to 28 ml m² on the transparent support and dried to form a first undercoating layer.

Composition of First Undercoating Layer Coating Liquid

| | | |
|---|---|---|
| Gelatin | 5.42 | weight parts |
| Formaldehyde | 1.36 | weight parts |
| Salicylic acid | 1.60 | weight parts |
| Acetone | 391 | weight parts |
| Methanol | 158 | weight parts |
| Methylene chloride | 406 | weight parts |
| Water | 12 | weight parts |

(Formation of Second Undercoating Layer)

A coating liquid of the composition indicated below was applied to 7 ml/m² on the first undercoating layer and dried to form a second undercoating layer.

Composition of Second Undercoating Layer Coating Liquid

| | |
|---|---|
| Anionic polymer described below | 0.79 weight part |
| Citric acid monoethyl ester | 10.1 weight parts |
| Acetone | 200 weight parts |
| Methanol | 877 weight parts |
| Water | 40.5 weight parts |
| Anionic polymer | |

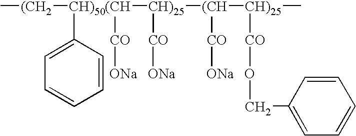

(Formation of Back Layer)

A coating liquid of the composition indicated below was applied to 25 ml/m² on the surface of the opposite side of the transparent support and dried to form a back layer.

Composition of Back Layer Coating Liquid

| | | |
|---|---|---|
| Cellulose diacetate with 55 percent | 6.56 | weight parts |
| degree of acetation | | |
| Silica-based matting agent (average | 0.65 | weight parts |
| particle size: 1 micrometer) | | |
| Acetone | 679 | weight parts |
| Methanol | 104 | weight parts |

(Formation of Alignment Layer)

An aqueous solution of alkyl-modified polyvinyl alcohol was applied on the second undercoating layer and dried for 90 sec with 60 degrees Celsius hot air, after which a rubbing treatment was applied to form an alignment layer. The rubbing direction of the alignment layer was parallel to the flow direction of the transparent support.

(Formation of Optically Anisotropic Layer)

The coating solution used for preparation of the optically anisotropic layer of Example 1 was applied with a #4 wire bar to the alignment layer. The thickness of the optically anisotropic layer was 1.74 micrometers.

The coated layer was heated up to 120 degrees Celsius for about 20 sec in a thermostatic chamber of 130 degrees Celsius and subsequently heated at the same temperature for 120 sec. After that the temperature was decreased by 80 degrees Celsius for 20 sec and subsequently the layer was irradiated at the same temperature with UV light of 0.4 J to fix the alignment. The layer was cooled to room temperature to complete preparation of the optical compensatory sheet.

(Preparation of Liquid-Crystal Display)

A polyimide alignment layer was provided on a glass substrate equipped with transparent ITO electrodes and treated by rubbing. Five micrometer spacers were positioned and two such sheets of substrate were positioned with their alignment layers facing. The two substrates were positioned so that the rubbing directions of their alignment layers were perpendicular. Rod-shaped liquid-crystal molecules (ZL4792 made by Merck Co.) were poured into the gap between the substrates to form a rod-shaped liquid-crystal layer. The Δn of the rod-shaped liquid-crystal molecules was 0.0969. Two optical compensatory sheets prepared as set forth above were bonded to either side of the TN liquid-crystal cell prepared as set forth above so that the optically anisotropic surfaces faced the substrates of the liquid-crystal cell. Two polarizing plates were then bonded to the outside thereof to prepare a liquid crystal display. The arrangement was such that the rubbing direction of the alignment layer of the optical compensatory sheet was antiparallel to the rubbing direction of the alignment layer of the liquid-crystal cell adjacent thereto. Further, the arrangement was such that the absorption axis of the polarizing plate was parallel to the rubbing direction of the liquid-crystal cell. A voltage was applied to the liquid-crystal cell of the liquid-crystal display, the transmittance of a 2 V white display and a 5 V black display was adopted as the contrast ratio, a contrast ratio of 10 was measured vertically and horizontally, and the area without gradation reversal was measured as the viewing angle. The results are given in Table 5.

### Examples 22 to 26 and Comparative Example 18

With the exception that Compound No. I-1 in the example 21 was replaced with the compounds of the present invention indicated in Table 5, optical compensatory sheets and liquid-crystal displays were prepared in the same manner as the example 21. The viewing angles of the displays were measured in the same manner as the example 21. The results are given in Table 5.

TABLE 5

| | Specifc compound | | | |
|---|---|---|---|---|
| | denoted by the | | | |
| | Formula (I), (II) or (III) | | | |
| | | Amount | Viewing angle | |
| Compensatory | | (weight | Vertical | Horizontal |
| sheet | No. | parts) | direction | direction |
| Example 21 | No. I-1 | 0.6 | 110° | 160° |
| Example 22 | No. I-2 | 0.6 | 110° | 160° |
| Example 23 | No. II-1 | 0.4 | 110° | 158° |
| Example 24 | No. II-4 | 0.1 | 110° | 160° |
| Example 25 | No. III-7 | 1.0 | 110° | 160° |
| Example 26 | No. III-15 | 1.0 | 110° | 160° |
| Comparative | — | — | 91° | 148° |
| Example 18 | | | | |

As indicated by results of the examples presented in Table 5, the optical compensatory sheets according to the present invention, having an optically anisotropic layer containing the compound denoted by the Formula (I), (II) or (III), contributed to improvement of viewing angles of LCDs. It was appeared that such effects were attributed to the fact the tilt angles of the liquid crystal compounds were sufficiently large in the optically anisotropic layers of the examples 21 to 26.

Next, effects of improvement of alignment speeds will be described. At first, such effects brought about the method (Method (1)) comprising a first step for homogenous alignment at a high temperature and a second step for hybrid alignment at a low temperature will be described.

### Example 27

With the exception that the coating solution used in the example 21 was replaced with a coating solution same as the coating solution used in Example 13 and the alignment process was replaces with a process as follows, an optical compensatory sheet and a liquid-crystal display were prepared in the same manner as the example 21. The viewing angles of the display were measured in the same manner as the example 21. The results are given in Table 6.

(Alignment Process)

The film having the coated layer thereon was placed in a thermostatic chamber of 130 degrees Celsius, heated up to 120 degrees Celsius (surface temperature) for 20 sec and subsequently heated at the same temperature for about 20 sec. After that the temperature was decreased by 80 degrees Celsius for 20 sec to align the discotic compound. Subsequently, the layer was irradiated at the same temperature with UV light of 0.4 J to fix the alignment. The layer was cooled to room temperature to complete preparation of the optical compensatory sheet. The viewing angles of the display were measured in the same manner as the example 21. The results are given in Table 6.

### Comparative Example 19

An optical compensatory sheet was prepared in the same manner as Example 27, except that an alignment process as follows was carried out in the place of the above alignment process.

The coated layer was heated up about 30 sec in a thermostatic chamber of 130 degrees Celsius to align the disctotic liquid crystal compound. After that, the layer was irradiated at the same temperature with UV light of 0.4 J to fix the alignment. The viewing angles of the display were measured in the same manner as the example 21. The results are given in Table 6.

### Comparative Example 20

An optical compensatory sheet was prepared in the same manner as Example 27, except that the 1,3,5-triazine compound was not used and an alignment process as follows was carried out in the place of the above alignment process.

The coated layer was heated up about 30 sec in a thermostatic chamber of 130 degrees Celsius to align the disctotic liquid crystal compound. After that, the layer was irradiated at the same temperature with UV light of 0.4 J to fix the alignment. The viewing angles of the display were measured in the same manner as the example 21. The results are given in Table 6.

### Comparative Example 21

An optical compensatory sheet was prepared in the same manner as Example 27, except that the 1,3,5-triazine compound was not used. The results are given in Table 6.

### Referential Example 1

An optical compensatory sheet was prepared in the same manner as Example 26, except that the 1,3,5-triazine compound was not used and an alignment process as follows was carried out in the place of the above alignment process.

The coated layer was heated up about 120 sec in a thermostatic chamber of 130 degrees Celsius to align the disctotic liquid crystal compound. After the temperature decreased 80 degrees Celsius, the layer was irradiated at the same temperature with UV light of 0.4 J to fix the alignment. The viewing angles of the display were measured in the same manner as the example 21. The results are given in Table 6.

TABLE 6

Viewing angle

| Compensatory | Triazine | Vertical | Horizontal |
|---|---|---|---|
| sheet | compound | direction | direction |
| Example 27 | No. II-1 | 91° | 148° |
| Comparative | No. II-1 | 71° | 112° |
| Example 19 | | | |

| | | |
|---|---|---|
| Comparative | — | *1 |
| Example 20 | | |
| Comparative | — | *1 |
| Example 21 | | |

| | | | |
|---|---|---|---|
| Referential | — | 91° | 148° |
| Example 1 | | | |

*1: It was impossible to obtain the data due to schlieren defects.

As indicated by results of the examples presented in Table 6, the optical compensatory sheet of the example 27, having the optically anisotropic layer formed of the hybrid aligned compound, contributed to improvement of viewing angle of the LCD, and the effect was much better than that of the comparative example 19 having the optically anisotropic layer formed of the homogenous aligned compound. Although a lot of schliren defects were found in the optically anisotropic layers of the comparative examples 20 and 21, any schliren defects were not found in the optically anisotropic layer of the example 27. According to the example 27, the optically anisotropic layer was prepared faster than according to the referential example 1 in which the compound was aligned in hybrid alignment not through homogenous alignment.

Next, effects of improvement of alignment speeds brought about the method (Method (2)) comprising a first step for homogenous alignment at a low temperature and a second step for hybrid alignment at a high temperature will be described.

### Example 28

With the exception that the coating solution used in the example 21 was replaced with a coating solution same as the coating solution used in Example 19 and the alignment process was replaces with a process as follows, an optical compensatory sheet and a liquid-crystal display were prepared in the same manner as in the example 21. The viewing angles of the displays were measured in the same manner as the example 21. The results are given in Table 7.

(Alignment Process)

The film having the coated layer thereon was placed in a thermostatic chamber of 130 degrees Celsius, heated up to 120 degrees Celsius (surface temperature) for 20 sec and subsequently heated at the same temperature at the same temperature for about 20 sec. After that, the temperature was decreased by 80 degrees Celsius for 20 sec to align the discotic compound. Subsequently, the layer was irradiated at the same temperature with UV light of 0.4 J to fix the alignment. The layer was cooled to room temperature to complete preparation of the optical compensatory sheet. The viewing angles of the display were measured in the same manner as the example 21. The results are given in Table 7.

### Comparative Examples 22 to 25

Optical compensatory sheets were prepared in the same manner as Example 28, except that the compounds having a function group capable of hydrogen bonding and alignment processes were changed as shown in Table 7. The viewing angles of the displays were measured in the same manner as the example 21. The results are given in Table 7.

TABLE 7

| | Compound having | | Compound having | | | | | | |
|---|---|---|---|---|---|---|---|---|---|
| | a function group | | a function | | | | | | |
| | capable of | | group capable of | | | | | | |
| | hydorgen bonding | | hydorgen bonding | | | Tilt angle | | | |
| | | Amount | | Amount | Conditions | | Air | Viewing angle | |
| Compensatory | | (weight | | (weight | of heating and | Alignment | interface | Vertical | Horizontal |
| sheet | No. | parts) | No. | parts) | maturation | layer side | side | direction | direction |
| Example 28 | No. XIII-2 | 0.2 | No. XXI-4 | 0.1 | *1 | 31° | 80° | 110° | 160° |
| Comparative | No. XIII-2 | 0.2 | — | — | *1 | 2° | 0° | 71° | 112° |
| Example 22 | | | | | | | | | |
| Comparative | — | — | No. XXI-4 | 0.1 | *1 | *3 | | | |
| Example 23 | | | | | | | | | |
| Comparative | — | — | — | — | *1 | *3 | | | |
| Example 24 | | | | | | | | | |
| Comparative | No. XIII-2 | 0.2 | No. XXI-4 | 0.1 | *2 | 2° | 0° | 71° | 112° |
| Example 25 | | | | | | | | | |

*1: The Layer was heated up to 120 degrees Celsius for about 20 seconds and subsequently maturated at the same temperature for about 30 sec.
*2: The Layer was heated up to 80 degrees Celsius for about 20 seconds and subsequently maturated at the same temperature for about 30 sec.
*3: It was impossible to obtain the data due to schlieren defects.

As indicated by results of the comparative example 25 presented in Table 7, irradiated with UV light at a low temperature (80 degrees Celsius), the layer was formed of the fixed compound in homogenous alignment, to thereby have small effect of improvement of viewing angle. On the other hand, as indicated by results of the example 28 presented in Table 7, irradiated with UV light after heated up to a high temperature (120 degrees Celsius), the layer was formed of the fixed compound in hybrid alignment, to thereby have large effect of improvement of viewing angle. According to the comparative examples 23 and 24, a lot of schlieren defects were generated in the layers due to slow alignment speed and their viewing angles could not be measured; according to the comparative example 22, although the alignment speed was fast, the homogenous alignment appeared due to low tilt angle. Especially, according to the comparative example 24, having the optical anisotropic layer containing none of compounds capable of hydrogen bonding, a lot of schlieren defects were generated in the layer due to slow alignment speed. Thus, for rapidly achievement of hybrid alignment without schlieren defects, it is necessary to use two compounds having a function group capable of hydrogen bonding together. Under the presence of the two compounds, at first the liquid crystal compound was aligned in homogenous alignment at a low temperature (80 degrees Celsius), and the homogenous alignment was transferred form the homogenous alignment state to a hybrid alignment state at a high temperature (120 degrees Celsius). For achievement of hybrid alignment with high tilt angles without schlieren defects and for providing the optical compensatory sheet contributing to improvement of viewing angle, it is necessary to use two compounds having a function group capable of hydrogen bonding together.

### INDUSTRIAL APPLICABILITY

According to the present invention, optical compensatory sheets comprising an optically anisotropic layer in which a liquid crystal compound is aligned in hybrid alignment with large tilt angle, especially the air interface side, can be prepared by combined the liquid crystal compound and one or more specific compounds. According to the present invention, it is possible to provided optical compensatory sheets which can contribute to improvement of viewing angle when they are employed in displaying apparatuses. According to the present invention, since the required time for alignment of liquid crystal compound can be reduced, optical compensatory sheets, having an optically anisotropic layer formed of a hybrid aligned liquid crystal compound with high tilt angle, can be prepared with a high productivity and without schliren defects.

1. An optical compensatory sheet comprising a transparent support and an optically anisotropic layer thereon comprising at least one compound represented by following Formula (I) or (II);
(R¹—X¹—)ₘAr¹(—COOH)ₚ Formula (I):
where Ar¹ denotes an aromatic heterocyclic group or aromatic condensed carbocyclic group; X¹ denotes a single bond or divalent linking group; R¹ denotes an alkyl group; m is an integer from 1 to 4 and p is an integer from 1 to 4; and plural R¹—X¹ may be identical or different each other when m is not smaller than 2;
(R²—X²—)ₙAr²(—SO₃H)_{q} Formula (II):
where Ar² denotes an aromatic heterocyclic group or aromatic carbocyclic group; X² denotes a single bond or divalent linking group; R² denotes an alkyl group; n is an integer from 1 to 4 and q is an integer from 1 to 4; and plural R²—X² may be identical or different each other when n is not smaller than 2.

2. An optical compensatory sheet comprising a transparent support and an optically anisotropic layer thereon formed of a triphenylene liquid crystal compound and at least one compound represented by Formula (III);
(R—)ₛAr(—Y)ᵣ Formula (III)
where Ar denotes an aromatic heterocyclic group or aromatic carbocyclic group; R denotes a substituent group; Y denotes sulfo or carboxyl; s is an integer from 0 to 5 and r is an integer from 1 to 4; and plural R and Y may be respectively identical or different each other when s and r are not smaller than 2 respectively.

3. The optical compensatory sheet of claim 2 wherein Ar is a benzene group.

4. The optical compensatory sheet of claim 2, wherein the compound represented by Formula (III) is represented by Formula (IIIa); 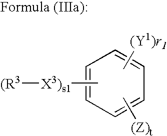
where Z denotes a substituent group, X³ denotes a single bond and divalent linking group, R³ denotes an alkyl group, alkenyl group or alkynyl group; Y¹ denotes a sulfo or carboxyl, t is an integer from 0 to 4, s¹ is an integer from 1 to 4 and r¹ is an integer from 1 to 4; and plural Z, R³, X³ and Y¹ may be respectively same or different each other when t, s¹ and r¹ are respectively not smaller than 2.

5. The optical compensatory sheet of claim 4 wherein, in Formula (IIIa), Z denotes an alkyl group, hydroxy, halogen atom or cyano; X³ is —O—, —S—, —OCO—, N(R^{a})CO—, —CO—, —COO— or —CON(R^{a})—; R^{a} denotes a C1-5 alkyl group or hydrogen atom; R³ denotes a substituted or non-substituted C8-20 alkyl group or C4-12 alkyl group which is terminated by —CHF₂ or —CF₃ and is substituted with fluorine atoms at not less than 60% of hydrogen positions; t is an integer from 0 to 2, s¹ is an integer from 1 to 3 and r¹ is 1.

6. An optical compensatory sheet comprising a transparent support and an optically anisotropic layer thereon formed of a discotic liquid crystal compound and at least one compound represented by Formula (IVb); 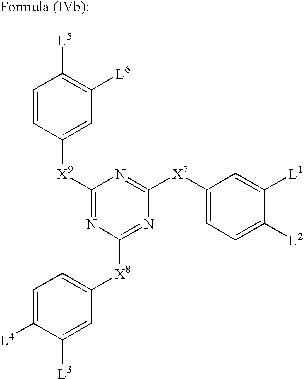
wherein X⁷, X⁸ and X⁹ independently denote —NH—, —NHCO—, —NHSO₂—, —O— or —S—; L¹, L², L³, L⁴, L⁵ and L⁶ independently denote a group having a structure represented by Formula (IVc) or (IVd); 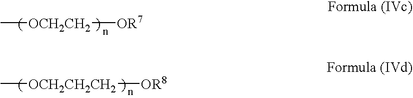
where in Formulae (IVc) and (IVd), R′ and P.8 independently a substituted or non-substituted alkyl group; and n is an integer from 1 to 12;
wherein the liquid crystal compound is fixed in hybrid alignment.

7. An optical compensatory sheet comprising a transparent support and an optically anisotropic layer thereon formed of a discotic liquid crystal compound, at least one compound represented by Formula (XIIIa) and at least one compound represented by Formula (XXII); 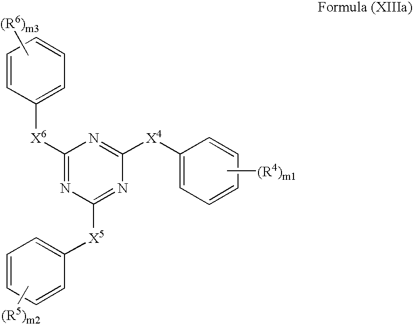
wherein R⁴, R⁵ and R⁶ independently denote a hydrogen atom or substituent group; X⁴, X⁵ and X⁶ independently denote a divalent linking group selected from the group consisting of —CO—, —NR^{a}— (R^{a} denotes a C01-5 alkyl group or hydrogen atom), —O—, —S—, —SO—, —SO₂— and combinations thereof; and m¹, m² and m³ denote independently integers from 1 to 5; and plural R⁴, R⁵ and R⁶ may be respectively identical or different each other when m¹, m² and in are respectively not smaller than 2;
Ar³(-L⁷-Y²)ₘ4 Formula (XXII)
where Ar³ denotes an aromatic carbocyclic group or aromatic heterocyclic group; Y² denotes a sulfo or a carboxyl; L⁷ denotes a single bond or divalent linking group; and m⁴ is an integer from 1 to 10;
wherein the liquid crystal compound is fixed in hybrid alignment.

8. A method for preparing an optically anisotropic layer formed of a liquid crystal compound hybrid-aligned, comprising
a first step of aligning the liquid crystal compound in homogenous alignment, and
a second step of aligning the liquid crystal compound in hybrid alignment after the first step, wherein the first step is a step of aligning the liquid crystal compound in homogenous alignment at T1 degrees Celsius in the presence of a homogenous alignment promoter and the second step is a step of aligning the liquid crystal compound in hybrid alignment at T2 (T2<Ti) degrees Celsius in the presence of the homogenous alignment promoter.

9. The method of claim 8, wherein the homgenous alignment promoter is a compound represented by Formula (IVb); 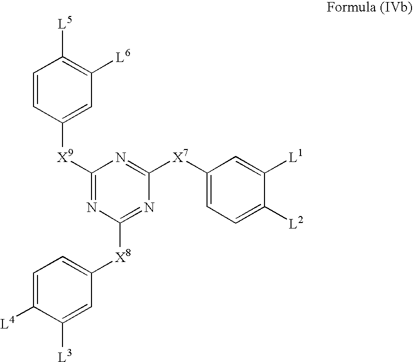
wherein X⁷, X⁸ and X⁹ independently denote —NH—, —NHCO—, —NHSO₂—, —O— or —S—; L¹, L², L³, L³, L⁵ and L⁶ independently denote a group having a structure represented by Formula (IVc) or (IVd); 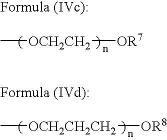
where in Formulae (IVc) and (IVd), R⁷ and R⁸ independently a substituted or non-substituted alkyl group; n is an integer from 1 to 12.

10. A method for preparing an optically anisotropic layer formed of a liquid crystal compound hybrid-aligned, comprising
a first step of aligning the liquid crystal compound in homogenous alignment, and
a second step of aligning the liquid crystal compound in hybrid alignment after the first step, wherein the first step is a step of aligning the liquid crystal compound in homgenous alignment at T₁ degrees Celsius in the presence of at least two
compounds having a function group capable of hydrogen bonding, the second step is a step of aligning the liquid crystal compound in hybrid alignment at T₂ (T₁<T₂) degrees Celsius in the presence of the at least two compounds having a function group capable of hydrogen bonding.

11. The method of claim 10, wherein at least one of the at least two compounds having a function group capable of hydrogen bonding is a compound having a 1,3,5-triazine ring.

12. The method of claim 10, wherein at least one of the at least two compounds having a function group capable of hydrogen bonding is a compound having a carboxyl group or a sulfo group.

13. The method of claim 10, wherein one of the at least two compounds having a function group capable of hydrogen bonding is a compound having a 1,3,5-triazine ring and another is a compound having a carboxyl group or a sulfo group.

14. The method of claim 10, wherein one of the at least two compounds having a function group capable of hydrogen bonding is a compound having a structure represented by Formula (XIIIa), and another is a compound having a structure represented by Formula (XXII); 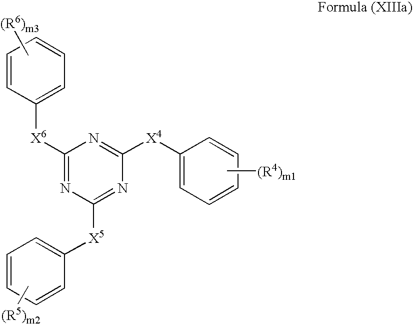
wherein R⁴, R⁵ and R⁶ independently denote a hydrogen atom or substituent group;
X⁴ X⁵ and X⁶ independently denote a divalent linking group selected from the group consisting of
—CO—, —NR^{a}— (R^{a} denotes a C1-5 alkyl group or hydrogen atom), —O—, —S—, —SO—, —SO₂— and combinations thereof; and m¹, m² and m³ denote independently integers from 1 to 5; and plural R⁴, R⁵ and R⁶ may be respectively identical or different each other when m¹, m² and m³ are respectively not smaller than 2;
Ar³(-L⁷-Y²)ₘ₄ Formula (XXII)
where Ar³ denotes an aromatic carbocyclic group or aromatic heterocyclic group; Y² denotes a sulfo or a carboxyl; L⁷ denotes a single bond or divalent linking group; and in⁴ is an integer from 1 to 10.

15. The method of claim 8, further comprising a third step of fixing the crystal compound in the hybrid alignment after the second step.

16. The method of claim 8, wherein the liquid crystal compound is a discotic liquid crystal compound.

17. An optical compensatory sheet comprising an optically anisotropic layer prepared by a method of claim 8.
